(19) United States
(12) Patent Application Publication
(10) Pub. No.: US 2019/0186438 A1
(43) Pub. Date: Jun. 20, 2019

(54) Electromagnetic Wave Modification of Fuel in a Power-generation Turbine

(71) Applicant: Plasma Igniter, LLC, Bruceton Mills, WV (US)

(72) Inventors: Andrew D. Lowery, Morgantown, WV (US); James E. Smith, Bruceton Mills, WV (US)

(73) Assignee: Plasma Igniter, LLC, Bruceton Mills, WV (US)

(21) Appl. No.: 15/848,539

(22) Filed: Dec. 20, 2017

(51) Int. Cl. F02M 27/06; F02C 7/22; F02C 7/266; H05H 1/24; H05H 1/46

(52) U.S. Cl. CPC F02M 27/06; F02C 7/222; F02C 7/266; H05H 1/2406; H05H 2001/4645; F05D 2240/35; F05D 2220/30; H05H 2001/2412; H05H 1/46

(57) ABSTRACT

Example implementations relate to electromagnetic wave modification of fuel in a power-generation turbine. An example implementation includes a power-generation turbine. The power-generation turbine includes a combustion chamber, a radio-frequency power source, and a fuel conduit configured to provide a fuel to the combustion chamber. In addition, the power-generation turbine includes a resonator configured to electromagnetically couple to the radio-frequency power source and having a resonant wavelength. The resonator includes a first conductor, a second conductor, and a dielectric between the first conductor and the second conductor. The resonator is configured such that, when the resonator is excited by the radio-frequency power source with a signal having a wavelength proximate to an odd-integer multiple of one-quarter (¼) of the resonant wavelength, the resonator radiates electromagnetic waves usable to modify (i) the fuel within the fuel conduit or (ii) a fuel mixture, which includes the fuel, within the combustion chamber.

### CROSS-REFERENCE TO RELATED APPLICATIONS

The present application hereby incorporates by reference U.S. Pat. Nos. 5,361,737; 7,721,697; 8,783,220; 8,887,683; 9,551,315; 9,624,898; and 9,638,157. The present application also hereby incorporates by reference U.S. Patent Application Pub. Nos. 2009/0194051; 2011/0146607; 2011/0175691; 2014/0283780; 2014/0283781; 2014/0327357; 2015/0287574; 2017/0082083; 2017/0085060; 2017/0175697; and 2017/0175698. In addition, the present application hereby incorporates by reference International Patent Application Pub. Nos. WO 2011/112786; WO 2011/127298; WO 2015/157294; and WO 2015/176073. Further, the present application hereby incorporates by reference the following U.S. Patent Applications, each filed on the same date as the present application: “Plasma-Distributing Structure in a Resonator System” (identified by attorney docket number 17-1501); “Magnetic Direction of a Plasma Corona Provided Proximate to a Resonator” (identified by attorney docket number 17-1502); “Fuel Injection Using a Dielectric of a Resonator” (identified by attorney docket number 17-1505); “Jet Engine Including Resonator-based Diagnostics” (identified by attorney docket number 17-1506); “Power-generation Turbine Including Resonator-based Diagnostics” (identified by attorney docket number 17-1507); “Electromagnetic Wave Modification of Fuel in a Jet Engine” (identified by attorney docket number 17-1508); “Jet Engine with Plasma-assisted Combustion” (identified by attorney docket number 17-1510); “Jet Engine with Fuel Injection Using a Conductor of a Resonator” (identified by attorney docket number 17-1511); “Jet Engine with Fuel Injection Using a Dielectric of a Resonator” (identified by attorney docket number 17-1512); “Jet Engine with Fuel Injection Using a Conductor of At Least One of Multiple Resonators” (identified by attorney docket number 17-1513); “Jet Engine with Fuel Injection Using a Dielectric of At Least One of Multiple Resonators” (identified by attorney docket number 17-1514); “Plasma-Distributing Structure in a Jet Engine” (identified by attorney docket number 17-1515); “Power-generation Gas Turbine with Plasma-assisted Combustion” (identified by attorney docket number 17-1516); “Power-generation Gas Turbine with Fuel Injection Using a Conductor of a Resonator” (identified by attorney docket number 17-1517); “Power-generation Gas Turbine with Fuel Injection Using a Dielectric of a Resonator” (identified by attorney docket number 17-1518); “Power-generation Gas Turbine with Plasma-assisted Combustion Using Multiple Resonators” (identified by attorney docket number 17-1519); “Power-generation Gas Turbine with Fuel Injection Using a Conductor of At Least One of Multiple Resonators” (identified by attorney docket number 17-1520); “Power-generation Gas Turbine with Fuel Injection Using a Dielectric of At Least One of Multiple Resonators” (identified by attorney docket number 17-1521); “Plasma-Distributing Structure in a Power Generation Turbine” (identified by attorney docket number 17-1522); “Jet Engine with Plasma-assisted Combustion and Directed Flame Path” (identified by attorney docket number 17-1523); “Jet Engine with Plasma-assisted Combustion Using Multiple Resonators and a Directed Flame Path” (identified by attorney docket number 17-1524); “Plasma-Distributing Structure and Directed Flame Path in a Jet Engine” (identified by attorney docket number 17-1525); “Power-generation Gas Turbine with Plasma-assisted Combustion and Directed Flame Path” (identified by attorney docket number 17-1526); “Power-generation Gas Turbine with Plasma-assisted Combustion Using Multiple Resonators and a Directed Flame Path” (identified by attorney docket number 17-1527); “Plasma-Distributing Structure and Directed Flame Path in a Power Generation Turbine” (identified by attorney docket number 17-1528); “Jet engine with plasma-assisted afterburner” (identified by attorney docket number 17-1529); “Jet engine with plasma-assisted afterburner having Resonator with Fuel Conduit” (identified by attorney docket number 17-1530); “Jet engine with plasma-assisted afterburner having Resonator with Fuel Conduit in Dielectric” (identified by attorney docket number 17-1531); “Jet engine with plasma-assisted afterburner having Ring of Resonators” (identified by attorney docket number 17-1532); “Jet engine with plasma-assisted afterburner having Ring of Resonators and Resonator with Fuel Conduit” (identified by attorney docket number 17-1533); “Jet engine with plasma-assisted afterburner having Ring of Resonators and Resonator with Fuel Conduit in Dielectric” (identified by attorney docket number 17-1534); and “Plasma-Distributing Structure in an Afterburner of a Jet Engine” (identified by attorney docket number 17-1535).

### BACKGROUND

Resonators are devices and/or systems that can produce a large response for a given input when excited at a resonance frequency. Resonators are used in various applications, including acoustics, optics, photonics, electromagnetics, chemistry, particle physics, etc. For example, electromagnetic resonators can be used as antennas or as energy transmission devices. Further, resonators can concentrate a large amount of energy in a relatively small location (for example, as in the electromagnetic waves radiated by a laser).

Power-generation turbines can produce energy. That energy can be used to power a variety of structures, such as homes, offices, cars, or trains, for example. One way in which a power-generation turbine can produce energy is by combusting hydrocarbon fuel to generate heat.

### SUMMARY

In a first implementation, a power-generation turbine is provided. The power-generation turbine includes a combustion chamber. The power-generation turbine also includes a radio-frequency power source. Further, the power-generation turbine includes a fuel conduit configured to provide a fuel to the combustion chamber. In addition, the power-generation turbine includes a resonator configured to electromagnetically couple to the radio-frequency power source and having a resonant wavelength. The resonator includes a first conductor. The resonator also includes a second conductor. Additionally, the resonator includes a dielectric between the first conductor and the second conductor. The resonator is configured such that, when the resonator is excited by the radio-frequency power source with a signal having a wavelength proximate to an odd-integer multiple of one-quarter (¼) of the resonant wavelength, the resonator radiates electromagnetic waves usable to modify (i) the fuel within the fuel conduit or (ii) a fuel mixture, which includes the fuel, within the combustion chamber.

In a second implementation, a method is provided. The method includes exciting, by a radio-frequency power source, a resonator electromagnetically coupled to the radio-frequency power source with a signal having a wavelength proximate to an odd-integer multiple of one-quarter (¼) of a resonant wavelength of the resonator. The resonator includes a first conductor. The resonator also includes a second conductor. Further, the resonator includes a dielectric between the first conductor and the second conductor. In addition, the method includes, in response to exciting the resonator, radiating electromagnetic waves to modify (i) a fuel within a fuel conduit or (ii) a fuel mixture, which includes the fuel, within a combustion chamber of a power-generation turbine. Still further, the method includes injecting the fuel from the fuel conduit into the combustion chamber.

In a third implementation, a system is provided. The system includes a treatment chamber. The system also includes a radio-frequency power source. Further, the system includes a fuel conduit configured to provide fuel from the treatment chamber to a combustion chamber of a power-generation turbine. In addition, the system includes a resonator configured to electromagnetically couple to the radio-frequency power source and having a resonant wavelength. The resonator includes a first conductor. The resonator also includes a second conductor. Additionally, the resonator includes a dielectric between the first conductor and the second conductor. The resonator is configured such that, when the resonator is excited by the radio-frequency power source with a signal having a wavelength proximate to an odd-integer multiple of one-quarter (¼) of the resonant wavelength, the resonator radiates electromagnetic waves usable to modify the fuel within the treatment chamber.

Other implementations will become apparent to those of ordinary skill in the art by reading the following detailed description, with reference where appropriate to the accompanying drawings.

### BRIEF DESCRIPTION OF THE FIGURES

FIG. 1A illustrates a cross-sectional view of an internal combustion engine.

FIG. 1B illustrates an isometric view of an example quarter-wave coaxial cavity resonator (QWCCR) structure, according to example implementations.

FIG. 1C illustrates a cutaway side view of a QWCCR structure, according to example implementations.

FIG. 1D illustrates a cross-sectional view of a QWCCR structure, according to example implementations.

FIG. 1E is a cross-sectional illustration of an electromagnetic mode in a QWCCR structure, according to example implementations.

FIG. 1F is a cross-sectional illustration of an electromagnetic mode in a QWCCR structure, according to example implementations.

FIG. 1G is a plot of a quarter-wave resonance condition of a QWCCR structure, according to example implementations.

FIG. 2 illustrates a system that includes a coaxial resonator, according to example implementations.

FIG. 3A illustrates a system that includes a coaxial resonator, according to example implementations.

FIG. 3B illustrates a system that includes a coaxial resonator, according to example implementations.

FIG. 4A illustrates a system that includes a coaxial resonator, according to example implementations.

FIG. 4B illustrates a controller, according to example implementations.

FIG. 5 illustrates a cutaway side view of a QWCCR structure connected to a fuel pump and a fuel tank, according to example implementations.

FIG. 6 illustrates a cross-sectional view of an example coaxial resonator connected to a direct-current (DC) power source through an additional resonator assembly acting as a radio-frequency (RF) attenuator, according to example implementations.

FIG. 7 illustrates a cross-sectional view of an example coaxial resonator connected to a DC power source through an additional resonator assembly acting as an RF attenuator, according to example implementations.

FIG. 8 illustrates core components of a power-generation turbine.

FIG. 9 illustrates a partial cross-sectional view of a combustor of a power-generation turbine.

FIG. 10A illustrates a combustion chamber, according to example implementations.

FIG. 10B illustrates a combustion chamber, according to example implementations.

FIG. 10C illustrates a combustion chamber, according to example implementations.

FIG. 11A illustrates a system, according to example implementations.

FIG. 11B illustrates a system, according to example implementations.

FIG. 11C illustrates a system, according to example implementations.

FIG. 11D illustrates a system, according to example implementations.

FIG. 12A illustrates a combustion chamber, according to example implementations.

FIG. 12B illustrates a combustion chamber, according to example implementations.

FIG. 12C illustrates a combustion chamber, according to example implementations.

FIG. 13 illustrates a method, according to example implementations.

### DETAILED DESCRIPTION

Example methods, devices, and systems are presently disclosed. It should be understood that the word “example” is used in the present disclosure to mean “serving as an instance or illustration.” Any implementation or feature presently disclosed as being an “example” is not necessarily to be construed as preferred or advantageous over other implementations or features. Other implementations can be utilized, and other changes can be made, without departing from the scope of the subject matter presented in the present disclosure.

Thus, the example implementations presently disclosed are not meant to be limiting. Components presently disclosed and illustrated in the figures can be arranged, substituted, combined, separated, and designed in a wide variety of different configurations, all of which are contemplated in the present disclosure.

Further, unless context suggests otherwise, the features illustrated in each of the figures can be used in combination with one another. Thus, the figures should be generally viewed as components of one or more overall implementations, with the understanding that not all illustrated features are necessary for each implementation.

In the context of this disclosure, various terms can refer to locations where, as a result of a particular configuration, and under certain conditions of operation, a voltage component can be measured as close to non-existent. For example, “voltage short” can refer to any location where a voltage component can be close to non-existent under certain conditions. Similar terms can equally refer to this location of close-to-zero voltage (for example, “virtual short circuit,” “virtual short location,” or “voltage null”). In examples, “virtual short” can be used to indicate locations where the close-to-zero voltage is a result of a standing wave crossing zero. “Voltage null” can be used to refer to locations of close-to-zero voltage for a reason other than as result of a standing wave crossing zero (for example, voltage attenuation or cancellation). Moreover, in the context of this disclosure, each of these terms that can refer to locations of close-to-zero voltage are meant to be non-limiting.

In an effort to provide technical context for the present disclosure, the information in this section can broadly describe various components of the implementations presently disclosed. However, such information is provided solely for the benefit of the reader and, as such, does not expressly limit the claimed subject matter. Further, components shown in the figures are shown for illustrative purposes only. As such, the illustrations are not to be construed as limiting. As is understood, components can be added, removed, or rearranged without departing from the scope of this disclosure.

I. Overview

As described in the present disclosure, a resonator excited by a radio-frequency power source can radiate electromagnetic waves. The resonator can be excited by a signal generated by the radio-frequency power source that has a wavelength that is proximate to an odd-integer multiple of one-quarter (¼) of a resonant wavelength of the resonator. The electromagnetic waves can include, for example, microwaves having a frequency between 300 MHZ and 300 GHz. The electromagnetic waves can be used to irradiate and modify (i) fuel (for example, hydrocarbon fuel) and/or (ii) another substance within a fuel mixture (for example, air, water, etc.).

Modifying fuel and/or another substance within a fuel mixture can include ionizing at least one hydrogen atom in a hydrocarbon chain, liberating at least one hydrogen atom from a hydrocarbon chain, exciting a hydrocarbon chain at one or more natural resonant frequencies to break one or more carbon-hydrogen bonds, altering an energy state of the fuel, exciting electrons within a valence band of a hydrocarbon chain to a higher energy level, reorienting water molecules, and/or reorienting polar hydrocarbon chains.

By modifying the fuel and/or fuel mixture according to any of these mechanisms, a combustion and/or ignition process of the fuel and/or the fuel mixture can be improved (for example, by increasing a combustibility of the fuel and/or the fuel mixture). In some implementations, an increased power output (for a given fuel-to-air ratio of the fuel mixture) by a power-generation turbine housing the combustion can be achieved, an amount of fuel within the fuel mixture consumed during combustion can be reduced, a lower energy barrier to ignition/combustion of the fuel and/or the fuel mixture can result, and the fuel and/or the fuel mixture can burn at higher thermal efficiencies and at lower fuel-to-air ratios for a given output power (for example, a “leaner” fuel mixture can be burned for a given amount of power output by a power-generation turbine that houses the combustion).

In some implementations, a modulator can be used to modulate an output of the radio-frequency power source used to excite the resonator. The modulator can modulate the output at a given modulation frequency with a given modulation duty cycle. Further, the modulator and/or the radio-frequency power source can be adjusted (for example, by a controller) to alter how much the fuel and/or the fuel mixture is modified by the above-described processes. For example, the controller can adjust the modulation frequency or the modulation duty cycle to increase or decrease the amount of electromagnetic waves radiated by the resonator. Additionally or alternatively, the controller can adjust the excitation frequency, excitation power, excitation amplitude, or excitation waveform of a signal output by the radio-frequency power source to excite the resonator in order to alter the magnitude and frequency of the electromagnetic waves radiated by the resonator. Such adjustments by the controller can be based on sensor readings of an associated combustion chamber, an associated fuel conduit, an associated fuel pump, and/or an associated fuel tank in some implementations. Further, such adjustments by the controller can be based on user input (for example, using an interface).

In various implementations, the modification of the fuel can take place in various locations. For example, in one implementation, the fuel can be modified within a fuel tank (before combustion), before the fuel is injected into a combustion chamber of a power-generation turbine. Alternatively, the fuel can be modified within a fuel conduit (before combustion) as the fuel is transiting from a fuel tank to a combustion chamber (for example, when the fuel is being pumped by a fuel pump within the fuel conduit). In still other implementations, the modification can occur within a treatment chamber. The treatment chamber can be located along a path of the fuel conduit and treatment of the fuel can occur before the fuel is injected into the combustion chamber. Alternatively, the treatment chamber can be located partially or wholly within the combustion chamber, and the fuel and/or air/water in the fuel mixture can be modified within the combustion chamber. Such modifications within the combustion chamber can occur before and/or during combustion. In yet other implementations, the modification can take place within the combustion chamber, but not within a treatment chamber. For example, a coaxial resonator could be oriented such that it is configured to radiate electromagnetic waves into a combustion zone of the combustion chamber in order to modify fuel and/or air/water in a fuel mixture before and/or during combustion. Other examples are possible as well.

In some implementations, multiple resonators can be excited to radiate electromagnetic waves used to modify fuel and/or other substances in a fuel mixture. The resonators can be located in various regions of the combustion chamber, fuel conduit, fuel tank, and/or treatment chamber so as to irradiate different regions of the system. The resonators can be located in other regions, as well. Further, one or more of the resonators could be excited at different excitation frequencies, with different excitation powers, or with different excitation waveforms so as to modify the fuel and/or fuel mixture according to different processes. Each of the resonators can be selectively excited by a controller, in some implementations.

II. Example Combustion

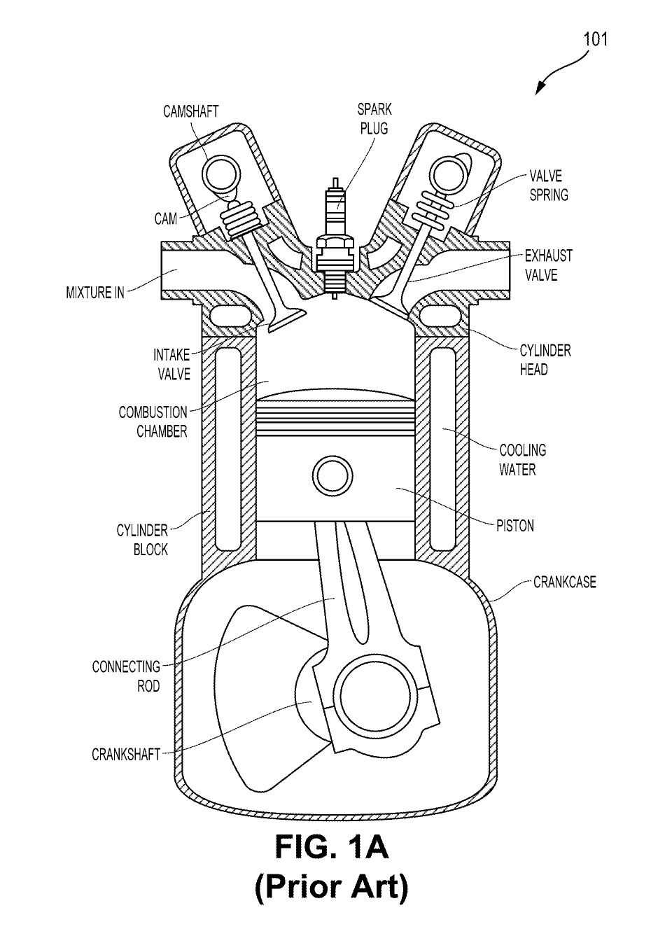

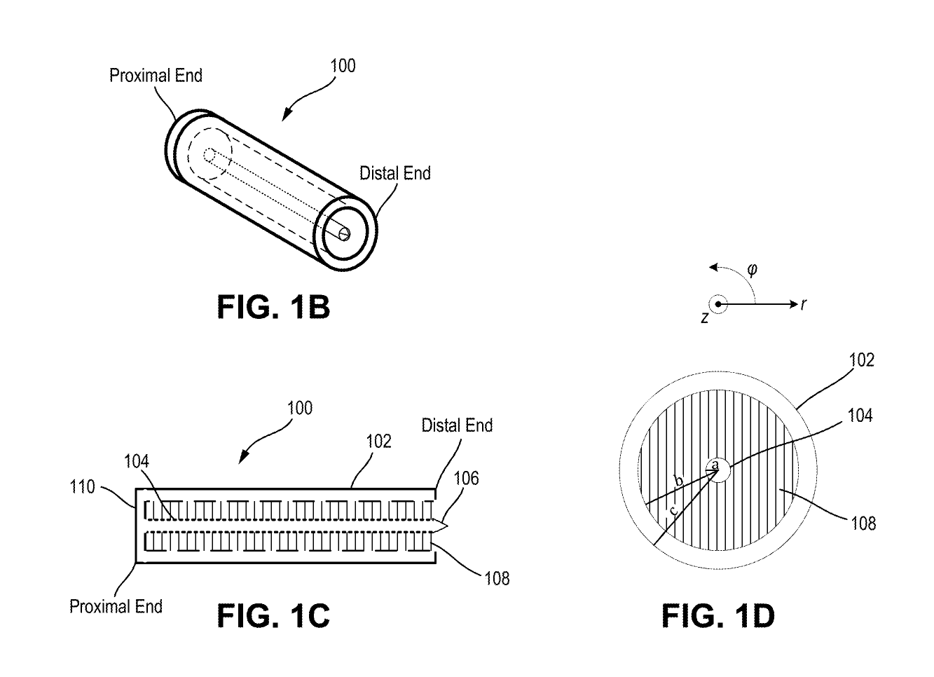

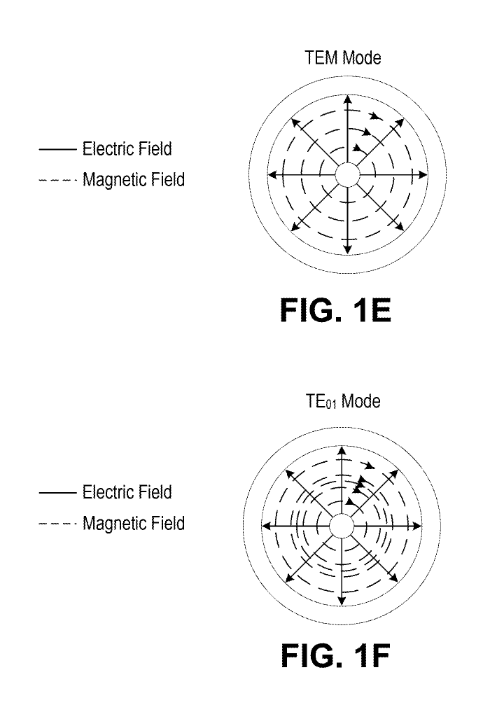

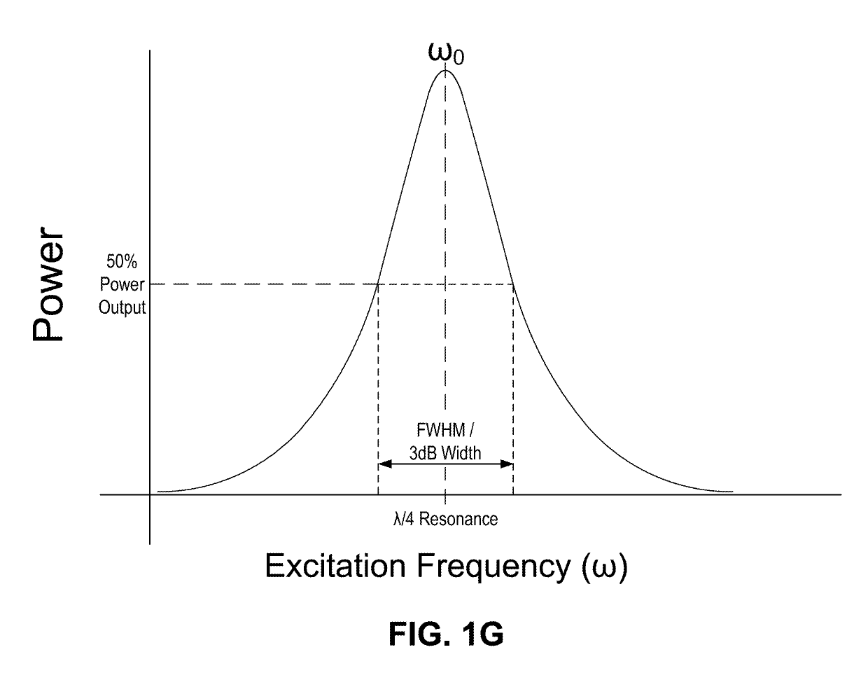

Igniters can be used to ignite a mixture of air and fuel (for example, within a combustion chamber of an internal combustion engine 101, such as that illustrated in cross-section in FIG. 1A). For example, igniters can be configured as gap spark igniters, similar to an automotive spark plug. However, gap spark igniters might not be desirable in some applications and/or under some conditions. For example, a gap spark igniter might not be capable of igniting and initiating combustion of fuel mixtures that have fuel-to-air ratios below a certain threshold. Further, lean mixtures of fuel and air might have significant environmental and economic benefits by making combustion (for example, within a combustor or an afterburner) more efficient, and thus, using a gap spark igniter might preclude achieving such benefits. In addition, higher thermal efficiencies can be achieved by operating at higher power densities and pressures. However, using more energetic or powerful gap spark igniters reduces overall ignition efficiency because the higher energy levels can be detrimental to the gap spark igniter's lifetime. Higher energy levels might also contribute to the formation of undesirable pollutants and can reduce overall engine efficiency.

While gap spark igniters are described above, other types of igniters can generally include glow plugs (for example, in diesel-fueled internal combustion engines), open flame sources (for example, cigarette lighters, friction spark devices, etc.), and other heat sources.

A variety of fuels (for example, hydrocarbon fuels) can be combusted to yield energy within an internal combustion engine, within a power-generation turbine, within a jet engine, or within various other applications. For example, kerosene (also known as paraffin or lamp oil), gasoline (also known as petrol), fractional distillates of petroleum fuel oil (for example, diesel fuel), crude oil, Fischer-Tropsch synthesized paraffinic kerosene, natural gas, and coal are all hydrocarbon fuels that, when combusted, liberate energy stored within chemical bonds of the fuel. Jet fuel, specifically, can be classified by its “jet propellant” (JP) number. The “jet propellant” (JP) number can correspond to a classification system utilized by the United States military. For example, JP-1 can be a pure kerosene fuel, JP-4 can be a 50% kerosene and 50% gasoline blend, JP-9 can be another kerosene-based fuel, JP-9 can be a gas turbine fuel (for example, including tetrahydrodimethylcyclopentadiene) specifically used in missile applications, and JP-10 can be a fuel similar to JP-9 that includes endo-tetrahydrodicyclopentadiene, exo-tetrahydrodicyclopentadiene, and adamantane. Other forms of jet fuel include zip fuel (for example, high-energy fuel that contains boron), SYNTROLEUM® FT-fuel, other kerosene-type fuels (for example, Jet A fuel and Jet A-1 fuel), and naphtha-type fuels (for example, Jet B fuel). It is understood that other fuels can be combusted as well. Further, the fuel type used can depend upon the application. For example, jet engines, internal combustion engines, and power-generation turbines may each burn different types of fuels.

When fuel (for example, hydrocarbon fuel) interacts with electromagnetic radiation, the fuel can change chemical composition. For example, when hydrocarbon fuel interacts with (for example, is irradiated by) microwaves, some of the hydrogen atoms can be ionized and/or one or more hydrogen atoms can be liberated from a hydrocarbon chain. The processes of liberating hydrogen within fuel, ionizing hydrogen within fuel, or otherwise changing the chemical composition of fuel are collectively referred to in the present disclosure as “reforming” the fuel. Reforming the fuel can include exciting the hydrocarbon fuel at one or more of its natural resonant frequencies (for example, acoustic and/or electromagnetic resonant frequencies) to break one or more of the carbon-hydrogen (or other) bonds within the hydrocarbon chain. When hydrogen within a hydrocarbon fuel becomes ionized and/or is liberated from the hydrocarbon chain, the resulting hydrocarbon fuel can require less energy to burn. Thus, a leaner fuel/air mixture that includes reformed fuel can achieve the same output power (for example, within a combustion chamber of a jet engine or a power-generation turbine) as compared to a more rich fuel/air mixture that includes non-reformed fuel, since the reformed fuel can combust more quickly and thoroughly. Analogously, when comparing equal fuel-to-air ratios, less input energy can be required to combust a mixture that includes reformed fuel when compared to a mixture that includes non-reformed fuel.

In addition to reforming fuels, electromagnetic radiation can alter an energy state of fuel and/or of a fuel mixture. In an example implementation, altering the energy state of fuel can include exciting electrons within the valence band of the hydrocarbon chain to higher energy levels. In such scenarios, raising the energy state can also include reorienting polar molecules (for example, water and/or polar hydrocarbon chains) within a fuel/air mixture due to electromagnetic fields applying a torque on polar molecules. Reorienting polar molecules can result in molecular motion, thereby increasing an effective temperature and/or kinetic energy of the molecule, which raises the energy state of fuel. By raising the energy state of fuel, the activation energy for combustion of the fuel can be reduced. When the activation energy for combustion is reduced, the energy supplied by the ignition source can also be decreased, thereby conserving energy during ignition.

Presently disclosed are ignition systems with resonators (for example, QWCCR structures) that use both RF power and DC power. The presently disclosed RF ignition systems provide an alternative to other types of igniters. For example, the QWCCR structure can be used as an igniter (for example, in place of an automotive gap spark plug) in the internal combustion engine 101. Such RF ignition systems can excite plasma (for example, within a corona). If an igniter is configured as one of the RF ignition systems presently disclosed, then more efficient, leaner, cleaner combustion can be achieved. Such increased combustion efficiency can be achieved at decreased air pressures and temperatures when compared with a gap spark igniter (for example, if the RF ignition system is used in a jet engine). Further, such increased combustion efficiency can be achieved at higher air pressures and temperatures when compared with a gap spark igniter. It is understood throughout this disclosure that where reference is made to “RF” or to microwaves, in alternate implementations, other wavelengths of electromagnetic waves outside of the RF range can be used alternatively or in addition to RF electromagnetic waves.

As described above, RF ignition systems can excite plasma. Plasma is one of the four fundamental states of matter (in addition to solid, liquid, and gas). Further, plasmas are mixtures of positively charged gas ions and negatively charged electrons. Because plasmas are mixtures of charged particles, plasmas have associated intrinsic electric fields. In addition, when the charged particles in the mixture move, plasmas also produce magnetic fields (for example, according to Ampere's law). Given the electromagnetic nature of plasmas, plasmas interact with, and can be manipulated by, external electric and magnetic fields. For example, placing a ferromagnetic material (for example, iron, cobalt, nickel, neodymium, samarium-cobalt, etc.) near a plasma can cause the plasma to be attracted to or repelled from the ferromagnetic material (for example, causing the plasma to move).

Plasmas can be formed in a variety of ways. One way of forming a plasma can include heating gases to a sufficiently high temperature (for example, depending on ambient pressure). Additionally or alternatively, forming a plasma can include exposing gases to a sufficiently strong electromagnetic field. Lightning is an environmental phenomenon involving plasma. One application of plasma can include neon signs. Further, because plasma is responsive to applied electromagnetic fields, plasma can be directed according to specific patterns. Hence, plasmas can also be used in technologies such as plasma televisions or plasma etching.

Plasmas can be characterized according to their temperature and electron density. For example, one type of plasma can be a “microwave-generated plasma” (for example, ranging from 5 eV to 15 eV in energy). Such a plasma can be generated by a QWCCR structure, for example.

III. Example Resonator

An example implementation of a QWCCR structure 100 is illustrated in FIGS. 1B-1D. As illustrated, the QWCCR structure 100 can include an outer conductor 102, an inner conductor 104 with an associated electrode 106, a base conductor 110, and a dielectric 108. Also as illustrated, the QWCCR structure 100 can be shaped as concentric circular cylinders. The inner conductor 104 can have radius ‘a’, the outer conductor 102 can have inner radius ‘b’, and the outer conductor 102 can have outer radius ‘c’, as illustrated in cross-section in FIG. 1D. In alternate implementations, the QWCCR structure 100 can have other shapes (for example, concentric ellipsoidal cylinders or concentric, enclosed, elongated volumes with square or rectangular cross-sections). The inner conductor 104, the outer conductor 102 (or just the inner surface of the outer conductor 102), the electrode 106, and the base conductor 110 can be made of various conductive materials (for example, steel, gold, silver, platinum, nickel, or alloys thereof). Further, in some implementations, the inner conductor 104, the outer conductor 102, and the base conductor 110 can be made of the same conductive materials, while in other implementations, the inner conductor 104, the outer conductor 102, and the base conductor 110 can be made of different conductive materials. Additionally, in some implementations, the inner conductor 104, the outer conductor 102, and/or the base conductor 110 can include a dielectric material coated in a conductor (for example, a metal-plated ceramic). In such implementations, the conductive coating can be thicker than a skin-depth of the conductor at a given excitation frequency of the QWCCR structure 100 such that electricity is conducted throughout the conductive coating.

As illustrated, an electrode 106 can be disposed at a distal end of the inner conductor 104. The electrode 106 can be made of a conductive material as described above (for example, the same conductive material as the inner conductor 104). For example, the electrode 106 can be machined with the inner conductor 104 as a single piece. In some implementations, as illustrated, the base conductor 110, the outer conductor 102, the inner conductor 104, and the electrode can be shorted together. For example, the base conductor 110 can short the outer conductor 102 to the inner conductor 104, in some implementations. When shorted together, these components can be directly electrically coupled to one another such that each of these components is at the same electric potential.

Further, in implementations where the base conductor 110, the outer conductor 102, and the inner conductor 104 (including the electrode 106) are shorted together, the base conductor 110, the outer conductor 102, and the inner conductor 104 (including the electrode 106) can be machined as a single piece. In addition, the electrode 106 can include a concentrator (for example, a tip, a point, or an edge), which can concentrate and enhance the electric field at one or more locations. Such an enhanced electric field can create conditions that promote the excitation of a plasma corona near the concentrator (for example, through a breakdown of a dielectric, such as air, that surrounds the concentrator). The concentrator can be a patterned or shaped portion of the electrode 106, for example. The electrode 106, including the concentrator, can be electromagnetically coupled to the inner conductor 104. In the present disclosure and claims, the electrode 106 and/or the concentrator can be described as being “configured to electromagnetically couple to” the inner conductor 104. This language is to be interpreted broadly as meaning that the electrode 106 and/or the concentrator: are presently electromagnetically coupled to the inner conductor 104, are always electromagnetically coupled to the inner conductor 104, can be selectively electromagnetically coupled to the inner conductor 104 (for example, using a switch), are only electromagnetically coupled to the inner conductor 104 when a power source is connected to the inner conductor 104, and/or are able to be electromagnetically coupled to the inner conductor 104 if one or more components are repositioned relative to one another. For example, the electrode 106 can be “configured to electromagnetically couple to” the inner conductor 104 if the electrode 106 is machined as a single piece with the inner conductor 104, if the electrode 106 is connected to the inner conductor 104 using a wire or other conducting mechanism, or if the electrode 106 is disposed sufficiently close to the inner conductor 104 such that the electrode 106 electromagnetically couples to one or more evanescent waves excited by the inner conductor 104 when the inner conductor 104 is connected to a power source.

As illustrated in FIG. 1C, the electrode 106 and/or a concentrator of the electrode 106 can extend beyond the distal end of the outer conductor 102 and/or the distal end of the dielectric 108. In alternate implementations, the electrode 106 and/or a concentrator of the electrode 106 can be flush with the distal end of the outer conductor 102 and/or the distal end of the dielectric 108. In alternate implementations, the electrode 106 and/or a concentrator of the electrode 106 can be shorter than the outer conductor 102, such that no portion of the electrode 106 and/or concentrator is flush with the distal end of the outer conductor 102 and no portion extends beyond the distal end of the outer conductor 102. The QWCCR structure 100 can be excited at resonance, in some implementations. The resonance can generate a standing voltage quarter-wave within the QWCCR structure 100. If the concentrator, the distal end of the outer conductor 102, and the distal end of the dielectric 108 are each flush with one another, the electromagnetic field can quickly collapse outside of the QWCCR structure 100, thereby concentrating the majority of the electromagnetic energy at the concentrator. In still other implementations, the distal end of the outer conductor 102 and/or the distal end of the dielectric 108 can extend beyond the electrode 106 and/or a concentrator of the electrode 106. The electrode 106 can effectively modify the physical length of the inner conductor 104, which can modify the resonance conditions of the QWCCR structure 100 (for example, can modify the electrical length of the QWCCR structure 100). Various resonance conditions can thus be achieved across a variety of QWCCR structures 100 by varying the geometry of the electrode 106 and/or a concentrator of the electrode 106.

Further, as illustrated in FIG. 1C, the base conductor 110 can be electrically coupled to the outer conductor 102 and the inner conductor 104. In alternate implementations, the inner conductor 104 can be electrically insulated from the outer conductor 102 (rather than shorted together through the base conductor 110).

Plasmas (for example, plasma coronas generated by the QWCCR structure 100) can be used to ignite mixtures of air and fuel (for example, hydrocarbon fuel for use in a combustion process). Plasma-assisted ignition (for example, using a QWCCR structure 100) is fundamentally different from ignition using a gap spark plug. For example, efficient electron-impact excitation, dissociation of molecules, and ionization of atoms, which might not occur in ignition using gap spark plugs, can occur in plasma-assisted ignition. Further, in plasmas, an external electric field can accelerate the electrons and/or ions. Thus, using electric fields, energy within the plasma (for example, thermal energy) can be directed to specific locations (for example, within a combustion chamber).

There are a variety of mechanisms by which plasma can impart the energy necessary to ignite mixtures of air and fuel. For example, electrons can impart energy to molecules during collisions. However, this singular energy exchange might be relatively minor (for example, because an electron's mass is orders of magnitude less than a molecule's mass). So long as the rate at which electrons are imparting energy to the molecules is higher than the rate at which molecules are undergoing relaxation, a population distribution of the molecules (for example, a population distribution that differs from an initial Boltzmann distribution of the molecules) can arise. The molecules having higher energy, along with the dissociation and ionization processes, can emit ultraviolet (UV) radiation (for example, when undergoing relaxation) that affects mixtures of fuel and air. Further, gas heating and an increase in system reactivity can increase the likelihood of ignition and flame propagation. In addition, when the average electron energy within a plasma (for example, within a combustion chamber) exceeds 10 eV, gas ionization can be the predominant mechanism by which plasma is formed (over electron-impact excitation and dissociation of molecules).

Plasma-assisted ignition can have a variety of benefits over ignition using a gap spark plug. For example, in plasma-assisted ignition, a plasma corona that is generated can be physically larger (for example, in length, width, radius, and/or overall volumetric extent) than a typical spark from a gap spark plug. This can allow a more lean fuel mixture (also known as lower fuel-to-air ratio) to be burned once combustion occurs as compared with alternative ignition, for example. Also, because a larger energy can be energized in plasma-assisted ignition, stoichiometric ratio fuels can be combusted more fully, thereby creating fewer regulated pollutants (for example, creating less NOₓ to be expelled as exhaust) and/or leaving less unspent fuel.

Dielectric breakdown of air or another dielectric material near the electrode 106 of the QWCCR structure 100 can be a mechanism by which a plasma corona is excited near the concentrator of the QWCCR structure 100. Factors that impact the breakdown of a dielectric, such as dielectric breakdown of air, include free-electron population, electron diffusion, electron drift, electron attachment, and electron recombination. Free electrons in the free-electron population can collide with neutral particles or ions during ionization events. Such collisions can create additional free electrons, thereby increasing the likelihood of dielectric breakdown. Oppositely, electron diffusion and attachment can each be mechanisms by which free electrons recombine and are lost, thereby reducing the likelihood of dielectric breakdown.

As presently described, a plasma corona can be provided “proximate to” a distal end of the QWCCR structure 100, the electrode 106, and/or a concentrator of the QWCCR structure 100. In other words, the plasma corona could be described as being provided “nearby” or “at” a distal end of the QWCCR structure 100, the electrode 106, and/or a concentrator of the QWCCR structure 100. Further, this terminology is not to be viewed as limiting. For example, while the plasma corona is provided “proximate to” the QWCCR structure 100, this does not limit the plasma corona from extending away from the QWCCR structure 100 and/or from being moved to other locations that are farther from the QWCCR structure 100 after being provided “proximate to” the QWCCR structure 100.

When used to describe a relationship between a plasma corona and a distal end of the QWCCR structure 100, a relationship between a plasma corona and the electrode 106, a relationship between a plasma corona and a concentrator of the electrode 106, or similar relationships, the term “proximate” can describe the physical separation between the plasma corona and the other component. In various implementations, the physical separation can include different ranges. For example, a plasma corona provided “proximate to” the concentrator can be separated from the concentrator (in other words, can “stand off from” the concentrator) by less than 1.0 nanometer, by 1.0 nanometer to 10.0 nanometers, by 10.0 nanometers to 100.0 nanometers, by 100.0 nanometers to 1.0 micrometer, by 1.0 micrometer to 10.0 micrometers, by 10.0 micrometers to 100.0 micrometers, or by 100.0 micrometers to 1.0 millimeter. Additionally or alternatively, a plasma corona provided “proximate to” the concentrator can be separated from the concentrator by 0.01 times a width of the plasma corona to 0.1 times a width of the plasma corona, by 0.1 times a width of the plasma corona to 1.0 times the width of the plasma corona, or by 1.0 times a width of the plasma corona to 10.0 times a width of the plasma corona. Even further, a plasma corona provided “proximate to” the concentrator can be separated from the concentrator by 0.01 times a radius of the concentrator to 0.1 times a radius of the concentrator, by 0.1 times a radius of the concentrator to 1.0 times a radius of the concentrator, or by 1.0 times a radius of the concentrator to 10.0 times a radius of the concentrator.

It is understood that in various implementations, the plasma corona can emit light entirely within the visible spectrum, partially within the visible spectrum and partially outside the visible spectrum, or completely outside the visible spectrum. In other words, even if the plasma corona is “invisible” to the human eye and/or to optics that only sense light within the visible spectrum, it is not necessarily the case that the plasma corona is not being provided.

IV. Mathematical Description of Example Resonator

In order for dielectric breakdown to occur, an electric field within the dielectric must be greater than or equal to an electric field breakdown threshold. An electric field generated by an alternating current (AC) source can be described by a root-mean-square (rms) value for electric field (Eᵣₘₛ). The rms value for electric field (Eᵣₘₛ) can be calculated according the following equation:

$${E}_{rms} = \sqrt{\frac{1}{{T}_{2} - {T}_{1}} {\int }_{{T}_{1}}^{{T}_{2}} {E}^{2} dt}$$

where T₂−T₁ represents the period over which the electric field is oscillating (for example, corresponding to the period of the AC source generating the electric field). As described mathematically above, the rms value for electric field (Eᵣₘₛ) represents the quadratic mean of the electric field. Using the rms value for electric field, an effective electric field (E_{eff}) can be calculated that is approximately frequency independent (for example, by removing phase lag effects from the oscillating electric field):

$${E}_{eff}^{2} = {E}_{rms}^{2} \frac{{v}_{c}^{2}}{{ω}^{2} + {v}_{c}^{2}}$$

where ω represents the angular frequency of the electric field (for example,

$$ω = \frac{2 π}{{T}_{2} - {T}_{1}} )$$

and v_{c} represents the effective momentum collision frequency of the electrons and neutral particles. The angular frequency (ω) of the electric field can correspond to the frequency of an excitation source used to excite the electric field (for example, the QWCCR structure 100). Using this effective electric field (E_{eff}), DC breakdown voltages for various gases (and potentially other dielectrics) can be related to AC breakdown values for uniform electric fields. For air, v_{c}≈5·10⁹×p, where p represents the pressure (in torr). At atmospheric pressure (for example, around 760 torr) or above and excitation frequencies of below 1 THz, the effective momentum collision frequency of the electrons and neutral particles (v_{c}) will dominate the denominator of the fractional coefficient of Eᵣₘₛ². Therefore, an approximation of the rms breakdown field (E_{b}) can be used. The rms breakdown field (E_{b}), in V/cm, of a uniform microwave field in the collision regime can be given by:

$${E}_{b} = 30 \cdot 297 ( \frac{p}{T} )$$

where T is the temperature in Kelvin.

An analytical description of the electromagnetics of the QWCCR structure 100 follows.

If fringing electromagnetic fields are assumed to be small, the lowest quarter-wave resonance in a coaxial cavity is a transverse electromagnetic mode (TEM mode) (as opposed to a transverse electric mode (TE mode) or a transverse magnetic mode (TM mode)). The TEM mode is the dominant mode in a coaxial cavity and has no cutoff frequency (ω_{c}). In the TEM mode (as illustrated in FIG. 1E), because neither the electric field nor the magnetic field have any components in the z-direction (coordinate system illustrated in FIG. 1D), the electric and magnetic fields can be written, respectively, as:

$$H = {H}_{ϕ} {\hat{a}}_{ϕ} = \frac{{I}_{0}}{2 π r} cos ( β z ) {\hat{a}}_{ϕ}$$

$$E = {E}_{r} {\hat{a}}_{r} = \frac{{V}_{0}}{2 π r} sin ( β z ) {\hat{a}}_{r}$$

where H is a phasor representing the magnetic field vector, E is a phasor representing the electric field vector, â_{φ} represents a unit vector in the φ direction (labeled in FIG. 1D), âᵣ represents a unit vector in the r direction (labeled in FIG. 1D), β represents the wave number (canonically defined as

$$β = \frac{2 π}{λ} ,$$

where λ is the wavelength), I₀ represents the maximum current in the cavity, V₀ represents the maximum voltage in the cavity, and z represents a distance along the QWCCR structure 100 in the z direction (labeled in FIG. 1D).

In various implementations, various electromagnetic modes of the QWCCR structure 100 can be excited in order to achieve various electromagnetic properties. In some implementations, for instance, a single electromagnetic mode can be excited, whereas in alternate implementations, a plurality of electromagnetic modes can be excited. For example, in some implementations, the TE₀₁ mode (as illustrated in FIG. 1F) can be excited.

Quality factor (Q) can be defined as:

$$Q = \frac{ω \cdot U}{{P}_{L}} \to U = \frac{{P}_{L} \cdot Q}{ω}$$

where co is the angular frequency, U is the time-average energy, and P_{L} is the time-average power loss. Quality factor (Q) can be used to measure goodness of a resonator cavity. Other formulations of goodness measurement can also be used (for example, based on full-width, half-max (FWHM) or a 3 decibel (dB) bandwidth of cavity resonance). In some implementations, the quality factor (Q) can be maximized when the ratio of the inner radius of the outer conductor ‘b’ to the radius of the inner conductor ‘a’ is approximately equal to 4. However, it will be understood that many other ways to adjust and/or maximize quality factor (Q) are possible and contemplated in the present disclosure.

At resonance, the stored energy of the QWCCR structure 100 oscillates between electrical energy (Uₑ) (within the electric field) and magnetic energy (Uₘ) (within the magnetic field). Time-average stored energy in the QWCCR structure 100 can be calculated using the following:

$$U = {U}_{m} + {U}_{e} = \frac{1}{4} {\int }_{vol} µ {\vert H \vert}^{2} + ɛ {\vert E \vert}^{2}$$

where μ is magnetic permeability and E is dielectric permittivity. By inserting the values for electric field and magnetic field from above, and integrating over the entire volume of the QWCCR structure 100, the following expression can be obtained:

$$U = \frac{ln ( \frac{b}{a} ) \cdot λ}{64 π} ( µ \cdot {I}_{0}^{2} + ɛ \cdot {V}_{0}^{2} )$$

where b represents the inner radius of the outer conductor 102 of the QWCCR structure 100 (as illustrated in FIG. 1D), a represents the radius of the inner conductor 104 of the QWCCR structure 100 (as illustrated in FIG. 1D), and represents the wavelength of the source (for example, AC source) used to excite the QWCCR structure 100. Because the magnetic energy at maximum is the same as the electric energy at maximum, μ·I₀² can be replaced with ε·V₀², thus resulting in:

$$U = \frac{ln ( \frac{b}{a} ) \cdot λ}{32 π} ( ɛ \cdot {V}_{0}^{2} )$$

Now, by equating the two above expressions for U, the following relationship can be expressed:

$$\frac{{P}_{L} \cdot Q}{ω} = \frac{ln ( \frac{b}{a} ) \cdot λ}{32 π} ( ɛ \cdot {V}_{0}^{2} ) \to {V}_{0} = \sqrt{\frac{32 π \cdot Q \cdot {P}_{L}}{ω \cdot ɛ \cdot ln ( \frac{b}{a} ) \cdot λ}}$$

Further, in recognizing that

$$ω = 2 π f = \frac{2 π c}{λ} ,$$

where c is the speed of light;

$$c = \sqrt{\frac{1}{µ \cdot ɛ}} ; and η = \sqrt{\frac{µ}{ɛ}} ,$$

where η is the impedance of the dielectric between the inner conductor 104 and the outer conductor 102 of the QWCCR structure 100, the following relationship for the peak potential (V₀) can be identified:

$${V}_{0} = 4 \sqrt{\frac{η \cdot Q \cdot {P}_{L}}{ln ( \frac{b}{a} )}}$$

Given that electric field decays as the distance from the peak potential (V₀) increases, the largest value of electric field corresponding to the peak potential (V₀) occurs exactly at the surface of the inner conductor (for example, at radius a, as illustrated in FIG. 1D). Using the above equation for phasor electric field (E), the peak value of electric field (Eₐ) can be expressed as:

$${E}_{a} = \frac{{V}_{0}}{2 π a} = \frac{2}{π a} \sqrt{\frac{η \cdot Q \cdot {P}_{L}}{ln ( \frac{b}{a} )}}$$

If the above peak value of electric field (Eₐ) meets or exceeds the above-described rms breakdown field (E_{b}), a dielectric breakdown can occur. For example, a dielectric breakdown of the air surrounding the tip of the QWCCR structure 100 can result in a plasma corona being excited. As indicated in the above equation for peak electric field (Eₐ), the smaller the radius a of the inner conductor 104, the smaller the inner radius b of outer conductor 102, the higher the quality factor (Q) of the QWCCR structure 100, and the larger the time-average power loss (P_{L}), the more likely it is that breakdown can occur (for example, because the peak value of electric field (Eₐ) is larger). A larger excitation power can correspond to a larger time-average power loss (P_{L}) in the QWCCR structure 100, for example.

The power loss (P_{L}) can include ohmic losses (Pₐ) on conductive surfaces (for example, the surface of the outer conductor 102, the surface of the inner conductor 104, and/or the surface of the base conductor 110, as illustrated in FIG. 1C), dielectric losses (P_{σ}_{ₑ}) in the dielectric 108, and radiation losses (P_{rad}) from a radiating end of the QWCCR structure 100 (for example, the distal end of the QWCCR structure 100). Each of the conductors can have a corresponding surface resistance (R_{S}). The surface resistance (R_{S}) can be the same for one or more of the conductors if the corresponding conductors are made of the same conductive materials. The corresponding surface resistance for each conductor can be expressed as

$${R}_{S} = \sqrt{\frac{ω \cdot {µ}_{c}}{2 \cdot {σ}_{c}}} ,$$

where μ_{c} is the magnetic permeability of the respective conductor and σ_{c} is the conductivity of the respective conductor. The power lost by each conductor can be calculated according to the following:

$${P}_{σ} = \frac{1}{2} {\int }_{A} {R}_{S} {\vert {H}_{//} \vert}^{2}$$

where H_{//} is the magnetic field parallel to the surface of the conductor. Thus, the total power loss in all conductors can be represented by:

$${P}_{σ} = {P}_{inner} + {P}_{outer} + {P}_{base} = \frac{{R}_{S} \cdot {I}_{0}^{2}}{4 π} [ \frac{λ}{8 \cdot a} + \frac{λ}{8 \cdot b} + ln ( \frac{b}{a} ) ]$$

Further, if the dielectric 108 is an isotropic, low-loss dielectric, the dielectric 108 can be characterized by its dielectric constant (ε) and its loss tangent (tan(δₑ)), where the loss tangent (tan(δₑ)) represents conductivity and alternating molecular dipole losses. Using dielectric constant (E) and loss tangent (tan(δₑ)), an effective dielectric conductivity (σₑ) can be approximately defined as:

σₑ≈ω·ε·tan(δₑ)

Based on the above, the power dissipated in the dielectric can be calculated according to the following:

$${P}_{{σ}_{e}} = \frac{1}{2} {\int }_{vol} {σ}_{e} {\vert E \vert}^{2} = \frac{{σ}_{e} \cdot η \cdot {I}_{0}^{2}}{4 π} ( \frac{ln ( \frac{b}{a} ) \cdot λ}{8} )$$

In order to combine all quality factors of the QWCCR structure 100 into a total internal quality factor (Qᵢₙₜ), the following relationship can be used:

$${Q}_{int} = \frac{1}{( {Q}_{inner}^{- 1} + {Q}_{outer}^{- 1} + {Q}_{base}^{- 1} + {Q}_{{σ}_{e}}^{- 1} )}$$

where Qᵢₙₙₑᵣ⁻¹, Qₒᵤₜₑᵣ⁻¹, Q_{base}⁻¹, and Q_{σ}_{ₑ}⁻¹ are the quality factors of the inner conductor 104, the outer conductor 102, the base conductor 110, and the dielectric 108, respectively. Using the above expression for quality factor (Q) in terms of time-average power loss (P_{L}), angular frequency (ω), and time-average energy (U), the following expression for internal quality factor (Qᵢₙₜ) can be determined:

$${Q}_{int} = {( \frac{{R}_{S}}{2 \cdot π \cdot η} [ \frac{( \frac{b}{a} + 1 )}{\frac{b}{a} \cdot ln ( \frac{b}{a} )} + 8 ] + tan ( {δ}_{e} ) )}^{- 1}$$

Based on the definitions of the individual quality factors above, the individual contribution of the outer conductor quality factor (Qₒᵤₜₑᵣ) to the internal quality factor (Qᵢₙₜ) can be greater than the individual contribution of the inner conductor quality factor (Qᵢₙₙₑᵣ). Thus, to increase the internal quality factor (Qᵢₙₜ), a material with higher conductivity can be used for the inner conductor 104 than is used for the outer conductor 102. Further, the base conductor 110 quality factor (Q_{base}) and the dielectric 108 quality factor (Q_{σ}_{ₑ}) can be unaffected by the geometry of the QWCCR structure 100 (both in terms of

$$\frac{b}{a}$$

and in terms of

$$\frac{b}{λ} ) .$$

The QWCCR structure 100 can also radiate electromagnetic waves (for example, from a distal, non-closed end opposite the base conductor 110). For example, if the QWCCR structure 100 is being excited by an RF power source (for example, a signal generator oscillating at radio frequencies), the QWCCR structure 100 can radiate microwaves from a distal end (for example, from an aperture of the distal end) of the QWCCR structure 100. Such radiation can lead to power losses, which can be approximated using admittance. Assuming that the transverse dimensions of the QWCCR structure 100 are significantly smaller than the wavelength (λ) being used to excite the QWCCR structure 100 (in other words, a<<λ and b<<λ), the real part (Gᵣ) and imaginary part (Bᵣ) of admittance can be represented by:

$${G}_{r} \approx \frac{4 \cdot {π}^{5} \cdot {[ {( \frac{( \frac{b}{λ} )}{( \frac{b}{a} )} )}^{2} - {( \frac{b}{λ} )}^{2} ]}^{2}}{3 \cdot η \cdot {ln}^{2} ( \frac{b}{a} )}$$

$${B}_{r} \approx \frac{16 \cdot π \cdot ( \frac{( \frac{b}{λ} )}{( \frac{b}{a} )} - ( \frac{b}{λ} ) )}{η \cdot {ln}^{2} ( \frac{b}{a} )} \cdot [ E ( \frac{2 \sqrt{\frac{b}{a}}}{1 + \frac{b}{a}} ) - 1 ]$$

where E(x) is the complete elliptical integral of the second kind. Namely:

$$E ( x ) = {\int }_{0}^{\frac{π}{2}} \sqrt{1 - {x}^{2} \cdot {sin}^{2} ( θ )} \cdot d θ$$

Further, the line integral of the electric field from the inner conductor 104 to the outer conductor 102 can be used to determine the potential difference (V_{ab}) across the shunt admittance corresponding to the electromagnetic waves radiated.

$${V}_{ab} {\vert}_{β z = \frac{π}{4}} = {\int }_{a \to b} {E}_{r} = \frac{{V}_{0} ln ( \frac{b}{a} )}{2 π}$$

Using the potential difference (V_{ab}) across the shunt admittance corresponding to the electromagnetic waves radiated, the power going to radiation (P_{rad}) can be represented by:

$${P}_{rad} = \frac{1}{2} {G}_{r} {V}_{ab}^{2} = \frac{{V}_{0} {{{π}^{3} ( \frac{b}{λ} )}^{4} [ {( \frac{b}{a} )}^{2} - 1 ]}^{2}}{6 η {( \frac{b}{a} )}^{4}}$$

In addition, using the potential difference (V_{ab}) across the shunt admittance corresponding to the electromagnetic waves radiated, the energy stored during radiation (U_{rad}) can be represented by:

$${U}_{rad} = \frac{1}{4} ( \frac{{B}_{r}}{ω} ) {V}_{ab}^{2} = \frac{ɛ {V}_{0}^{2} λ ( \frac{b}{λ} ) [ {( \frac{b}{a} )}^{- 1} + 1 ]}{2 {π}^{2}} [ E ( \frac{2 \sqrt{\frac{b}{a}}}{1 + \frac{b}{a}} ) + 1 ]$$

Based on the above, the overall quality factor of the QWCCR structure 100 (Q_{QWCCR}) can be described by the following:

$${Q}_{QWCCR} = \frac{ω ( U + {U}_{rad} )}{{P}_{inner} + {P}_{outer} + {P}_{base} + {P}_{{σ}_{e}} + {P}_{rad}}$$

If the energy stored during radiation (U_{rad}) is small compared with the energy stored in the interior of the QWCCR structure 100 (U), the radiation power (P_{rad}) can be treated similarly to the other losses. Further, the energy stored during radiation (U_{rad}) can be neglected in the above equation:

$$Q \approx \frac{ω ( U )}{{P}_{inner} + {P}_{outer} + {P}_{base} + {P}_{{σ}_{e}} + {P}_{rad}}$$

Still further, the quality factor of the radiation component (Q_{rad}) can be described using the above relationship for quality factors:

$${Q}_{rad} = \frac{ω U}{{P}_{rad}} = \frac{3 {( \frac{b}{λ} )}^{4} ln ( \frac{b}{a} )}{8 {{{π}^{3} ( \frac{b}{λ} )}^{4} [ {( \frac{b}{a} )}^{2} - 1 ]}^{2}}$$

Even further, using the above-referenced quality factors, the total quality factor of the QWCCR structure 100 (Q_{QWCCR}) can be approximated by:

$${Q}_{QWCCR} \approx {( \frac{8 {{{π}^{3} ( \frac{b}{λ} )}^{4} [ {( \frac{b}{a} )}^{2} - 1 ]}^{2}}{3 {( \frac{b}{a} )}^{4} ln ( \frac{b}{a} )} + \frac{{R}_{s}}{2 πη \\} [ \frac{( ( \frac{b}{a} ) + 1 )}{( \frac{b}{λ} ) ln ( \frac{b}{a} )} + 8 ] + tan ( {δ}_{e} ) )}^{- 1}$$

Based on the above relationships, it can be shown that one method of minimizing losses due to radiation of electromagnetic waves by the QWCCR structure 100 is to minimize the inner radius b of the outer conductor 102 with respect to the excitation wavelength (λ). Another way of minimizing losses due to radiation of electromagnetic waves is to select an inner radius b of the outer conductor 102 that is close in dimension to the radius a of the inner conductor 104.

Various physical quantities and dimensions of the QWCCR structure 100 can be adjusted to modify performance of the QWCCR structure 100. For example, physical quantities and dimensions can be modified to maximize and/or optimize the total quality factor of the QWCCR structure 100 (Q_{QWCCR}). In some implementations, different dielectrics can be inserted into the QWCCR structure 100. In one implementation, the dielectric 108 can include a composite of multiple dielectric materials. For example, a half of the dielectric 108 near a proximal end of the QWCCR structure 100 can include alumina ceramic while a half of the dielectric 108 near a distal end of the QWCCR structure 100 can include air. The resonant frequency can be based on the dimensions and the fabrication materials of the QWCCR structure 100. Hence, modification of the dielectric 108 can modify a resonant frequency of the QWCCR structure 100. In some implementations, the resonant frequency can be 2.45 GHz based on the dimensions of the QWCCR structure 100. In other implementations, the resonant frequency of the QWCCR structure 100 could be within an inclusive range between 1 GHz to 100 GHz. In still other implementations, the resonant frequency of the QWCCR structure 100 could be within an inclusive range of 100 MHz to 1 GHz or an inclusive range of 100 GHz to 300 GHz. However, other resonant frequencies are contemplated within the context of the present disclosure.

An RF power source exciting the QWCCR structure 100 can generate a standing electromagnetic wave within the QWCCR structure 100. In some implementations, the resonant frequency of the QWCCR structure 100 can be designed to match the frequency of an RF power source that is exciting the QWCCR structure 100 (for example, to maximize power transferred to the QWCCR structure 100). For example, if a desired excitation frequency corresponds to a wavelength of 4, dimensions of the QWCCR structure 100 can be modified such that the electrical length of the QWCCR structure 100 is an odd-integer multiple of quarter wavelengths (for example, ¼λ₀, ¾λ₀, 5/4λ₀, 7/4λ₀, 9/4λ₀, 11/4λ₀, 13/4λ₀, etc.). The electrical length is a measure of the length of a resonator in terms of the wavelength of an electromagnetic wave used to excite the resonator. The QWCCR structure 100 can be designed for a given resonant frequency based on the dimensions of the QWCCR structure 100 (for example, adjusting dimensions of the inner conductor 104, the outer conductor 102, or the dielectric 108) or the materials of the QWCCR structure 100 (for example, adjusting materials of the inner conductor 104, the outer conductor 102, or the dielectric 108).

In other implementations, the resonant frequency of the QWCCR structure 100 can be designed or adjusted such that its resonant frequency does not match the frequency of an RF power source that is exciting the QWCCR structure 100 (for example, to reduce power transferred to the QWCCR structure 100). Analogously, the frequency of an RF power source can be de-tuned relative to the resonant frequency of a QWCCR structure 100 that is being excited by the RF power source. Additionally or alternatively, the physical quantities and dimensions of the QWCCR structure 100 can be modified to enhance the amount of energy radiated (for example, from the distal end) in the form of electromagnetic waves (for example, microwaves) from the QWCCR structure 100. As an example, one or more elements of the QWCCR structure 100 could be movable or otherwise adjustable so as to modify the resonant properties of the QWCCR structure 100. Enhancing the amount of energy radiated might be done at the expense of maximizing the electric field at a concentrator of the electrode 106 at the distal end of the inner conductor 104. For example, some implementations can include slots or openings in the outer conductor 102 to increase the amount of radiated energy despite possibly reducing a quality factor of the QWCCR structure 100.

In still other implementations, the physical quantities and dimensions of the QWCCR structure 100 can be designed in such a way so as to enhance the intensity of an electric field at a concentrator of the electrode 106 of the QWCCR structure 100. Enhancing the electric field at a concentrator of the electrode 106 of the QWCCR structure 100 can result in an increase in plasma corona excitation (for example, an increase in dielectric breakdown near the concentrator), when the QWCCR structure 100 is excited with sufficiently high RF power/current. To increase electric field at a concentrator of the electrode 106 of the QWCCR structure 100, a radius of the concentrator can be minimized (for example, configured as a very sharp structure, such as a tip). Additionally or alternatively, to increase the electric field at a tip of the QWCCR structure 100 (for example, thereby increasing the intensity and/or size of an excited plasma corona), the intrinsic impedance (η) of the dielectric 108 can be increased, the power used to excite the QWCCR structure 100 can be increased, and the total quality factor of the QWCCR structure 100 (Q_{QWCCR}) can be increased (for example, by increasing the volume energy storage (U) of the cavity or by minimizing the surface and radiation losses).

Further, the shunt capacitance (C) of a circular coaxial cavity (for example, in farads/meter, and neglecting fringing fields) can be expressed as follows:

$$C = \frac{2 {πɛ}_{0} {ɛ}_{r}}{ln ( \frac{b}{a} )}$$

where ε₀ represents the permittivity of free space, εᵣ represents the relative dielectric constant of the dielectric 108 between the inner conductor 104 and the outer conductor 102, b is the inner radius of the outer conductor 102, and a is the radius of the inner conductor 104 (as illustrated in FIG. 1D).

Similarly, the shunt inductance (L) of a circular coaxial cavity (for example, in henrys/meter) can be expressed as follows:

$$L = \frac{{μ}_{0} {μ}_{r}}{2 π} ln ( \frac{b}{a} )$$

where μ₀ represents the permeability of free space, μᵣ represents the relative permeability of the dielectric 108 between the inner conductor 104 and the outer conductor 102, b is the inner radius of the outer conductor 102, and a is the radius of the inner conductor 104 (as illustrated in FIG. 1D).

Based on the above, the complex impedance (Z) of a circular coaxial cavity (for example, in ohms, Ω) can be expressed as follows:

$$Z = \sqrt{\frac{R + j ω L}{G + j ω C}}$$

where G represents the conductance per unit length of the dielectric between the inner conductor and the outer conductor, R represents the resistance per unit length of the QWCCR structure 100, j represents the imaginary unit (for example, \sqrt{−1}), ω represents the frequency at which the QWCCR structure 100 is being excited, L represents the shunt inductance of the QWCCR structure 100, and C represents the shunt capacitance of the QWCCR structure 100.

At very high frequencies (for example, GHz frequencies) the complex impedance (Z) can be approximated by:

$${Z}_{0} = \sqrt{\frac{L}{C}}$$

where Z₀ represents the characteristic impedance of the QWCCR structure 100 (in other words, the complex impedance (Z) of the QWCCR structure 100 at high frequencies).

As described above, the shunt inductance (L) and the shunt capacitance (C) of the QWCCR structure 100 depend on the relative permeability (μᵣ) and the relative dielectric constant (εᵣ), respectively, of the dielectric 108 between the inner conductor 104 and the outer conductor 102. Thus, any modification to either the relative permeability (μᵣ) or the relative dielectric constant (εᵣ) of the dielectric 108 between the inner conductor 104 and the outer conductor 102 can result in a modification of the characteristic impedance (Z₀) of the QWCCR structure 100. Such modifications to impedance can be measured using an impedance measurement device (for example, an oscilloscope, a spectrum analyzer, and/or an AC volt meter).

The above characteristic impedance (Z₀) represents an impedance calculated by neglecting fringing fields. In some applications and implementations, the fringing fields can be non-negligible (for example, the fringing fields can significantly impact the impedance of the QWCCR structure 100). Further, in such implementations, the composition of the materials surrounding the QWCCR structure 100 can affect the characteristic impedance (Z₀) of the QWCCR structure 100. Measurements of such changes to characteristic impedance (Z₀) can provide information regarding the environment (for example, a combustion chamber) surrounding the QWCCR structure 100 (for example, the temperature, pressure, or atomic composition of the environment). A change in the characteristic impedance (Z₀) can coincide with a change in the cutoff frequency, resonant frequency, short-circuit condition, open-circuit condition, lumped-circuit model, mode distribution, etc. of the QWCCR structure 100.

FIG. 1G illustrates a quarter-wave resonance condition of the QWCCR structure 100. The y-axis of the plot corresponds to a power of electromagnetic waves radiated from a distal end of the QWCCR structure 100 and the x-axis corresponds to an excitation frequency (ω) (for example, from a radio-frequency power source that is electromagnetically coupled to the QWCCR structure 100) used to excite the QWCCR structure 100. As illustrated, the shape of the curve can be a Lorentzian.

As illustrated in FIG. 1G the curve has a maximum power at a quarter-wave (V4) resonance. This resonance can correspond to excitation frequency (ω) that has an associated excitation wavelength that is four times the length of the QWCCR structure 100. In other words, at the resonant frequency (ω₀) the QWCCR structure 100 is being excited by a standing wave, where one-quarter of the length of the standing wave is equal to the length of the QWCCR structure 100. Although not illustrated, it is understood that the QWCCR structure 100 could experience additional resonances (for example, at odd-integer multiples of the resonant wavelength: ¾λ₀, 5/4λ₀, 7/4λ₀, 9/4λ₀, 11/4λ₀, 13/4λ₀, etc.). Each of the additional resonances could look similar to the resonance illustrated in FIG. 1G (for example, could have a Lorentzian shape).

As illustrated, the power of the electromagnetic waves radiated from the distal end of the QWCCR structure 100 decreases exponentially the further the excitation frequency (ω) is from the resonant frequency (ω₀). However, the power of the electromagnetic waves is not necessarily zero as soon as you move away from resonance. Hence, it is understood that even when excited near the quarter-wave resonance condition (in other words, proximate to the quarter-wave resonance condition), rather than exactly at the resonance condition, the QWCCR structure 100 can still radiate electromagnetic waves with non-zero power and/or provide a plasma corona, depending on arrangement.

When the QWCCR structure 100 is being excited such that it provides a plasma corona proximate to the distal end (for example, at the electrode 106), a plot with a shape similar to that of FIG. 1G could be provided. In such a scenario, a plot of voltage at the electrode 106 versus excitation frequency (ω) could include a Gaussian shape, rather than a Lorentzian shape. In other words, the voltage at the electrode 106 may reach a peak when excited by a resonant frequency. The voltage at the electrode 106 may fall off exponentially according to a Gaussian shape as the excitation frequency moves away from the resonant frequency. It will be understood that the Gaussian and Lorentzian shapes presently described may be based on one or more characteristics of the QWCCR structure 100, such as its shape, quality factor, bias conditions, or other factors.

It is understood that when the term “proximate” is used to describe a relationship between a wavelength of a signal (for example, a signal used to excite the QWCCR structure 100) and a resonant wavelength of a resonator (for example, the QWCCR structure 100), the term “proximate” can describe a difference in length. For example, if the wavelength of the signal is “proximate to an odd-integer multiple of one-quarter of the resonant wavelength,” the wavelength of the signal can be equal to, within 0.001% of, within 0.01% of, within 0.1% of, within 1.0% of, within 5.0% of, within 10.0% of, within 15.0% of, within 20.0% of, and/or within 25.0% of one-quarter of the resonant wavelength. Additionally or alternatively, if the wavelength of the signal is “proximate to an odd-integer multiple of one-quarter of the resonant wavelength,” the wavelength of the signal can be within 0.1 nm, within 1.0 nm, within 10.0 nm, within 0.1 micrometers, within 1.0 micrometers, within 10.0 micrometers, within 0.1 millimeters, within 1.0 millimeters, and/or within 1.0 centimeters of one-quarter of the resonant wavelength, depending on context (for example, depending on the resonant wavelength). Still further, if the wavelength of the signal is “proximate to an odd-integer multiple of one-quarter of the resonant wavelength,” the wavelength of the signal can be a multiple of one-quarter of the resonant wavelength that is an odd number plus or minus 0.5, an odd number plus or minus 0.1, an odd number plus or minus 0.01, an odd number plus or minus 0.001, and/or an odd number plus or minus 0.0001.

The quality factor of the QWCCR structure 100 (Q_{QWCCR}), described above, can be used to describe the width and/or the sharpness of the resonance (in other words, how quickly the power drops off as you excite the QWCCR structure 100 further and further from the resonance condition). For example, a square root of the quality factor can correspond to the voltage modification experienced at the electrode 106 of the QWCCR structure 100 when the QWCRR structure 100 is excited at the quarter-wave resonant condition. Additionally, the quality factor may be equal to the resonant frequency (ω₀) divided by full width at half maximum (FWHM). The FWHM is equal to the width of the curve in terms of frequency between the two points on the curve where the power is equal to 50% of the maximum power, as illustrated). The 50% power maximum point can also be referred to as the −3 decibel (dB) point, because it is the point at which the maximum voltage at the distal end of the QWCCR structure 100 decreases by 3 dB (or 29.29% for voltage) and the maximum power radiated by the QWCCR structure 100 decreases by 3 dB (or 50% for power). In various implementations, the FWHM of the QWCCR structure 100 could have various values. For example, the FWHM could be between 5 MHz and 10 MHz, between 10 MHz and 20 MHz, between 20 MHz and 40 MHz, between 40 MHz and 60 MHz, between 60 MHz and 80 MHz, or between 80 MHz and 100 MHz. Other FWHM values are also possible.

Further, the quality factor of the QWCCR structure 100 (Q_{QWCCR}) can also take various values in various implementations. For example, the quality factor could be between 25 and 50, between 50 and 75, between 75 and 100, between 100 and 125, between 125 and 150, between 150 and 175, between 175 and 200, between 200 and 300, between 300 and 400, between 400 and 500, between 500 and 600, between 600 and 700, between 700 and 800, between 800 and 900, between 900 and 1000, or between 1000 and 1100. Other quality factor values are also possible.

It is understood that, in alternate implementations, alternate structures (for example, alternate quarter-wave structures) can be used to emit electromagnetic radiation and/or excite plasma coronas (for example, other structures that concentrate electric field at specific locations using points or tips with sufficiently small radii). For example, other quarter-wave resonant structures, such as a coaxial-cavity resonator (sometimes referred to as a “coaxial resonator”), a dielectric resonator, a crystal resonator, a ceramic resonator, a surface-acoustic-wave resonator, a yttrium-iron-garnet resonator, a rectangular-waveguide cavity resonator, a parallel-plate resonator, a gap-coupled microstrip resonator, etc. can be used to excite a plasma corona.

Further, it is understood that wherever in this disclosure the terms “resonator,” “QWCCR,” “QWCCR structure,” and “coaxial resonator,” are used, any of the structures enumerated in the preceding paragraph could be used, assuming appropriate modifications are made to a corresponding system. In addition, the terms “resonator,” “QWCCR,” “QWCCR structure,” and “coaxial resonator” are not to be construed as inclusive or all-encompassing, but rather as examples of a particular structure that could be included in a particular implementation. Still further, when a “QWCCR structure” is described, the QWCCR structure can correspond to a coaxial resonator, a coaxial resonator with an additional base conductor, a coaxial resonator excited by a signal with a wavelength that corresponds to an odd-integer multiple of one-quarter (¼) of a length of the coaxial resonator, and other structures, in various implementations.

Additionally, whenever any “QWCCR,” “QWCCR structure,” “coaxial resonator,” “resonator,” or any of the specific resonators in this disclosure or in the claims are described as being “configured such that, when the resonator is excited by the radio-frequency power source with a signal having a wavelength proximate to an odd-integer multiple of one-quarter (¼) of the resonant wavelength, the resonator provides at least one of a plasma corona or electromagnetic waves,” some or all of the following are contemplated, depending on context. First, the corresponding resonator could be configured to provide a plasma corona when excited by the radio-frequency power source with a signal having a wavelength proximate to an odd-integer multiple of one-quarter (¼) of a resonant wavelength of the resonator. Second, the corresponding resonator could be configured to provide electromagnetic waves when excited by the radio-frequency power source with a signal having a wavelength proximate to an odd-integer multiple of one-quarter (¼) of a resonant wavelength of the resonator. Third, the corresponding resonator could be configured to provide, when excited by the radio-frequency power source with a signal having a wavelength proximate to an odd-integer multiple of one-quarter (¼) of a resonant wavelength of the resonator, both a plasma corona and electromagnetic waves.

V. Example Resonator Systems

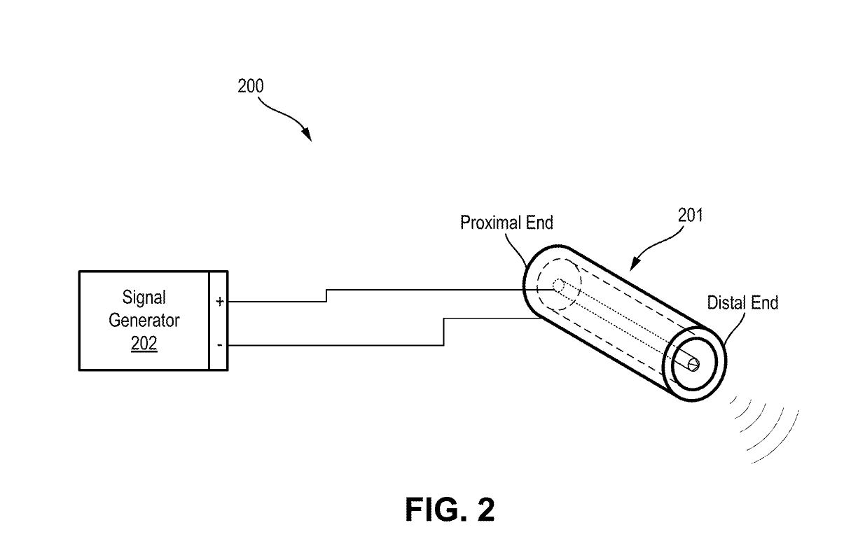

In some implementations, the coaxial resonator 201 can be used as an antenna (for example, instead of or in addition to generating a plasma corona). As an antenna, the coaxial resonator 201 can radiate electromagnetic waves. The electromagnetic waves can consequently influence charged particles. As illustrated in the system 200 of FIG. 2, such electromagnetic waves can be radiated when the coaxial resonator 201 is excited by a signal generator 202. For example, the signal generator 202 can be coupled to the coaxial resonator 201 in order to excite the coaxial resonator 201 (for example, to excite a plasma corona and to produce electromagnetic waves). Such a coupling can include inductive coupling (for example, using an induction feed loop), parallel capacitive coupling (for example, using a parallel plate capacitor), or non-parallel capacitive coupling (for example, using an electric field applied opposite a non-zero voltage conductor end). Further, the electrical distance between the signal generator 202 and the coaxial resonator 201 can be optimized (for example, minimized or adjusted based on wavelength of an RF signal) in order to minimize the amount of energy lost to heating and/or to maximize a quality factor. Further, in some implementations, the coaxial resonator 201 can radiate acoustic waves when excited (for example, at resonance). The acoustic waves produced can induce motion in nearby particles, for example.

The signal generator 202 can be a device that produces periodic waveforms (for example, using an oscillator circuit). In various implementations, the signal generator 202 can produce a sinusoidal waveform, a square waveform, a triangular waveform, a pulsed waveform, or a sawtooth waveform. Further, the signal generator 202 can produce waveforms with various frequencies (for example, frequencies between 1 Hz and 1 THz). The electromagnetic waves radiated from the coaxial resonator 201 can be based on the waveform produced by the signal generator 202. For example, if the waveforms produced by the signal generator 202 are sinusoidal waves having frequencies between 300 MHz and 300 GHz (for example, between 1 GHz and 100 GHz), the electromagnetic waves radiated by coaxial resonator 201 can be microwaves. In various implementations, the signal generator 202 can, itself, be powered by an AC power source or a DC power source.

Depending on the signal used by the signal generator 202 to excite the coaxial resonator 201, the coaxial resonator 201 can additionally excite one or more plasma coronas. For example, if a large enough voltage is used to excite the coaxial resonator 201, a plasma corona can be excited at the distal end of the electrode 106 (for example, at a concentrator of the electrode 106). In some implementations, a voltage step-up device can be electrically coupled between the signal generator 202 and the coaxial resonator 201. In such scenarios, the voltage step-up device can be operable to increase an amplitude of the AC voltage used to excite the coaxial resonator 201.

In some implementations, the signal generator 202 can include one or more of the following: an internal power supply; an oscillator (for example, an RF oscillator, a surface acoustic wave resonator, or a yttrium-iron-garnet resonator); and an amplifier. The oscillator can generate a time-varying current and/or voltage (for example, using an oscillator circuit). The internal power supply can provide power to the oscillator. In some implementations, the internal power supply can include, for example, a DC battery (for example, a marine battery, an automotive battery, an aircraft battery, etc.), an alternator, a generator, a solar cell, and/or a fuel cell. In other implementations, the internal power supply can include a rectified AC power supply (for example, an electrical connection to a wall socket passed through a rectifier). The amplifier can magnify the power that is output by the oscillator (for example, to provide sufficient power to the coaxial resonator 201 to excite plasma coronas). For example, the amplifier can multiply the current and/or the voltage output by the oscillator. Additionally, in some implementations, the signal generator 202 can include a dedicated controller that executes instructions to control the signal generator 202.

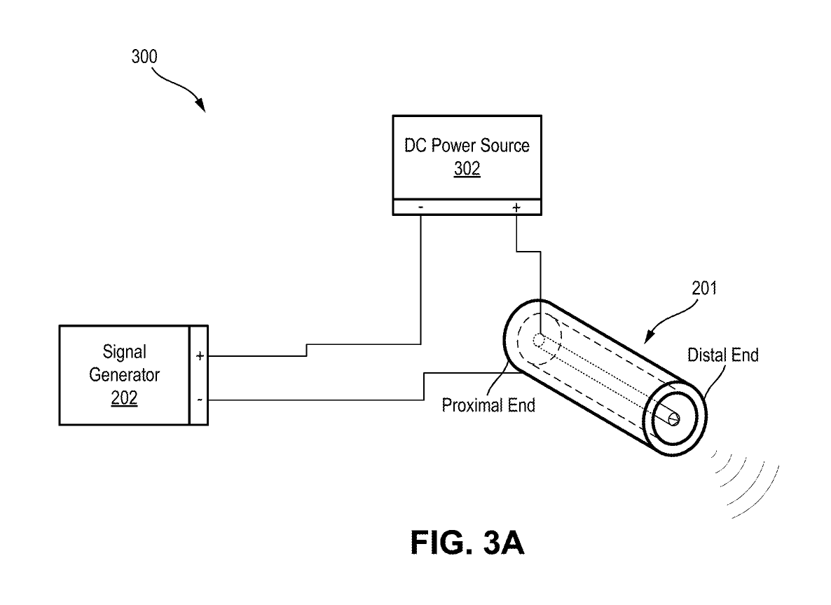

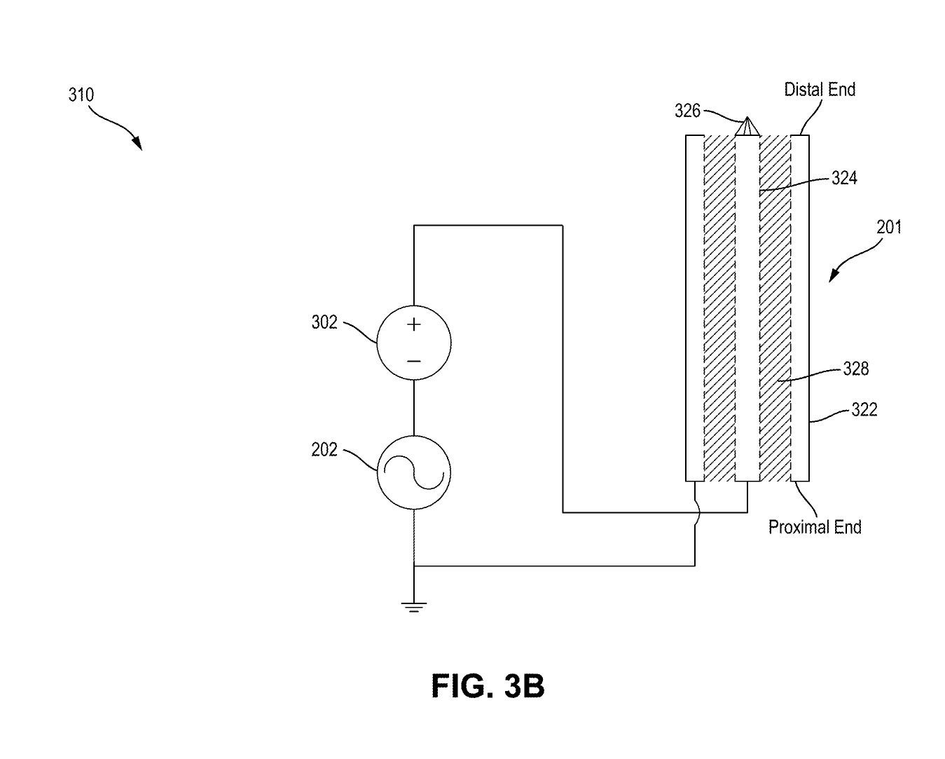

Additionally or alternatively, as illustrated in the system 300 of FIG. 3A, the coaxial resonator 201 can be electrically coupled (for example, using a wired connection or wirelessly) to a DC power source 302. Further, in some implementations, an RF cancellation resonator (not shown) can prevent RF power (for example, from the signal generator 202) from reaching, and potentially interfering with, the DC power source 302. The RF cancellation resonator can include resistive elements, lumped-element inductors, and/or a frequency cancellation circuit.

In some implementations, the DC power source 302 can include a dedicated controller that executes instructions to control the DC power source 302. The DC power source 302 can provide a bias signal (for example, corresponding to a DC bias condition) for the coaxial resonator 201. For example, a DC voltage difference between the inner conductor 104 and the outer conductor 102 of the coaxial resonator 201 in FIG. 3A can be established by the DC power source 302 by increasing the DC voltage of the inner conductor 104 and/or decreasing the DC voltage of the outer conductor 102 (given the orientation of the positive terminal and negative terminal of the DC power source 302). In other implementations, a DC voltage difference between the inner conductor 104 and the outer conductor 102 can be established by the DC power source 302 by decreasing the DC voltage of the inner conductor 104 and/or increasing the DC voltage of the outer conductor 102 (if the orientation of the positive terminal and negative terminal of the DC power source 302 in FIG. 3A were reversed). The bias signal (for example, the voltage of the bias signal and/or the current of the bias signal) output by the DC power source 302 can be adjustable.

By providing the coaxial resonator 201 with a bias signal, an increased voltage can be presented at a concentrator of the electrode 106, thereby yielding an increased electric field at the concentrator of the electrode 106. The total electric field at the concentrator can thus be a sum of the electric field from the bias signal of the DC power source 302 and the electric field from the signal generator 202 exciting the coaxial resonator 201 at a resonance condition (for example, exciting the coaxial resonator 201 at a quarter-wave resonance condition so the electric field of the signal from the signal generator 202 reaches a maximum at the distal end of the coaxial resonator 201). Because of this increased total electric field, an excitation of a plasma corona near the concentrator can be more probable.

As an alternative, rather than using a bias signal, the signal generator 202 can simply excite the coaxial resonator 201 using a higher voltage. However, this might use considerably more power than providing a bias signal and augmenting that bias signal with an AC voltage oscillation.

In some implementations, the DC power source 302 can be switchable (for example, can generate the bias signal when switched on and not generate the bias signal when switched off). As such, the DC power source 302 can be switched on when a plasma corona output is desired from coaxial resonator 201 and can be switched off when a plasma corona output is not desired from coaxial resonator 201. For example, the DC power source 302 can be switched on during an ignition sequence (for example, a sequence where fuel is being ignited within a combustion chamber to begin combustion), but switched off during a reforming sequence (for example, a sequence in which electromagnetic radiation is being used to chemically modify fuel). Further, in some implementations, the electric field at the concentrator of the electrode 106 used to initiate the plasma corona can be larger than the electric field at the concentrator used to sustain the plasma corona. Hence, in some implementations, the DC power source 302 can be switched on in order to excite the plasma corona, but switched off while the plasma corona is maintained by the signal from the signal generator 202.

In alternate implementations, the system 200 of FIG. 2 and/or the system 300 of FIG. 3A can include a plurality of coaxial resonators 201. If the system 200 of FIG. 2 includes a plurality of coaxial resonators 201, the plurality of coaxial resonators 201 can each be electrically coupled to the same signal generator (for example, such that each of the plurality of coaxial resonators 201 is excited by the same signal), can each be electrically coupled to a respective signal generator (for example, such that each of the plurality of coaxial resonators 201 is independently excited, thereby allowing for unique excitation frequency, power, etc. for each of the plurality of coaxial resonators 201), or one set of the plurality of coaxial resonators 201 can be connected to a common signal generator and another set of the plurality of coaxial resonators 201 can be connected to one or more other signal generators, which could be similar or different from signal generator 202. In implementations of the system 300 that include a plurality of coaxial resonators 201, each of the coaxial resonators 201 can be attached to a respective DC power source (for example, multiple instances of DC power source 302) and a common signal generator (for example, such that a bias signal can be independently switchable and/or adjustable for each coaxial resonator 201, while maintaining a common excitation waveform across all coaxial resonators 201 in the system 300), different signal generators and a common DC power source (for example, such that a bias signal can be jointly switchable across all coaxial resonators 201 in the system 300, while maintaining an independent excitation waveform for each coaxial resonator 201), or different DC power sources and different signal generators (for example, such that the bias signal is independently switchable for each coaxial resonator 201, while maintaining an independent excitation waveform for each coaxial resonator 201).

FIG. 3B illustrates a circuit diagram of the system 300 of FIG. 3A, which includes the signal generator 202, the DC power source 302, and the coaxial resonator 201 (illustrated in vertical cross-section). As illustrated, similar to the QWCCR structure 100, the coaxial resonator 201 includes an outer conductor 322, an inner conductor 324 (including an electrode 326), and a dielectric 328. In addition, when the DC power source 302 is switched off, the circuit illustrated in FIG. 3B may not be an open-circuit. Instead, the signal generator 202 can simply be shorted to the inner conductor 324 when the DC power source 302 is switched off As illustrated, the outer conductor 322 can be electrically coupled to ground. Further, the signal generator 202 and the DC power source 302 can be connected in series, with their negative terminals connected to ground. The positive terminals of the signal generator 202 and the DC power source 302 can be electrically coupled to the inner conductor 324. Consequently, the electrode 326 can also be electrically coupled to the positive terminals through an electrical coupling between the inner conductor 324 and the electrode 326.

In alternate implementations, the negative terminals of the signal generator 202 and the DC power source 302 can instead be connected to the inner conductor 324 and the positive terminals can be connected to the outer conductor 322. In this way, the signal generator 202 and the DC power source 302 can instead apply a negative voltage (relative to ground) to the electrode 326 and/or inner conductor 324, rather than a positive voltage (relative to ground). Further, in some implementations, the negative terminals of the DC power source 302 and the signal generator 202 and/or the inner conductor 324 might not be grounded.

As stated above, the DC power source 302 can be switchable. In this way a positive bias signal or a negative bias signal can be selectively applied to the inner conductor 324 and/or the electrode 326 relative to the outer conductor 322. When the DC power source 302 is switched on, a bias condition can be present, and when the DC power source 302 is switched off, a bias condition might not be present. A bias signal provided by the DC power source 302 can increase the electric potential, and thus the electric field, at the electrode 326 (for example, at a concentrator of the electrode 106, such as a tip, edge, or blade). By increasing the electric field at the electrode 326, dielectric breakdown and potentially plasma excitation can be more prevalent. Thus, by switching on the DC power source 302, the amount of plasma excited at a plasma corona can be enhanced.

In some implementations, the voltage of the DC power source 302 can range from +1 kV to +100 kV. Alternatively, the voltage of the DC power source 302 can range from −1 kV to −100 kV. Even further, the voltage of the DC power source 302 can be adjustable in some implementations. Furthermore, the voltage of the DC power source 302 can be pulsed, ramped, etc. For example, the voltage can be adjusted by a controller connected to the DC power source 302. In such implementations, the voltage of the DC power source 302 can be adjusted by the controller according to sensor data (for example, sensor data corresponding to temperature, pressure, fuel composition, etc.).

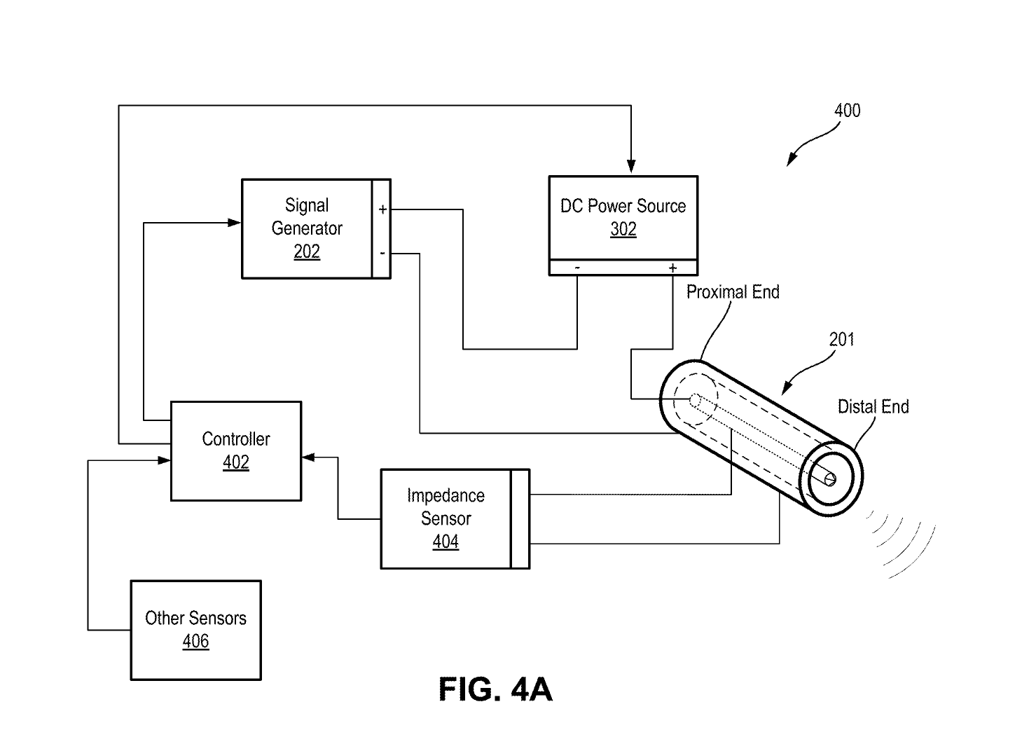

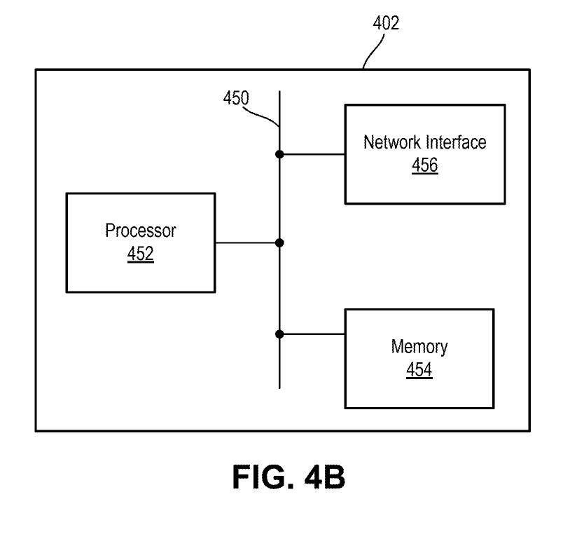

As illustrated in FIG. 4A, an example system 400 can include a controller 402. In various implementations, the controller 402 can include a variety of components. For example, the controller 402 can include a desktop computing device, a laptop computing device, a server computing device (for example, a cloud server), a mobile computing device, a microcontroller (for example, embedded within a control system of a power-generation turbine, an automobile, or an aircraft), and/or a microprocessor. As illustrated, the controller 402 can be communicatively coupled to the signal generator 202, the DC power source 302, an impedance sensor 404, and one or more other sensors 406. Through the communicative couplings, the controller 402 can receive signals/data from various components of the system 400 and control/provide data to various components of the system 400. For example, the controller 402 can switch the DC power source 302 in order to provide a time-modulated bias signal to the coaxial resonator 201 (for example, during an ignition sequence within a combustion chamber adjacent to, coupled to, or surrounding the coaxial resonator 201).

Further, a “communicative coupling,” as presently disclosed, is understood to cover a broad variety of connections between components, based on context. “Communicative couplings” can include direct and/or indirect couplings between components in various implementations. In some implementations, for example, a “communicative coupling” can include an electrical coupling between two (or more) components (for example, a physical connection between the two (or more) components that allows for electrical interaction, such as a direct wired connection used to read a sensor value from a sensor). Additionally or alternatively, a “communicative coupling” can include an electromagnetic coupling between two (or more) components (for example, a connection between the two (or more) components that allows for electromagnetic interaction, such as a wireless interaction based on optical coupling, inductive coupling, capacitive coupling, or coupling though evanescent electric and/or magnetic fields). In addition, a “communicative coupling” can include a connection (for example, over the public internet) in which one or more of the coupled components can transmit signals/data to and/or receive signals/data from one or more of the other coupled components. In various implementations, the “communicative coupling” can be unidirectional (in other words, one component sends signals and another component receives the signals) or bidirectional (in other words, both components send and receive signals). Other directionality combinations are also possible for communicative couplings involving more than two components. One example of a communicative coupling could be the controller 402 communicatively coupled to the coaxial resonator 201, where the controller 402 reads a voltage and/or current value from the resonator directly. Another example of a communicative coupling could be the controller 402 communicating with a remote server over the public Internet to access a look-up table. Additional communicative couplings are also contemplated in the present disclosure.

In some implementations, the controller 402 can control one or more settings of the signal generator 202 (for example, waveform shape, output frequency, output power amplitude, output current amplitude, or output voltage amplitude) or the DC power source 302 (for example, switching on or off or adjusting the level of the bias signal). For example, the controller 402 can control the bias signal of the DC power source 302 (for example, a voltage of the bias signal) based on a calculated voltage used to excite a plasma corona (for example, based on conditions within a combustion chamber). The calculated voltage can account for the voltage amplitude being output by the signal generator 202, in some implementations. The calculated voltage can ensure, for example, that the bias signal has a small effect on any standing electromagnetic wave formed within the coaxial resonator 201 based on an output of the signal generator 202.

The controller 402 can be located nearby the signal generator 202, the DC power source 302, the impedance sensor 404, and/or the one or more other sensors 406. For example, the controller 402 may be connected by a wire connection to the signal generator 202, the DC power source 302, the impedance sensor 404, and/or the one or more other sensors 406. Alternatively, the controller 402 can be remotely located relative to the signal generator 202, the DC power source 302, the impedance sensor 404, and/or the one or more other sensors 406. For example, the controller 402 can communicate with the signal generator 202, the DC power source 302, the impedance sensor 404, and/or the one or more other sensors 406 over BLUETOOTH®, over BLUETOOTH LOW ENERGY (BLE)®, over the public Internet, over WIFI® (IEEE 802.11 standards), over a wireless wide area network (WWAN), etc.

In some implementations, the controller 402 can be communicatively coupled to fewer components within the system 400 (for example, only communicatively coupled to the DC power source 302). Further, in implementations that include fewer components than illustrated in the system 400 (for example, in implementations, having only the coaxial resonator 201, the signal generator 202, and the controller 402), the controller 402 can interact with fewer components of the system 400. For instance, the controller can interact only with the signal generator 202.

The impedance sensor 404 can be connected to the coaxial resonator 201 (for example, one lead to the inner conductor 324 of the coaxial resonator 201 and one lead to the outer conductor 322 of the coaxial resonator 201) to measure an impedance of the coaxial resonator 201. In some implementations, the impedance sensor 404 can include an oscilloscope, a spectrum analyzer, and/or an AC volt meter. The impedance measured by the impedance sensor 404 can be transmitted to the controller 402 (for example, as a digital signal or an analog signal). In some implementations, the impedance sensor 404 can be integrated with the controller 402 or connected to the controller 402 through a printed circuit board (PCB) or other mechanism. The impedance data can be used by the controller 402 to perform calculations and to adjust control of the signal generator 202 and/or the DC power source 302.

Similarly, the other sensors 406 can also transmit data to the controller 402. Analogous to the impedance sensor 404, in some implementations, the other sensors 406 can be integrated with the controller 402 or connected to the controller 402 through a PCB or other mechanism. The other sensors 406 can include a variety of sensors, such as one or more of: a fuel gauge, a tachometer (for example, to measure revolutions per minute (RPM)), an altimeter, a barometer, a thermometer, a sensor that measures fuel composition, a gas chromatograph, a sensor measuring fuel-to-air ratio in a given fuel/air mixture, an anemometer, a torque sensor, a vibrometer, an accelerometer, or a load cell.

In some implementations, the controller 402 can be powered by the DC power source 302. In other implementations, the controller 402 can be independently powered by a separate DC power source or an AC power source (for example, rectified within the controller 402).

As an example, a possible implementation of the controller 402 is illustrated in FIG. 4B. As illustrated, the controller 402 can include a processor 452, a memory 454, and a network interface 456. The processor 452, the memory 454, and the network interface 456 can be communicatively coupled over a system bus 450. The system bus 450, in some implementations, can be defined within a PCB.

The processor 452 can include one or more central processing units (CPUs), such as one or more general purpose processors and/or one or more dedicated processors (for example, application-specific integrated circuits (ASICs), digital signal processors (DSPs), or network processors). The processor 452 can be configured to execute instructions (for example, instructions stored within the memory 454) to perform various actions. Rather than a processor 452, some implementations can include hardware logic (for example, one or more resistor-inductor-capacitor (RLC) circuits, flip-flops, latches, etc.) that performs actions (for example, based on the inputs from the impedance sensor 404 or the other sensors 406).

The memory 454 can store instructions that are executable by the processor 452 to carry out the various methods, processes, or operations presently disclosed. Alternatively, the method, processes, or operations can be defined by hardware, firmware, or any combination of hardware, firmware, or software. Further, the memory 454 can store data related to the signal generator 202 (for example, control signals), the DC power source 302 (for example, switching signals), the impedance sensor 404 (for example, look-up tables related to changes in impedance and/or a characteristic impedance of the coaxial resonator 201 based on certain environmental factors), and/or the other sensors 406 (for example, a look-up table of typical wind speeds based on elevation).

The memory 454 can include non-volatile memory. For example, the memory 454 can include a read-only memory (ROM), electrically erasable programmable read-only memory (EEPROM), a hard drive (for example, hard disk), and/or a solid-state drive (SSD). Additionally or alternatively, the memory 454 can include volatile memory. For example, the memory 454 can include a random-access memory (RAM), flash memory, dynamic random-access memory (DRAM), and/or static random-access memory (SRAM). In some implementations, the memory 454 can be partially or wholly integrated with the processor 452.

The network interface 456 can enable the controller 402 to communicate with the other components of the system 400 and/or with outside computing device(s). The network interface 456 can include one or more ports (for example, serial ports) and/or an independent network interface controller (for example, an Ethernet controller). In some implementations, the network interface 456 can be communicatively coupled to the impedance sensor 404 or one or more of the other sensors 406. Additionally or alternatively, the network interface 456 can be communicatively coupled to the signal generator 202, the DC power source 302, or an outside computing device (for example, a user device). Communicative couplings between the network interface 456 and other components can be wireless (for example, over WIFI®, BLUETOOTH®, BLUETOOTH LOW ENERGY (BLE)®, or a WWAN) or wireline (for example, over token ring, t-carrier connection, Ethernet, a trace in a PCB, or a wire connection).

In some implementations, the controller 402 can also include a user-input device (not shown). For example, the user-input device can include a keyboard, a mouse, a touch screen, etc. Further, in some implementations, the controller 402 can include a display or other user-feedback device (for example, one or more status lights, a speaker, a printer, etc.) (not shown). That status of the controller 402 can alternatively be provided to a user device through the network interface 456. For example, a user device such as a personal computer or a mobile computing device can communicate with the controller 402 through the network interface 456 to retrieve the values of one or more of the other sensors 406 (for example, to be displayed on a display of the user device).

VI. Resonators with Fuel Injection

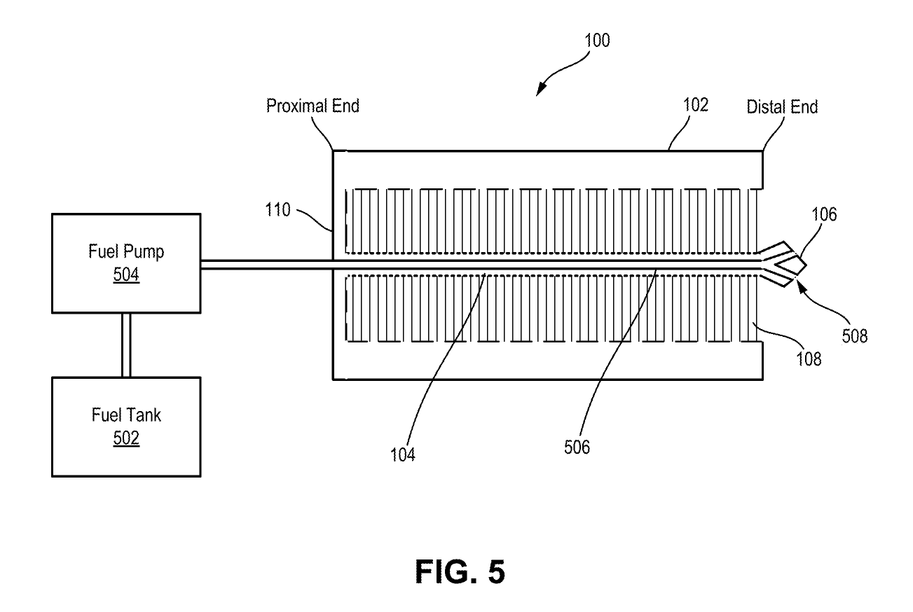

As illustrated in FIG. 5, in some implementations, the QWCCR structure 100 (or the coaxial resonator 201) can be attached to a fuel tank 502. The fuel tank 502 can provide a fuel source for a combustion chamber or other environment, for example. The fuel tank 502 can contain or be connected to a fuel pump 504 through a fuel-supply line (for example, a hose or a pipe). The fuel pump 504 can transfer fuel from the fuel tank 502 into the fuel-supply line and propel the fuel through a fuel conduit 506 defined by or disposed within the inner conductor 104 of the QWCCR structure 100. For example, the fuel pump 504 can include a mechanical pump (for example, gear pump, rotary vane pump, diaphragm pump, screw pump, peristaltic pump) or an electrical pump. In some implementations, the fuel tank 502 can include various sensors (for example, a pressure sensor, a temperature sensor, or a fuel-level sensor). Such sensors can be electrically connected to the controller 402 in order to provide data regarding the status of the fuel tank 502 to the controller 402, for example. Additionally or alternatively, the fuel pump 504 can be connected to the controller 402. Through such a connection, the controller 402 could control the fuel pump 504 (for example, to switch the fuel pump on and off, set a fuel injection rate, etc.).

In some implementations, the fuel conduit 506 can inject fuel (for example, into a combustion chamber) at one or more outlets 508 defined within the electrode 106 (for example, within a concentrator of the electrode 106). By conveying fuel through the fuel conduit 506 and out one or more outlets 508, fuel can be introduced proximate to a source of ignition energy (for example, proximate to a plasma corona generated near a concentrator of the electrode 106), which can allow for efficient combustion and ignition. In alternate implementations, one or more outlets can be defined with other locations of the fuel conduit 506 (for example, so as not to interfere with the electric field at the concentrator of the electrode 106).

In some implementations, the fuel conduit 506 can act, at least in part, as a Faraday cage (for example, by encapsulating the fuel within a conductor that makes up the fuel conduit 506) to prevent electromagnetic radiation in the QWCCR structure 100 from interacting with the fuel while the fuel is transiting the fuel conduit 506. In other structures, the fuel conduit 506 can allow electromagnetic radiation to interact with (for example, reform) the fuel within the fuel conduit 506.

In some implementations, the QWCCR structure 100 can include multiple fuel conduits 506 (for example, multiple fuel conduits running from the proximal end of the QWCCR structure 100 to the distal end of the QWCCR structure 100). Additionally or alternatively, one or more fuel conduits 506 can be positioned within the dielectric 108 or within the outer conductor 102. As described above, the outlet(s) 508 of the fuel conduit(s) 506 can be oriented in such as a way as to expel fuel toward concentrators (for example, tips, edges, or points) of one or more electrodes 106 (for example, toward regions where plasma coronas are likely to be excited).

VII. Additional Resonator Implementations

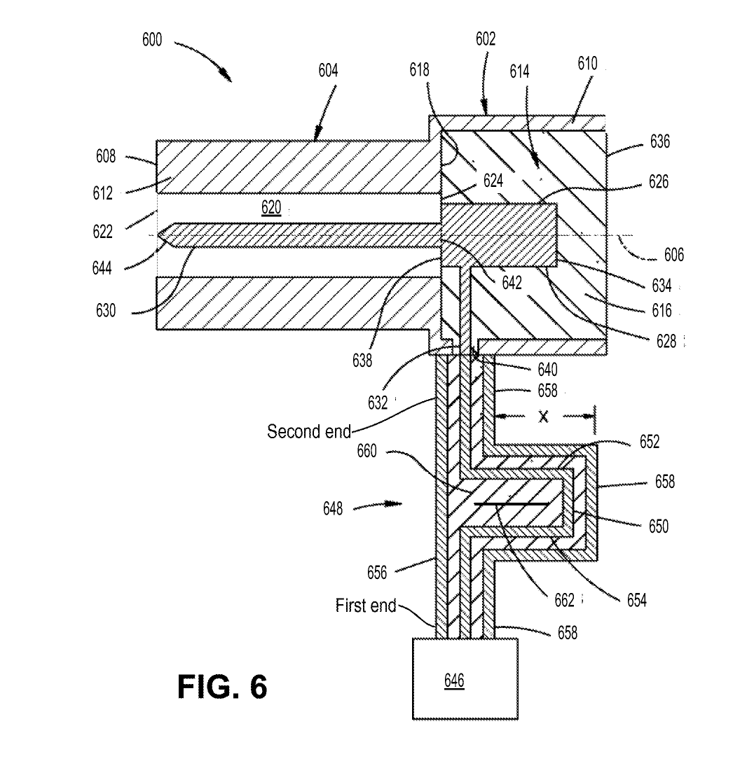

FIG. 6 illustrates a cross-sectional view of an example alternative coaxial resonator 600 connected to a DC power source through an additional resonator assembly acting as an RF attenuator, in accordance with example implementations. The coaxial resonator 600 is an assembly of two quarter-wave coaxial cavity resonators that are coupled together. More specifically, the coaxial resonator 600 includes a first resonator 602 and a second resonator 604 electrically coupled in a series arrangement along a longitudinal axis 606. In some implementations, the coaxial resonator 600 includes a DC bias condition established at a node of the voltage standing wave (for example, between quarter-wave segments). In such implementations, there may be no impedance mismatch. Because there is no impedance mismatch, the diameters of the inner conductor and the outer conductor of the first resonator 602 can be different than the diameters of the inner conductor and the outer conductor of the second resonator 604, respectively, without impacting the quality factor (Q). In such a way, the DC bias condition might not affect or interact with the AC signal coming from a signal generator.

The first resonator 602 and the second resonator 604 are defined by a common outer conductor wall structure 608. The outer conductor wall structure 608 includes a first cylindrical wall 610 and a second cylindrical wall 612 centered on the longitudinal axis 606. The first cylindrical wall 610 is constructed of a conducting material and surrounds a first cylindrical cavity 614 centered on the longitudinal axis 606. The first cylindrical cavity 614 is filled with a dielectric 616 having a relative dielectric constant approximately equal to four (εᵣ≈4), for example.

In the example implementation of FIG. 6, the first resonator 602 and the second resonator 604 adjoin one another in a connection plane 618 that is perpendicular to the longitudinal axis 606. In other examples, the connection plane 618 might not be perpendicular to the longitudinal axis 606, and can instead be designed with a different configuration that maintains constant impedance between the first resonator 602 and the second resonator 604.

The second cylindrical wall 612 is constructed of a conducting material and surrounds a second cylindrical cavity 620 that is also centered on the longitudinal axis 606. The second cylindrical cavity 620 is coaxial with the first cylindrical cavity 614, but can have a greater physical length. The second cylindrical wall 612 provides the second cylindrical cavity 620 with a distal end 622 spaced along the longitudinal axis 606 from a proximal end 624 of the second cylindrical cavity 620.

A center conductor structure 626 is supported within the conductor wall structure 608 of the coaxial resonator 600 by the dielectric 616. The center conductor structure 626 includes a first center conductor 628, a second center conductor 630, and a radial conductor 632.

The first center conductor 628 reaches within the first cylindrical cavity 614 along the longitudinal axis 606. In the example implementation shown in FIG. 6, the first center conductor 628 has a proximal end 634 adjacent a proximal end 636 of the first cylindrical cavity 614, and has a distal end 638 adjacent the distal end 624 of the first cylindrical cavity 614. The radial conductor 632 projects radially from a location adjacent the distal end 638 of the first center conductor 628, across the first cylindrical cavity 614, and outward through an aperture 640.

The second center conductor 630 has a proximal end 642 at the distal end 638 of the first center conductor 628. The second center conductor 630 projects along the longitudinal axis 606 to a distal end 644 configured as an electrode tip located at or in close proximity to the distal end 622 of the second cylindrical cavity 620.

To reduce any mismatch in impedances between the first resonator 602 and the second resonator 604, the relative radial thicknesses between both the cylindrical walls 610, 612 and the respective center conductors 628, 630 are defined in relation to the relative dielectric constant of the dielectric 616 and the dielectric constant of the air or gas that fills the second cylindrical cavity 620. In the example implementation of FIG. 6, the physical length of the second center conductor 630 along the longitudinal axis 606 is approximately twice the physical length of the first center conductor 628 along the longitudinal axis 606. However, based at least in part on the dielectric 616 having a relative dielectric constant approximately equal to four, the electrical lengths of the two center conductors 628 and 630 are approximately equal.

In example implementations, any gaps between any of the center conductors 628, 630 and any outer conductor could be filled with a dielectric and/or the gap (for example, the second cylindrical cavity 620) could be large enough to reduce arcing (in other words, large enough such that the electric field is not of sufficient intensity to result in a dielectric breakdown of air or the intervening dielectric). As further shown in FIG. 6, the dielectric 616 fills the first cylindrical cavity 614 around the first center conductor 628 and the radial conductor 632.

In the illustrated example, a DC power source 646 is connected to the center conductor structure 626 through the radial conductor 632 connected adjacent to a virtual short-circuit point of the DC power source 646.

An RF control component, specifically, an RF frequency cancellation resonator assembly 648 is disposed between the radial conductor 632 and the DC power source 646 to restrict RF power from reaching the DC power source 646. The RF frequency cancellation resonator assembly 648 is an additional resonator assembly having a center conductor 650. The center conductor 650 has a first portion 652 and a second portion 654, each of which has the same electrical length “X” illustrated in FIG. 6 (and the same electrical length as the first center conductor 628 and the second center conductor 630).

In an example implementation, the electrical length “X” depicted in FIG. 6 can be sized such that the center conductor 650 is an odd-integer multiple of half wavelengths (for example, ½λ₀, 3/2λ₀, 5/2λ₀, 7/2λ₀, 9/2λ₀, 11/2λ₀, 13/2λ₀, etc.) out of phase (in other words, 180° out of phase) with the outer conducting wall 656 and the outer conducting wall 658, simultaneously, where λ₀ is the resonant wavelength, and where the resonant wavelength λ₀ is inversely related to the frequency of the RF power. In alternative implementations, a similar “folded” structure to the electrical length “X” could be located within the cylindrical cavity 614 to achieve a similar phase shift between the inner conductor and the outer conductor.

The RF frequency cancellation resonator assembly 648 also has a short outer conducting wall 656 and a long outer conducting wall 658. The short outer conducting wall 656 has first and second ends on opposite ends of the RF frequency cancellation resonator assembly 648. The long outer conducting wall 658 also has first and second ends on opposite ends of the RF frequency cancellation resonator assembly 648. The first and second ends of the short outer conducting wall 656 are each on the opposite side of the RF frequency cancellation resonator assembly 648 from the corresponding first and second ends of the long outer conducting wall 658.

In an example implementation, the difference in electrical length between the short outer conducting wall 656 and the long outer conducting wall 658 is substantially equal to the combined electrical length of the first portion 652 and the second portion 654. In this example, the combined electrical length of the first portion 652 and the second portion 654 is substantially equal to twice the electrical length of the first center conductor 628.

In an example implementation, the short outer conducting wall 656 and the long outer conducting wall 658 surround a cavity 660 filled with a dielectric. In operation, with this example implementation, electric current running along the outer conductor of the RF frequency cancellation resonator assembly 648 primarily follows the shortest path and run along the short outer conducting wall 656. Accordingly, electric current on the outer conductor of the RF frequency cancellation resonator assembly 648 travels two fewer quarter-wavelengths than current running along the center conductor 650 of the RF frequency cancellation resonator assembly 648.

In examples, the RF frequency cancellation resonator assembly 648 can also have an internal conducting ground plane 662 disposed within the cavity 660 and between the first portion 652 and the second portion 654 of the center conductor 650. Based on the geometry of the cancellation resonator assembly 648, this configuration provides a frequency cancellation circuit connected between the DC power source 646 and the radial conductor 632.

Further, in examples, the RF frequency cancellation resonator assembly 648 is configured to shift a voltage supply of RF energy 180 degrees out of phase relative to the ground plane 662 of the coaxial resonator 600 due to the difference in electrical length between the short outer conducting wall 656 and the center conductor 650 of the RF frequency cancellation resonator assembly 648.

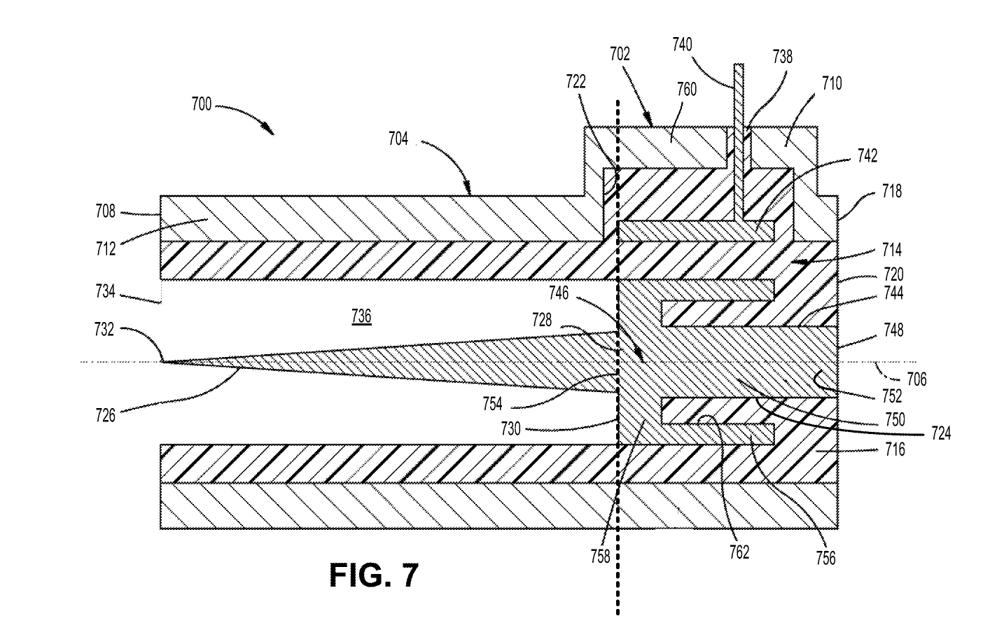

FIG. 7 illustrates a cross-sectional view of another example alternative coaxial resonator 700 connected to a DC power source through an additional resonator assembly acting as an RF attenuator, in accordance with an example implementation. The coaxial resonator 700 includes a first resonator portion 702 and a second resonator portion 704 electrically coupled in a series arrangement along a longitudinal axis 706.

As depicted in FIG. 7, the first resonator portion 702 and the second resonator portion 704 are defined by a common outer conductor wall structure 708. The wall structure 708 includes a first cylindrical wall portion 710 and a second cylindrical wall portion 712 centered on the longitudinal axis 706. The first cylindrical wall portion 710 is constructed of a conducting material and surrounds a first cylindrical cavity 714 centered on the longitudinal axis 706. In this example implementation, the first cylindrical cavity 714 is filled with a dielectric 716.

An annular edge 718 of the first cylindrical wall portion 710 defines a proximal end 720 of the first cylindrical cavity 714. A proximal end of the second cylindrical wall portion 712 adjoins a distal end 722 of the first cylindrical cavity 714.

The coaxial resonator 700 further includes a first center conductor portion 724 and a second center conductor portion 726 (the center conductor portions 724, 726 represented by the densest cross-hatching in FIG. 7). For illustration, the first center conductor portion 724 and the second center conductor portion 726 are separated by the vertical dashed line in FIG. 7. In some implementations, both the first center conductor portion 724 and the second center conductor portion 726 can correspond to an odd-integer multiple of quarter wavelengths based on the frequency of an RF power source used to excite the coaxial resonator 700. The second center conductor portion 726 has a proximal end 728 adjoining a distal end 730 of the first center conductor portion 724. The second center conductor portion 726 projects along the longitudinal axis 706 to a distal end configured as a concentrator 732 (for example, a tip) of an electrode located at or in close proximity to a distal end 734 of a second cylindrical cavity 736.

The coaxial resonator 700 has an aperture 738 that reaches radially outward through the first cylindrical wall portion 710. A radial conductor 740 extends out through the aperture 738 from the longitudinal axis 706 to be connected to an RF power source (for example, the signal generator 202) by an RF power input line. The end of the radial conductor 740 that is closer to the longitudinal axis 706 connects to a parallel plate capacitor 742 that is in a coupling arrangement to a center conductor structure 744. The parallel plate capacitor 742 is also in a coupling arrangement to an inline folded RF attenuator 746. The spacing between the parallel plate capacitor 742 and the center conductor structure 744 can depend on the materials used for fabrication (for example, the materials used to fabricate the parallel plate capacitor 742, the center conductor structure 744, and/or the dielectric 716).

In an example, the DC power source 646 described above is connected to the center conductor structure 744 at a proximal end 748 of the center conductor structure 744 with a DC power input line. The inline folded RF attenuator 746 is disposed between the second resonator portion 704 and the DC power source 646 to restrict RF power from reaching the DC power source 646.

The inline folded RF attenuator 746 includes an interior center conductor portion 750 having a proximal end 752 and a distal end 754. The inline folded RF attenuator 746 also includes an exterior center conductor portion 756 and a transition center conductor portion 758 that connects or couples the interior center conductor portion 750 and the exterior center conductor portion 756.

The exterior center conductor portion 756 has a proximal end largely in the same plane as the proximal end 752, and a distal end largely in the same plane as the distal end 754. For example, in the cross-sectional illustration of FIG. 7, the plane of the proximal end 752 and the plane of the proximal end of the exterior center conductor portion 756 can be the plane of the cross-section that is illustrated. In this example implementation, the transition center conductor portion 758 is located proximal to the distal end 754. The exterior center conductor portion 756 surrounds the interior center conductor portion 750.

In this example, the exterior center conductor portion 756 resembles a cylindrical portion of conducting material surrounding the rest of the interior center conductor portion 750. The longitudinal lengths of the interior center conductor portion 750 and the exterior center conductor portion 756 are substantially equal to the longitudinal length of the parallel plate capacitor 742 with which they are in a coupling arrangement. The electrical length between the proximal end 752 to the distal end 754, for both the interior center conductor portion 750 and the exterior center conductor portion 756, is substantially equal to one quarter-wavelength. The second center conductor portion 726 and the second cylindrical wall portion 712 are both configured to have an electrical length of one quarter-wavelength.

The wall structure 708 includes a short outer conducting portion 760 which has a proximal end largely in the same plane as the proximal end 752, and a distal end largely in the same plane as the distal end 754. An outer conducting path runs from the distal end of the wall structure 708 (that is substantially coplanar with the distal end 734 of the second cylindrical cavity 736), along the short outer conducting portion 760, and stops at the proximal end 720 of the first cylindrical wall portion 710. In this example, the outer conducting path has an electrical length of two quarter-wavelengths.

An inner conducting path runs from the concentrator 732 to the proximal end 728 of the second center conductor portion 726, along the outside of the transition center conductor portion 758, then along the outside from the distal end to the proximal end of the exterior center conductor portion 756, then along an interior wall 762 of the exterior center conductor portion 756 from its proximal end to its distal end, then along the interior center conductor portion 750 from its distal end to its proximal end. In this example, the electrical length of this inner conducting path is four quarter-wavelengths, or two half wavelengths. The difference in electrical lengths between the inner conducting path and the outer conducting path is one half wavelength.

With this configuration, the inline folded RF attenuator 746 operates as a radio-frequency control component connected between the DC power source 646 and the voltage supply of RF energy. The inline folded RF attenuator 746 is configured to shift a voltage supply of RF energy 180 degrees out of phase relative to the ground plane of the coaxial resonator 700.

The particular arrangement depicted in FIG. 7 is not limiting with respect to the orientation of the inline folded RF attenuator 746. In other examples, the entire arrangement depicted in FIG. 7 can be “stretched,” with the inline folded RF attenuator 746 being disposed further away from the concentrator 732 and not directly coupled to the parallel plate capacitor 742. For example, the inline folded RF attenuator 746 could be separated by one quarter-wavelength from the portion of the center conductor that would remain in direct coupling arrangement with the parallel plate capacitor 742. The coaxial resonator 700 can achieve a maximize efficiency when (i) the inline folded RF attenuator 746 is an odd-integer multiple of quarter wavelengths from the concentrator 732; and (ii) the inline folded RF attenuator 746 is an odd-integer multiple of quarter wavelengths in electrical length.

In another example, the arrangement depicted in FIG. 7 could be more compressed, with the exterior center conductor portions 756 of the inline folded RF attenuator 746 extending longitudinally as far as the parallel plate capacitor 742 and also surrounding the portion of center conductor exposed for plasma creation. This can be implemented by arranging the center conductor structure 744 in the middle so that the exterior center conductor portions 756 extends in either direction longitudinally. Any particular geometry of this arrangement can involve adjusting the various parameters of dielectrics to ensure impedance matching and full 180 degree phase cancellation.

In one example, the arrangements described with respect to FIGS. 6 and 7 and the particular combination of components that provide the RF signal to the coaxial resonators are contained in a body dimensioned approximately the size of a gap spark igniter and adapted to mate with a combustor (for example, of an internal combustion engine). As an example for illustration, a microwave amplifier could be disposed at the resonator, and the resonator could be used as the frequency determining element in an oscillator amplifier arrangement. The amplifier/oscillator could be attached at the top or back of an igniter, and could have the high voltage supply also integrated in the module with diagnostics. This example permits the use of a single, low-voltage DC power supply for feeding the module along with a timing signal.

VIII. Power-Generation Turbines

The above coaxial resonators could be usefully employed in the context of a power-generation turbine. For example, a coaxial cavity resonator similar to the coaxial resonator 201 illustrated in FIG. 2 could be used in a gas turbine. While reference is made to “QWCCR,” “QWCCR structure,” and “coaxial resonator” elsewhere in the description, it will be understood that other types of resonators are possible and contemplated.

An example power-generation turbine includes a compressor coupled to a turbine through a shaft, and the power-generation turbine also includes a combustion chamber or area, called a combustor. It is understood that, as presently described, the terms “power-generation turbine,” “power-generation gas turbine,” and “gas turbine” are used synonymously and/or interchangeably. In operation, atmospheric air flows through a compressor that brings the air to higher pressure. Energy is then added by spraying fuel into the air and igniting it so the combustion generates a high-temperature, high-pressure gas flow. The high-temperature, high-pressure gas enters a turbine, where it expands down to an exhaust pressure, producing a shaft work output at the shaft coupled to the turbine in the process.

The shaft work output is used to drive the compressor and other devices (for example, an electric generator) that can be coupled to the shaft. The energy that is not used for shaft work comes out in the exhaust gases that can include a high temperature and/or a high velocity. Gas turbines can be utilized to power aircraft, trains, ships, electrical generators, pumps, gas compressors, and tanks, among other machines.

An example gas turbine includes an upstream rotating compressor coupled to a downstream turbine, and a combustion chamber or area, called a combustor, in between the compressor and the turbine. In operation, atmospheric air flows through a compressor that brings the air to higher pressure. Energy is then added by spraying fuel into the air and igniting it so the combustion generates a high-temperature high pressure gas flow. The high-temperature high-pressure gas enters a turbine, where it expands down to the exhaust pressure, producing a shaft work output in the process. In a power-generation turbine, the shaft work is used to drive the compressor and an electric generator that can be coupled to the shaft.

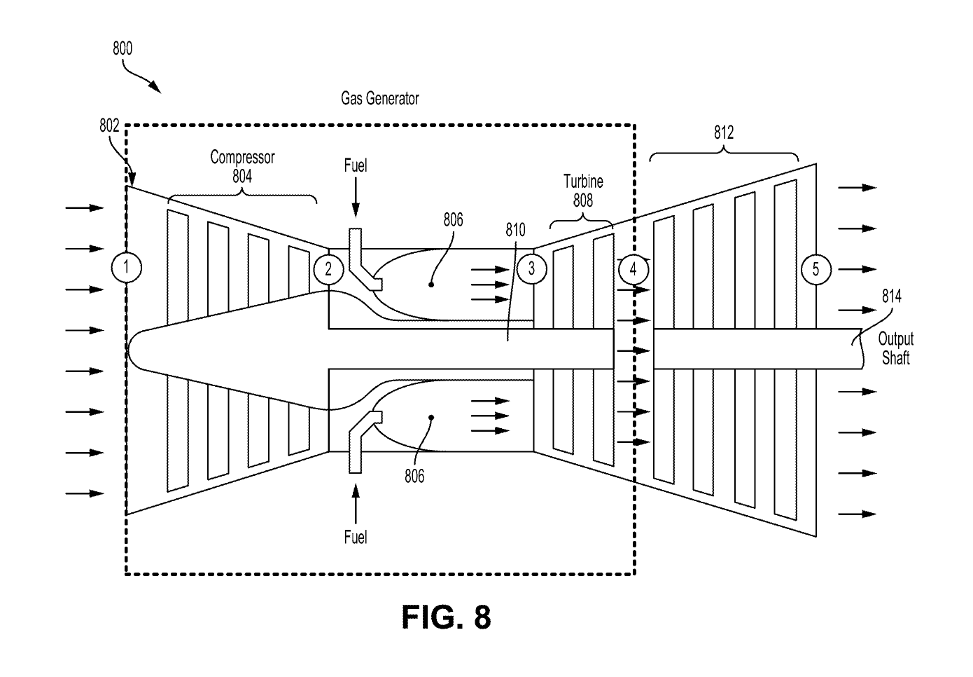

FIG. 8 illustrates core components of an example power-generation turbine 800. In this arrangement, large amounts of surrounding air (free stream) are continuously brought into an inlet or intake 802. At the rear of the intake 802, the air then enters a compressor 804 (axial, centrifugal, or both). The compressor 804 operates as many rows of airfoils, with each row producing an increase in pressure. At the exit of the compressor 804, the air is therefore at a much higher pressure than when it enters the intake 802.

Fuel is mixed with the compressed air exiting the compressor 804, and the fuel-compressed air mixture is burned in a combustor 806, generating a flow of hot, high pressure gas. The hot, high pressure air exiting the combustor 806 is then passed through a first turbine 808. The first turbine 808 extracts energy from a flow of gas by making blades of the first turbine 808 spin in the flow. The first turbine 808 can include several stages, and the energy extracted by the first turbine 808 is used to turn the compressor 804 by linking or coupling the compressor 804 and the first turbine 808 by a central shaft 810.

The above-mentioned components of the power-generation turbine 800 can be referred to collectively as the gas generator. The power-generation turbine 800 further includes a power section having a second turbine 812 and an output shaft 814. The output shaft 814 can be coupled to an electric generator. Particularly, the output shaft 814 can be connected to a rod or shaft of the electric generator that turns one or more magnets surrounded by coils of copper wire. The fast-revolving generator magnet creates a powerful magnetic field that lines up the electrons around the copper coils and causes them to move, providing an electrical current, and thereby generating electricity.

In examples, the gas generator and power section of the power-generation turbine 800 are mechanically-separate so they can each rotate at different speeds appropriate for the conditions. In other examples, the power-generation turbine 800 might not include two turbines 808, 812 but can have a single turbine driving both the compressor 804 and the output shaft 814. Further, although FIG. 8 illustrates the output shaft 814 exiting an end of the power-generation turbine 800 that is opposite the intake 802, in some examples, the output shaft 814 is disposed and rotatable within the central shaft 810 and exits the power-generation turbine 800 from the intake 802.

One way to boost efficiency of the power-generation turbine 800 is to install a recuperator or to use a heat-recovery steam generator (HRSG) to recover energy from the exhaust of the second turbine 812. If a recuperator is installed, the recuperator captures waste heat in the gases exiting the turbines 808, 812 to preheat the compressed air discharged by the compressor 804 before the compressed air enters the combustor 806. If a HRSG is used, the HRSG generates steam by capturing heat from the gases exiting the turbines 808, 812. High-pressure steam generated by the HSRG can be used to generate additional electric power with steam turbines in a “combined cycle” configuration.

The combustor 806, which can also be referred to as a burner, a combustion chamber, or a flame holder, comprises the area of the power-generation turbine 800 where combustion takes place. The combustor 806 of the power-generation turbine 800 is configured to contain and maintain stable combustion despite high air flow rates. As such, in examples, the combustor 806 is configured to mix the air and fuel, ignite the air-fuel mixture, and then mix in more air to complete the combustion process.

Combustors of power-generation turbines can be classified into several types. For example, a first type of combustor can be referred to as an annular combustor in which the combustor is configured as a continuous chamber that encircles the air in a plane perpendicular to the air flow. A second type of combustor can be referred to as can-annular, which is similar to the annular type but incorporates several can-shaped combustion chambers rather than a single continuous chamber. The can-shaped combustion chambers can be disposed in a radial array about a longitudinal axis of the power-generation turbine. The can-shaped combustion chambers could be disposed perpendicular to the longitudinal axis, parallel to the longitudinal axis, or at a particular angle relative to the longitudinal axis. A third type of combustor can be referred to as a can or silo combustor that can include one or more self-contained combustion chambers mounted externally to the power-generation turbine.

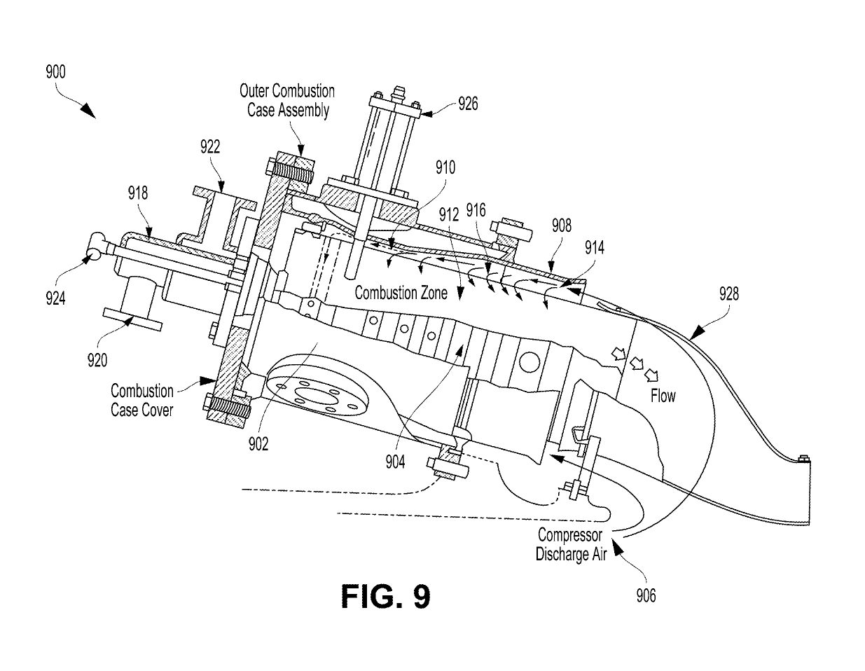

FIG. 9 illustrates a partial cross-sectional view of a combustor 900 of a power-generation turbine. In an example implementation, the combustor 900 could represent the combustor 806 of the power-generation turbine 800 described above.

The combustor 900 includes a case 902 that is configured as an outer shell of the combustor 900. The case 902 can be protected from thermal loads by the air flowing in it, and can operate as a pressure vessel configured to withstand the difference between the high pressures inside the combustor 900 and the lower pressure outside.

The combustor 900 further includes a liner 904 that could be slot-cooled and configured to contain the combustion process. The liner 904 is configured to withstand extended high temperature cycles, and therefore can be made from superalloys. Furthermore, the liner 904 is cooled with air flow. In some example implementations, in addition to air cooling, the combustor 900 can include thermal barrier coatings to further cool the liner 904.

FIG. 9 further illustrates air flow paths through the combustor 900. Compressed discharge air exiting the compressor 804 can flow through a compressor discharge air opening 906 disposed in the combustor 900. The air entering through the compressor discharge air opening 906 flows through a flow sleeve 908 and is the source of combustion air 910, which is highly compressed air. The combustion air 910 can be decelerated using a diffuser and is fed through main channels of the combustor 900. This air is mixed with fuel, and then combusted in a combustion zone 912.

A portion of the compressed discharge air, referred to as dilution air 914, is injected through dilution air holes in the liner 904 at the end of the combustion zone 912 to help cool the air before it reaches the first turbine 808. The dilution air 914 can be used to produce the uniform temperature profile desired in the combustor 900.

Further, a portion of the compressed discharge air, referred to as cooling air 916, is injected through cooling air holes in the liner 904 to generate a layer (film) of cool air to protect the liner 904 from the high combustion temperatures. The combustor 900 can be configured such that the cooling air 916 does not directly interact with the combustion air 910 and the combustion process.

The combustor 900 further includes a fuel injector 918 configured to introduce fuel to the combustion zone 912 for mixing the fuel with the combustion air 910. The fuel injector 918 can be configured as any of several types of fuel injectors, including without limitation: pressure-atomizing, air blast, vaporizing, and premix/prevaporizing injectors.

Pressure-atomizing fuel injectors utilize high fuel pressures (as much as 500 pounds per square inch (psi)) to atomize the fuel. When using this type of fuel injector, the fuel system is configured to be sufficiently robust to withstand such high pressures. The fuel tends to be heterogeneously atomized, resulting in incomplete or uneven combustion, which generates pollutants and smoke.

The air blast fuel injector can include a port 920 configured to receive atomizing air. The air blast injector “blasts” fuel with a stream of air received through the port 920, atomizing the fuel into homogeneous droplets, and can cause the combustor 900 to be smokeless. The air blast fuel injector can operate at lower fuel pressures than the pressure atomizing fuel injector.

The vaporizing fuel injector is similar to the air blast injector in that the combustion air 910 is mixed with the fuel as it is injected into the combustion zone 912. However, with the vaporizing fuel injector, the fuel-air mixture travels through a tube within the combustion zone 912. Heat from the combustion zone 912 is transferred to the fuel-air mixture, vaporizing some of the fuel to enhance the mixing before the mixture is combusted. This way, the fuel is combusted with low thermal radiation, which helps protect the liner 904. However, the vaporizer tube can have low durability because of the low fuel flow rate within it causing the tube to be less protected from the combustion heat.

The premixing/prevaporizing injector is configured to mix or vaporize the fuel before it reaches the combustion zone 912. In such a scenario, the fuel is uniformly mixed with the air, and emissions from the power-generation turbine 800 can be reduced. However, in some cases, fuel can auto-ignite or otherwise combust before the fuel-air mixture reaches the combustion zone 912, and the combustor 900 can thus be damaged. In some example implementations, a resonator could be configured with fuel passages disposed within the resonator, such that the resonator integrates operations of the fuel injector 918 with operations of an igniter described below. In these examples, the resonator could be configured to perform the atomization and vaporization of the fuel in addition to mixing and preparing the fuel for combustion. The fuel would then be passed through a formed plasma to ensure ignition. Further, the presence of the electromagnetic waves radiated by the resonator could be used to energize the air-fuel mixture and stimulate combustion.

In examples, the power-generation turbine 800 could be a dual-fuel turbine. A dual-fuel turbine can run primarily with one type of gas (for example, natural gas) as fuel but can also have a back-up fuel supply system if the gaseous fuel is not available. For instance, the dual-fuel turbine can be configured to also receive liquid fuel and water through a pipe system.

In an example, to accommodate different types of fuel, the fuel injector 918 could be configured as a dual-fuel nozzle assembly configured to receive two types of fuel. For instance, the fuel injector 918 can have a gas-fuel port 922 configured to be fluidly coupled to a source of gaseous fuel, and can also have a liquid-fuel port 924 configured to be fluidly coupled to a source of liquid fuel.

Example fuels that could be provided to the power-generation turbine 800 include, without limitation: Arabian Extra Light Crude Oil (AXL), Arabian Super Light (ASL), Biodiesel Condensate or Natural Gas Liquids (NGL), Dimethyl Ether (DME), Distillate Oil #2 (DO2), Ethane (C₂), Heavy Crude Oil, Heavy Fuel Oil (HFO), High H₂, Hydrogen Blends, Kerosene (Jet A or Jet A-1), Lean Methane, Light Crude Oil (LCO), Liquid Natural Gas (LNG), Liquefied Propane Gas (LPG), Medium Crude Oil, Methanol/Ethanol (Alcohol), Naphtha, Natural Gas (NG), Sour Gas (H₂S), Steel Mill Gases, and Syngas.

Each of these fuels can have a particular air-to-fuel mixture ratio (or desirable mixture ratio range) at which the fuel is burnt. Under some conditions, if the air-fuel mixture has an air-to-fuel ratio that is less than the particular air-to-fuel ratio, combustion might not occur. Further, each fuel can have different combustion characteristics. The resonators disclosed in the present disclosure may enable gas turbines to operate on a wide variety of gaseous and liquid fuels while burning fuels efficiently and without changes to the gas turbines.

The combustor 900 also includes an igniter 926. In examples, the igniter 926 can be configured as an electrical spark igniter, similar to an automotive spark plug. However, there are several disadvantages to such configuration. For instance, a spark plug might not be capable of igniting different types of fuel with different air-to-fuel ratios and combustion characteristics. Further, even if the spark plug is capable of igniting some mixtures, achieving high efficiencies for different types of fuel and air-to-fuel ratios can be difficult.

The igniter 926 can be disposed proximate to the combustion zone 912 where the fuel and air are already mixed. To avoid damage by the combustion itself, the igniter 926 can be located proximate to the combustion zone 912, but upstream from the combustion location. In example implementations, once combustion is initially started by the igniter 926, the combustion can be self-sustaining and the igniter 926 need no longer be used. However, in some examples, it can be desirable to have the igniter 926 configured to facilitate detection of changes in operational characteristics of the gas turbine or the combustion process that could lead to extinguishing combustion, and proactively prevent such extinguishment.

The combustor 900 can further include a transition assembly 928 that couples the combustor 900 to the first turbine 808 such that hot air resulting from the combustion zone 912 flows through the transition assembly 928 to the first turbine 808.

The combustor 900 illustrated in FIG. 9 represents one implementation, and other possible variations are possible. For example, rather than having a fuel injector including two ports for two different types of fuel, the combustor can include different, independent fuel injectors, each fuel injector configured to provide a respective type of fuel to the combustion zone 912. In other examples, the combustor 900 can have a port configured to receive water or steam injection to provide control of NOₓ gases in the combustion zone 912.

Additionally, in examples, the combustor 900 can have several combustion stages, including, for example, a pilot stage. The power-generation turbine 800 can be configured to provide fuel to each stage in the combustor 900 through a respective tube. Other example variations are possible.

The combustion taking place at the combustor 900 may affect many of the operating characteristics of the power-generation turbine 800. As examples, combustion may determine fuel efficiency, output power level, and levels of emissions of the power-generation turbine 800. It can thus be desirable to have an ignition system that prepares the fuel for efficient and thorough combustion regardless of the type of fuel, reduces emissions, and that facilitates starting and sustaining ignition regardless of air-to-fuel ratio and the type of fuel.

IX. Electromagnetic Wave Modification of Fuel

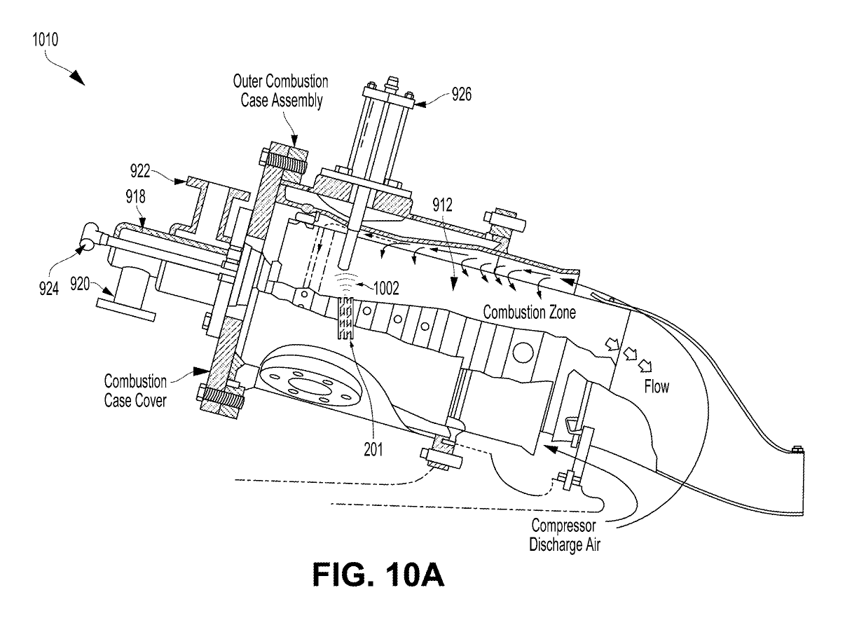

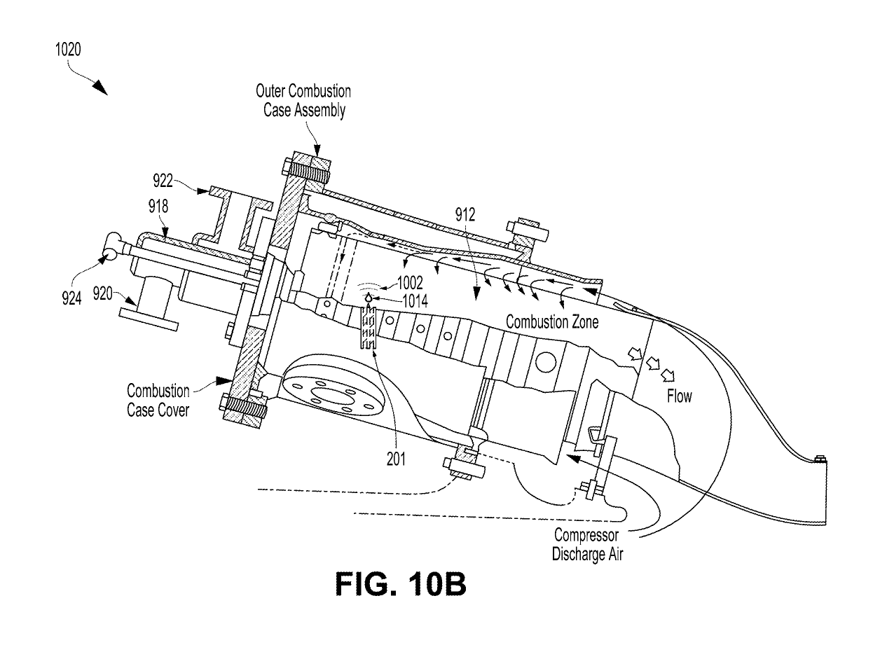

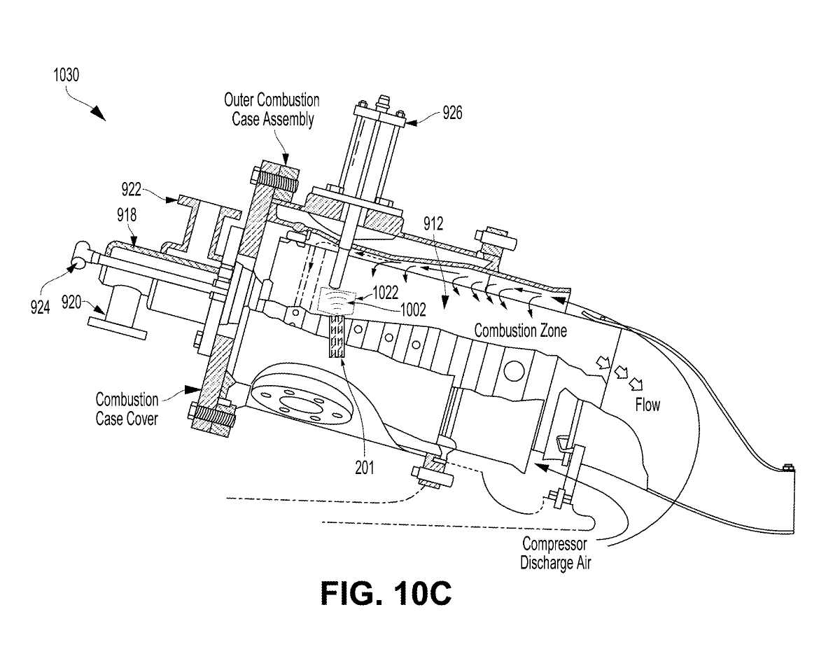

FIG. 10A illustrates a combustion chamber 1010, according to example implementations. In some implementations, the combustion chamber 1010 can be a component of a power-generation turbine (for example, the power-generation turbine 800 illustrated in FIG. 8). The combustion chamber 1010 can be similar to the combustor 900 illustrated in FIG. 9, for example. For simplicity, some of the components labeled within the combustor 900 have not been labeled in FIG. 10A. It is thus understood that additional components present in FIG. 9 may additionally be present in FIG. 10A, even if unlabeled. Unlike FIG. 9, however, the arrangement of FIG. 10A includes a resonator. In various implementations, the resonator can include a coaxial-cavity resonator, a dielectric resonator, a crystal resonator, a ceramic resonator, a surface-acoustic-wave resonator, a yttrium-iron-garnet resonator, a rectangular-waveguide cavity resonator, a parallel-plate resonator, or a gap-coupled microstrip resonator. While reference is made to “QWCCR,” “QWCCR structure,” and “coaxial resonator” elsewhere in the description, it will be understood that other types of resonators are possible and contemplated.

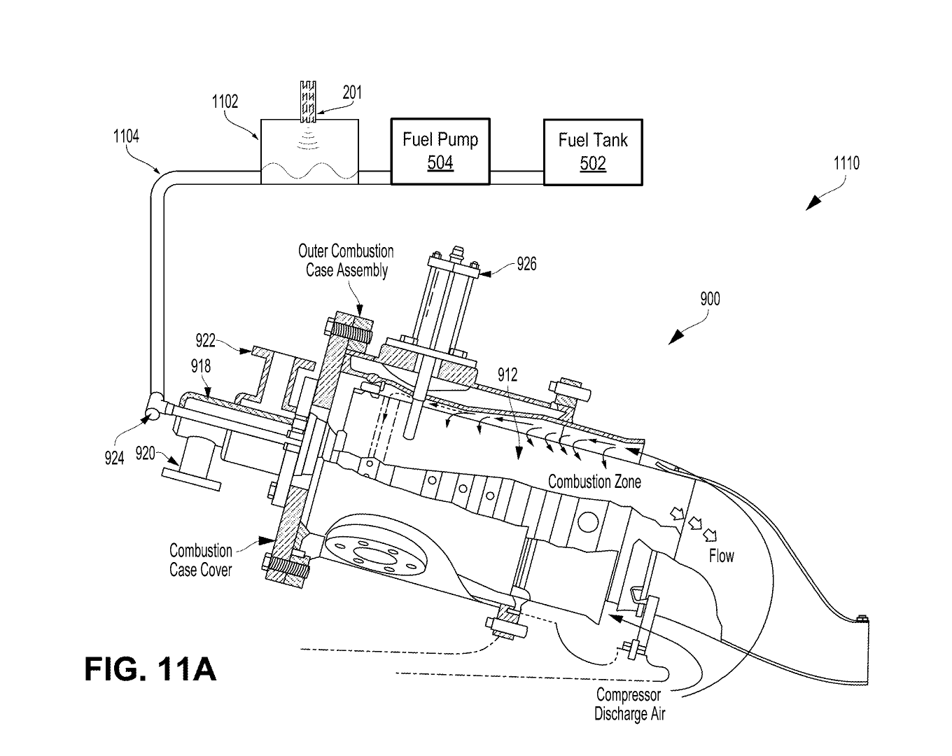

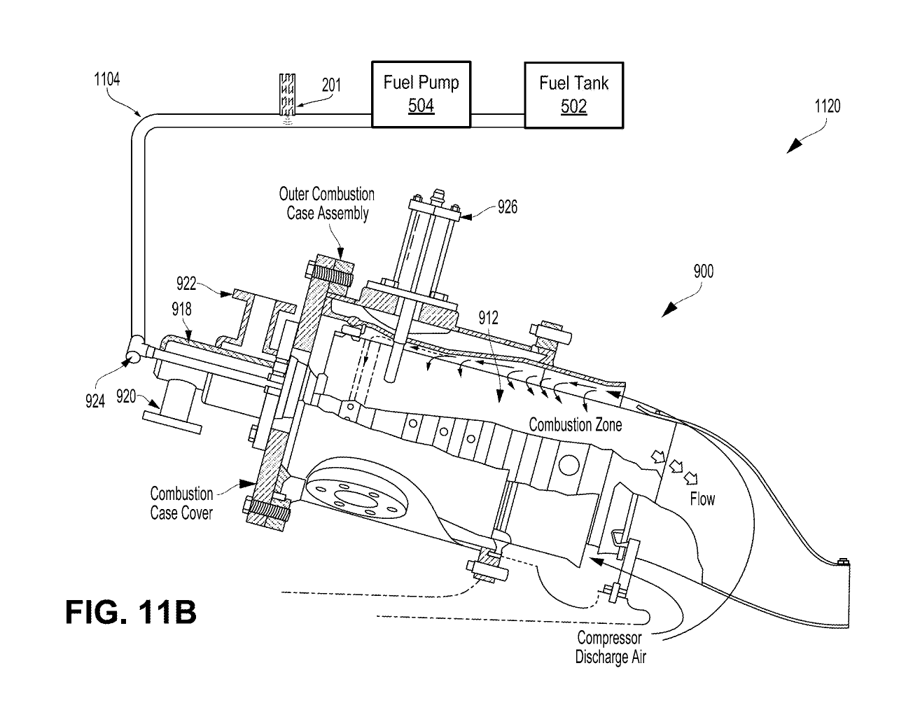

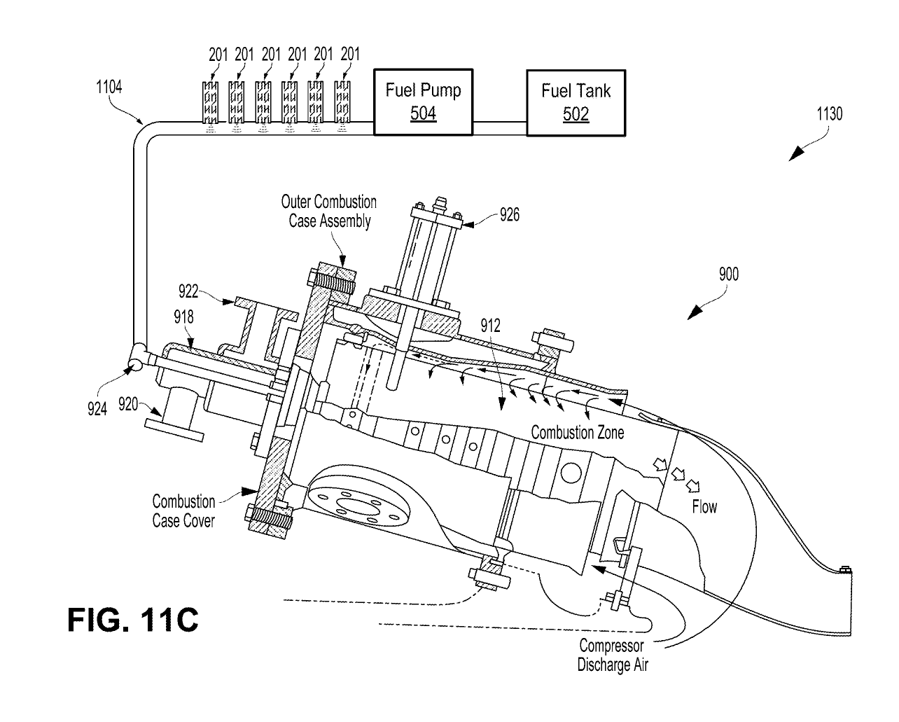

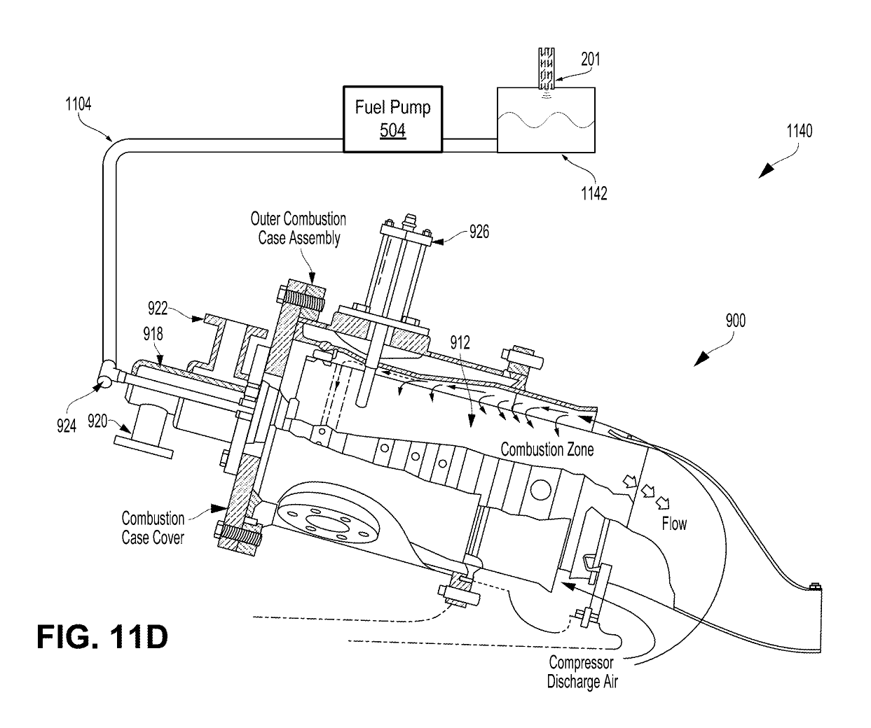

The resonator in FIG. 10A can be the coaxial resonator 201 illustrated in FIG. 2, in some implementations. As such, the coaxial resonator 201 can be configured to radiate electromagnetic waves 1002 (for example, microwaves) when excited by a radio-frequency power source (for example, the signal generator 202 illustrated in FIG. 2) with a signal having a wavelength proximate to an odd-integer multiple of one-quarter (¼) of the resonant wavelength of the coaxial resonator 201. For simplicity, the radio-frequency power source used to excite the coaxial resonator 201 in FIGS. 10A-11D is not illustrated in the figures.

The coaxial resonator 201 can be disposed near location of fuel injection from the fuel injector 918 within the combustion zone 912. Further, the electromagnetic waves 1002 radiated by the coaxial resonator 201 can be directed (in other words, oriented a direction) toward an injection site of the fuel injector 918 such that fuel injected into the combustion zone 912 is irradiated by the electromagnetic waves 1002. Additionally or alternatively, the electromagnetic waves 1402 can be radiated toward a location of the igniter 926. In such implementations, fuel and/or a fuel mixture could be modified immediately before ignition, for example. The electromagnetic waves 1002 can be microwaves, in some implementations. For example, the electromagnetic waves 1002 can include microwaves having wavelengths from one millimeter to one meter and/or can include microwaves having frequencies from 300 MHz to 300 GHz.

Additionally, the electromagnetic waves 1002 can interact with the injected fuel and modify the injected fuel. For example, the electromagnetic waves 1002 can modify the fuel by ionizing at least one hydrogen atom in a hydrocarbon chain, liberating at least one hydrogen atom from a hydrocarbon chain, exciting a hydrocarbon chain at one or more natural resonant frequencies to break one or more carbon-hydrogen bonds, altering an energy state of the fuel, exciting electrons within a valence band of a hydrocarbon chain to a higher energy level, and/or reorienting polar hydrocarbon chains.

Further, a portion or the entirety of the combustion zone 912 of the combustion chamber 1010 can be exposed to the electromagnetic waves 1002. As such, the electromagnetic waves 1002 can also modify qualities of a fuel/air mixture within the combustion zone 912. Electromagnetic waves 1002 can impart a torque on any substance having an electric dipole moment. Hence, the electromagnetic waves 1002 can reorient polar molecules within an air portion of the fuel/air mixture. In one implementation, for instance, the electromagnetic waves 1002 can reorient water molecules within the air portion. The act of reorienting polar molecules can impart a kinetic energy on the polar molecules, thereby increasing a temperature and/or energy state of the polar molecules within a fuel/air mixture. The degree to which the polar molecules are affected by the electromagnetic waves 1402 may depend on the mass of the molecules, the frequency of the electromagnetic waves 1402, and/or the intensity of the electromagnetic waves 1402. In other implementations, other modifications by the electromagnetic waves 1002 to the fuel and/or the fuel/air mixture are also possible.

The above modifications to the fuel and/or the fuel/air mixture can occur at various stages of a combustion process. For example, upon injecting the fuel into the combustion zone 912, the fuel and/or the fuel/air mixture can be “preformed” by modifying the fuel and/or the fuel/air mixture before ignition and combustion. Alternatively, the modifications to the fuel and/or the fuel/air mixture can occur during ignition and/or during combustion. In still other implementations, air can be modified by the electromagnetic waves 1002 before injecting fuel into the combustion zone 912. As such, the air can be “preformed” before becoming a part of the fuel/air mixture. In alternate implementations, other reformation timings relative to the combustion process can be used. Further, the modification to the fuel, air, and/or fuel/air mixture can occur continuously or intermittently (for example, by pulsing an RF power source used to excite the coaxial resonator 201). In one implementation, the electromagnetic waves 1002 can be provided at regular predetermined intervals that are shorter in duration than a relaxation time related to one or more of the excitation processes that give rise to a modification of the fuel and/or the fuel/air mixture. For example, the predetermined interval can be shorter in duration than a relaxation time related to an excitation of valence band electrons to a higher energy state.

Modifying the fuel, the air, and/or the fuel/air mixture in any of the presently described manners may assist in ignition and/or combustion. For example, modifying the fuel, the air, and/or the fuel/air mixture may increase a combustibility of the fuel, the air, and/or the fuel/air mixture (for example, by reducing the amount of fuel within a fuel/air mixture consumed during combustion). In addition, modification as presently described can allow for a lower energy barrier to ignition/combustion. In other words, less energy may be required to ignite a fuel/air mixture that includes fuel modified in any of the above manners. Additionally or alternatively, such modifications can result in a fuel/air mixture that, when compared with non-modified fuel/air mixtures, can burn at higher thermal efficiencies and can burn at lower fuel-to-air ratios for a given output power (for example, a “leaner” fuel mixture can be burned for a given amount of power output of the power-generation turbine that houses the combustion).

The coaxial resonator 201 can be disposed mostly outside of the combustion zone 912 with just a distal end of the coaxial resonator 201 being exposed to the combustion zone 912. In alternate implementations, however, the coaxial resonator 201 can be disposed entirely within the combustion zone 912, partially within the combustion zone 912, or entirely outside of the combustion zone 912 but configured to radiate electromagnetic waves into the combustion zone 912.

FIG. 10B illustrates a combustion chamber 1020, according to example implementations. The combustion chamber 1020 can be analogous to the combustion chamber 1010 illustrated in FIG. 10A. However, unlike FIG. 10A, the arrangement of FIG. 10B includes a resonator (for example, the coaxial resonator 201 illustrated in FIG. 2) configured to provide a plasma corona 1014 in addition to radiating the electromagnetic waves 1002. The plasma corona 1014 can be provided by the coaxial resonator 201 when the coaxial resonator 201 is excited by a radio-frequency power source with a signal having a wavelength proximate to an odd-integer multiple of one-quarter (¼) of the resonant wavelength and the signal is of sufficient power.

Additionally, the coaxial resonator 201 could be electrically coupled to a switchable direct-current power source. For example, the coaxial resonator 201 could be electrically coupled to the DC power source 302 illustrated in FIG. 3A. The direct-current power source can be configured to provide a bias signal between a first conductor (for example, the inner conductor 324) of the coaxial resonator 201 and a second conductor (for example, the outer conductor 322) of the coaxial resonator 201. The bias signal can increase an electric field at an electrode of the first conductor of the coaxial resonator 201, thereby reducing the power output required by the radio-frequency power source in order to produce the plasma corona 1014.

The coaxial resonator 201 could be excited by the radio-frequency power source and/or provided the bias signal from the switchable direct-current power source so as to radiate the electromagnetic waves 1002 and provide the plasma corona 1014 according to a predetermined pattern. The predetermined pattern can take various forms. For example, the coaxial resonator 201 could alternate between radiating electromagnetic waves 1002 for a first predetermined time and then providing the plasma corona 1014 for a second predetermined time. The ratio of the first predetermined time to the second predetermined time can vary across implementations. Alternatively, in some implementations, the coaxial resonator 201 can provide the plasma corona 1014 and radiate electromagnetic waves 1002 simultaneously. Other predetermined patterns of providing the plasma corona 1014 and/or radiating the electromagnetic waves 1002 are also possible.

As illustrated in FIG. 10B, and unlike in FIG. 10A, the arrangement of FIG. 10B does not include the igniter 926. Because the coaxial resonator 201 is configured to provide the plasma corona 1014, the plasma corona 1014 can be used to ignite a fuel/air mixture within the combustion zone 912, and a secondary ignition source (for example, the igniter 926) could be superfluous. However, in alternate implementations, the combustion chamber 1020 can include additional ignition sources, such as the igniter 926.

FIG. 10C illustrates a combustion chamber 1030, according to example implementations. The combustion chamber 1030 can be analogous to the combustion chamber 1010 illustrated in FIG. 10A. However, unlike in FIG. 10A, the arrangement of FIG. 10C includes a treatment chamber 1022.

As illustrated, the coaxial resonator 201 can provide the electromagnetic waves 1002 to an interior of the treatment chamber 1022. As such, the treatment chamber 1022 is an example location where modification of the fuel and/or the fuel/air mixture according to any of the presently described processes can occur.

The treatment chamber 1022 can be wholly enclosed. For example, the treatment chamber 1022 can include one or more valves that are configured to open and close so as to fluidly connect and fluidly disconnect the treatment chamber 1022 from the combustion zone 912 and/or the treatment chamber 1022 from the fuel injector 918. In one implementation, a first valve can open between the fuel injector 918 and the treatment chamber 1022 in order to allow fuel to flow from the fuel injector 918 to the treatment chamber 1022. After sufficient fuel has been injected into the treatment chamber 1022, the first valve can close. The fuel can then be modified by the electromagnetic waves 1002 in the treatment chamber 1022. Upon sufficient modification of the fuel, a second valve can open between the treatment chamber 1022 and the combustion zone 912 in order to allow fuel to communicate from the treatment chamber 1022 to the combustion zone 912. After sufficient fuel has been transferred into the combustion zone 912, the second valve can close. Upon the second valve closing, the igniter 926 can ignite the modified fuel present in the combustion zone 912.

In alternate implementations, rather than the treatment chamber 1022 being sealed from the combustion zone 912 by a valve, the treatment chamber 1022 can be partially or wholly exposed to the combustion zone 912 at all times. Additionally or alternatively, in some implementations, rather than the treatment chamber 1022 being sealed from the fuel injector 918 by a valve, the treatment chamber 1022 can be partially or wholly exposed to the fuel injector 918 at all times.

In some implementations, one or more interior walls of the treatment chamber 1022 can be coated by a reflective surface (for example, a metal coating). The reflective surface could be configured to be highly reflective of the electromagnetic waves 1002, such that the electromagnetic waves 1002 have an increased number of reflections over which to modify the fuel within the treatment chamber 1022.

FIG. 11A illustrates a system 1110, according to example implementations. In some implementations, the system 1110 can be a component of a power-generation turbine such as the power-generation turbine 800 illustrated in FIG. 8. Additionally, the system 1110 can include the combustor 900 illustrated in FIG. 9. Further, the system 1110 can include a fuel tank (such as the fuel tank 502 illustrated in FIG. 5), a fuel pump (such as the fuel pump 504 illustrated in FIG. 5), and a treatment chamber 1102. The fuel tank 502, the fuel pump 504, and the treatment chamber 1102 can be fluidly connected to one another and to the combustor 900 using a fuel conduit 1104, as illustrated.

In the system 1110, fuel can be pumped from the fuel tank 502 into a fuel injection region of the combustor 900 through the treatment chamber 1102. The fuel can be pumped from the fuel tank 502 to the combustor 900 using the fuel pump 504, as illustrated. In some implementations, a portion of the fuel conduit 1104 can be positioned within the treatment chamber 1102. In alternate implementations, a portion of the fuel conduit 1104 can connected to one side of the treatment chamber 1102 to empty fuel into treatment chamber 1102 and another portion of the fuel conduit 1104 can be connected to an opposing side of the treatment chamber 1102 to retrieve treated fuel from the treatment chamber 1102 and transport the treated fuel to the combustor 900 (for example, through a fuel injection portion of the combustor 900). Such a portion of the fuel conduit 1104 that transports treated fuel to the combustor 900 can be shorter than a distance over relaxation of the fuel would occur for any natural process used to treat the fuel. Further, a portion or the entirety of the fuel conduit 1104 can be made of a metal and/or a rare-earth magnet/material so the fuel within the fuel conduit 1104 is electromagnetically isolated from an exterior of the fuel conduit 1104.

In some implementations, the treatment chamber 1102 can be analogous to the treatment chamber 1022 illustrated in FIG. 10C, other than the fact that the treatment chamber 1102 is located partially or entirely outside of the combustor 900. As illustrated, the coaxial resonator 201 can be configured to radiate electromagnetic waves within the treatment chamber 1102 when excited by an RF power source with a signal of an appropriate wavelength. (The RF power source is not illustrated to prevent clutter of the figure.) These electromagnetic waves can be used to modify the fuel in any of the ways presently described in order to “pretreat” the fuel within the treatment chamber 1102 before the fuel enters the combustor 900.

FIG. 11B illustrates a system 1120, according to example implementations. In some implementations, the system 1120 can be a component of a power-generation turbine such as the power-generation turbine 800 illustrated in FIG. 8. The system 1120 can be analogous to the system 1110 illustrated in FIG. 11A, in some implementations. However, unlike the system 1110 illustrated in FIG. 11A, the system 1120 of FIG. 11B does not include the treatment chamber 1102.

As illustrated, in the system 1120 of FIG. 11B, the fuel pump 504 can pump fuel from the fuel tank 502 to the combustor 900 through the fuel conduit 1104. In order to energize the fuel, rather than using the treatment chamber 1102 as in FIG. 11A, the coaxial resonator 201 is positioned such that electromagnetic waves radiated from the coaxial resonator 201 are provided directly to the fuel conduit 1104. Hence, as fuel flows from the fuel tank 502 to the combustor 900 through the fuel conduit 1104, the fuel is irradiated by the electromagnetic waves and, thus, is also modified according to the processes presently disclosed.

In some implementations, the fuel flow rate can be controlled (for example, by the fuel pump 504), such that an appropriate power from the electromagnetic waves reaches each portion of the fuel. For example, the flow rate of fuel within the fuel conduit 1104 in liters/minute can be adjusted by the fuel pump 504 based on the power of the electromagnetic waves output by the coaxial resonator 201 in Watts. Additionally or alternatively, a modulation rate of the coaxial resonator 201 can be controlled such that an appropriate power from the electromagnetic waves reaches each portion of the fuel. For example, the modulation rate of the coaxial resonator 201 can be determined based on a volume of fuel flowing passed a point in the fuel conduit 1104 where the coaxial resonator 201 is located per unit time. Even further, the output power of the coaxial resonator 201, and hence the power of the radiated electromagnetic waves, can also be controlled such that an appropriate power from the electromagnetic waves reaches each portion of the fuel.

In alternate implementations, in addition to or instead of adjusting the fuel flow rate, the modulation of the coaxial resonator 201, or the output power of the coaxial resonator 201, multiple resonators (for example, coaxial resonators 201) can be used to radiate electromagnetic waves used to modify the fuel flowing within the fuel conduit 1104. Without limitation, an example of such an implementation is illustrated in FIG. 11C. In particular, FIG. 11C illustrates a system 1130 that includes multiple coaxial resonators 201, each configured to radiate electromagnetic waves into the fuel conduit 1104 to modify the fuel before the fuel reaches the combustor 900. In some implementations, as illustrated, the coaxial resonators 201 can be evenly spaced with respect to one another. In other implementations, the coaxial resonators 201 can be unevenly spaced.

Further, in some implementations, one or more of the coaxial resonators 201 can radiate electromagnetic waves of a different wavelength than are radiated by one or more of the other coaxial resonators 201. In this way, different fuel resonances can be excited. For example, if the fuel being transmitted to the combustor 900 is a mixture of two disparate fuel types, two separate electromagnetic waves could be radiated by two different coaxial resonators 201. A first of the electromagnetic waves could be tuned, in wavelength, to a resonance of the first fuel type in the mixture and a second of the electromagnetic waves could be tuned, in wavelength, to a resonance of the second fuel type in the mixture.

In some implementations, multiple coaxial resonators could be used to modify fuel and/or a fuel mixture. Illustrated in FIG. 11C, for example, are six coaxial resonators 201 radiating electromagnetic waves directly into the fuel conduit 1104. In various implementations, the system 1130 can include greater or fewer than six coaxial resonators 201.

In addition, in implementations similar to the system 1110 of FIG. 11A, there could be multiple coaxial resonators 201 radiating electromagnetic waves into the treatment chamber 1102. Additionally, in implementations similar to FIG. 10A, there could be multiple coaxial resonators 201 radiating electromagnetic waves into the combustion zone 912. Even further, in some implementations, there could be multiple coaxial resonators 201 radiating electromagnetic waves in multiple locations. For example, in the system 1110 illustrated in FIG. 11A, rather than a single coaxial resonator 201 radiating electromagnetic waves into the treatment chamber 1102, there could be multiple coaxial resonators 201 radiating electromagnetic waves into the treatment chamber 1102, in addition to multiple coaxial resonators 201 radiating electromagnetic waves directly into the fuel conduit 1104, and in addition to multiple coaxial resonators 201 radiating electromagnetic waves into the combustion zone 912.

FIG. 11D illustrates a system 1140, according to example implementations. In some implementations, the system 1140 can be a component of a power-generation turbine such as the power-generation turbine 800 illustrated in FIG. 8. The system 1140 can be analogous to the system 1130 illustrated in FIG. 11C, in some implementations. However, unlike the system 1130 illustrated in FIG. 11C, the coaxial resonator 201 radiates electromagnetic waves directly into a fuel tank 1142.

In some implementations, the fuel tank 1142 can be similar to the fuel tank 502 described above. Alternatively, in some implementations, the fuel tank 1142 can be analogous to the treatment chamber 1102 described with respect to FIG. 11A. For example, the fuel tank 1142 can have an interior wall that is highly reflective to the electromagnetic waves radiated by the coaxial resonator 201.

In some implementations, modifying the fuel can increase a volatility of the fuel. Hence, to reduce volatility of stored fuel when the system 1140 is not in use, fuel might only be modified just before it is transported to the combustor 900 for ignition/combustion. For example, the coaxial resonator 201 can begin radiating electromagnetic waves into the fuel tank 1142 to modify the fuel in response to the fuel pump 504 pumping fuel from the fuel tank 1142 through the fuel conduit 1104 into the combustor 900.

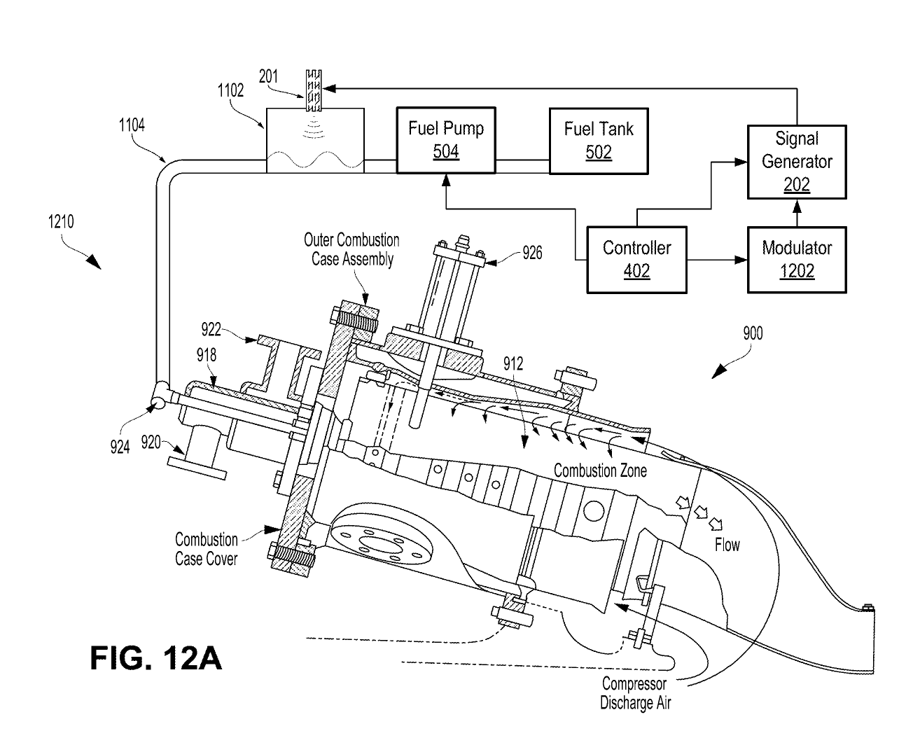

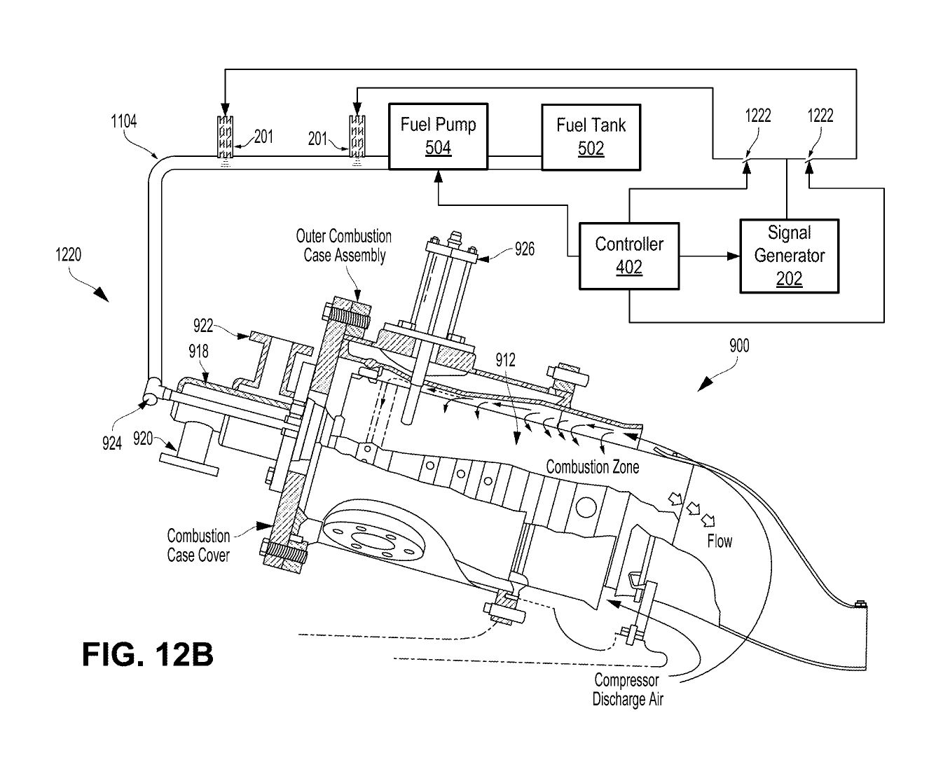

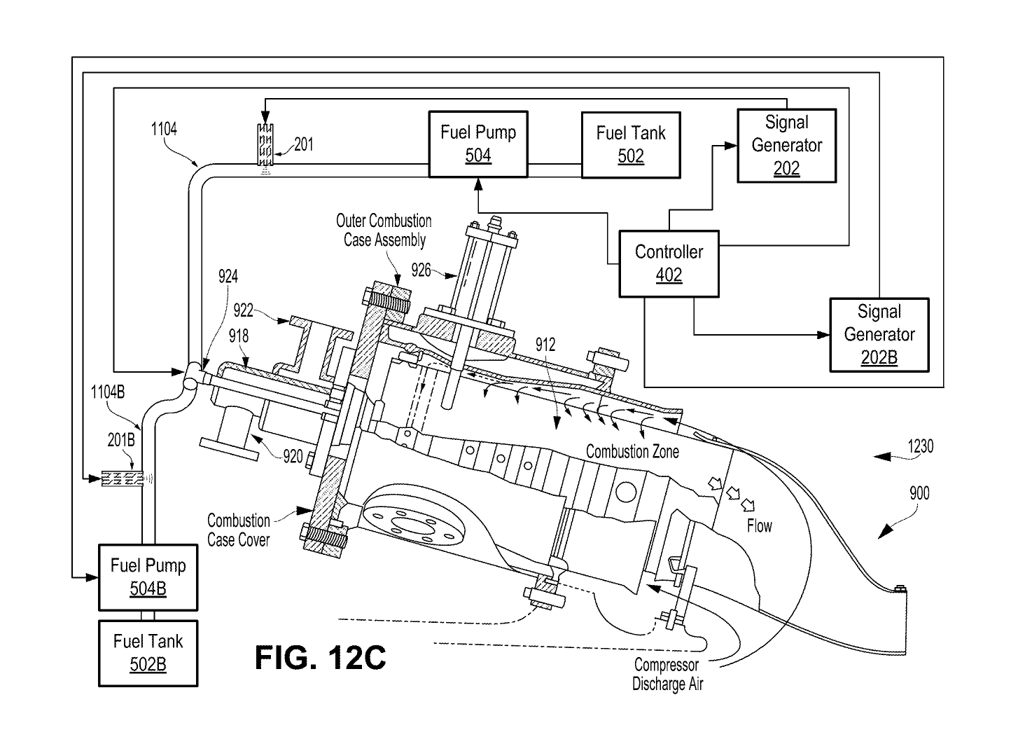

FIG. 12A illustrates a system 1210 according to example implementations. The system 1210 of FIG. 12A can include the coaxial resonator 201 (as illustrated in FIG. 2), the signal generator 202 (as illustrated in FIG. 2), the controller 402 (as illustrated in FIGS. 4A and 4B), the fuel tank 502 (as illustrated in FIG. 5), the fuel pump 504 (as illustrated in FIG. 5), the combustor 900 (as illustrated in FIG. 9), the treatment chamber 1102 (as illustrated in FIG. 11A), and the fuel conduit 1104 (as illustrated in FIGS. 11A-11D). It is understood that, in some implementations, the components of FIG. 12A could all be packaged together. However, it is also understood that, in other implementations, the components of FIG. 12A could be self-contained components that are removably attached in such a way as to form the arrangement illustrated. For example, the signal generator 202 could be communicatively coupled to the controller 402 and/or the coaxial resonator 201 in order to excite the coaxial resonator 201, but later could be communicatively uncoupled when excitation of the coaxial resonator 201 is no longer necessary.

Similar to the system 1110 illustrated in FIG. 11A, fuel can flow from the fuel tank 502 to the combustor 900 through the fuel conduit 1104 and the treatment chamber 1102. Once in the combustion zone 912 (or before entering the combustion zone 912 in the fuel injector 918, in some implementations), the fuel can be mixed with air and ignited/burned. The fuel pump 504 can control the flow rate at which the fuel flows from the fuel tank 502 to the combustor 900. Also like the system 1110 of FIG. 11A, when the fuel is in the treatment chamber 1102, the coaxial resonator 201 can modify the fuel by irradiating the fuel with electromagnetic waves.

In order to radiate electromagnetic waves, the coaxial resonator 201 can be excited by a signal generator 202 (for example, with a signal that has a wavelength proximate to one-quarter (¼) of a resonant wavelength of the coaxial resonator 201). Further, the modulator 1202 can be used to modulate the output of the signal generator 202. For example, the modulator 1202 can be used as a trigger signal for the signal generator 202, such that the modulator 1202 periodically triggers the signal generator 202 to output a signal to the coaxial resonator 201. Thus, in addition to having a signal frequency (for example, a radio frequency between 300 MHz and 300 GHz) associated with the signal created by the signal generator 202 to excite the coaxial resonator 201, the system 1210 can include a modulation frequency at which the modulator 1202 modulates the signal generator 202. In various implementations the modulation frequency can take various values, such as 0 Hz (continuous wave), between 0.1 Hz and 1.0 Hz, between 1.0 Hz and 10.0 Hz, between 10.0 Hz and 100.0 Hz, between 100.0 Hz and 1.0 kHz, between 1.0 kHz and 10.0 kHz, between 100.0 kHz and 1.0 MHz, or between 1.0 MHz and 10.0 MHz, or between 10.0 MHz and 100.0 MHz. Other modulation frequencies are also possible. The modulation frequency can also include an associated duty cycle. For example, the associated duty cycle can be any integer multiple of 5%. Other duty cycle values are also possible. Further, in some implementations, the modulation frequency and/or the associated duty cycle can be adjustable. Such adjustments can correspondingly modify how often the electromagnetic waves are radiated by the coaxial resonator 201.

The controller 402 can control the modulator 1202, the signal generator 202, and the fuel pump 504. In alternate implementations, the system 1210 might not include a modulator 1202, and the controller 402, itself, could directly modulate the signal generator 202. Controlling the modulator 1202, the signal generator 202, and the fuel pump 504 can include changing settings on the modulator 1202, the signal generator 202, and the fuel pump 504, respectively (for example, using a control signal). Additionally, the controller 402 can change such settings: in response to dynamic conditions within the combustor 900, in order to change conditions within the combustor 900, in response to dynamic conditions within the fuel tank 502, in order to change conditions within the fuel tank 502, in response to dynamic conditions within the treatment chamber 1102, in order to change conditions within the treatment chamber 1102, in response to dynamic conditions within the fuel conduit 1104, and/or in order to change conditions within the fuel conduit 1104. Such conditions within the fuel tank 502, the treatment chamber 1102, the fuel conduit 1104, and/or the combustor 900 can be measured by a sensor configured to provide sensor data to the controller 402. Further, the controller 402 can control the fuel pump 504, the signal generator 202, and the modulator 1202 by executing instructions stored within a non-transitory, computer-readable medium (for example the memory 454 illustrated in FIG. 4B), in some implementations.

Controlling the signal generator 202 can take a variety of forms. For example, controlling the signal generator 202 can include modifying an output frequency, an output wavelength, an output current, an output voltage, an output power, an output amplitude, and/or an output waveform shape (for example, a sinusoidal waveform, a square waveform, a triangular waveform, a pulsed waveform, or a sawtooth waveform) of the signal generator 202.

Additionally, controlling the modulator 1202 can take a variety of forms. For example, controlling the modulator 1202 can include modifying the modulation frequency and/or the modulation duty cycle of the modulator 1202. The modulation frequency and/or the modulation duty cycle of the modulator 1202 can be modified based on a power-output demand of a power-generation turbine that includes the system 1210. For example, the controller 402 could receive a power-output demand of the power-generation turbine based on a user-input or based on a feedback loop, and modify the modulation frequency and/or duty cycle based on the power-output demand.

Further, controlling the fuel pump 504 can take a variety of forms. For example, controlling the fuel pump 504 can include controlling a pumping frequency of the fuel pump 504, a duty cycle of the fuel pump 504, a pumping power of the fuel pump 504, and/or a pumping volume of the fuel pump 504. The pumping frequency of the fuel pump 504, the duty cycle of the fuel pump 504, the pumping power of the fuel pump 504, and/or the pumping volume of the fuel pump 504 can be controlled based on a power-output demand of a power-generation turbine that includes the system 1210, for example.

The controller 402 can modify the modulator 1202, the signal generator 202, and/or the fuel pump 504 in order to improve combustion within the combustion zone 912 of the combustor 900. For example, if sufficient and/or total combustion is not occurring (as sensed by a combustion sensor, in some implementations) or if ignition is not occurring, the modulation frequency and/or duty cycle can be increased by the controller such that more electromagnetic waves are radiated by the coaxial resonator 201 to modify the fuel in the treatment chamber 1102. Additionally or alternatively, if sufficient and/or total combustion is not occurring or if ignition is not occurring, the frequency, amplitude, and/or power output by the signal generator to excite the coaxial resonator 201 can be increased to increase the amount and/or strength of the electromagnetic waves modifying the fuel in the treatment chamber 1102. In some implementations, if the fuel-to-air ratio in a fuel mixture in the combustion zone 912 of the combustor 900 is either too high or too low, the pumping frequency and/or pumping volume of the fuel pump 504 can be increased or decreased by the controller to modify the fuel-to-air ratio, which could possibly improve combustion/ignition conditions.

In alternate implementations, the controller 402 can control additional or fewer components. For example, the controller 402 could also control settings of the fuel tank 502 and/or the combustor 900, such as a temperature or pressure setting within the fuel tank 502 and/or the combustor 900, in various implementations. Additionally or alternatively, in some implementations, the system 1210 can include one or more valves used to control fuel flow within the fuel conduit 1104. For example, the system 1210 can include one or more valves between the fuel tank 502 and the fuel pump 504, one or more valves between the fuel pump 504 and the treatment chamber 1102, and/or one or more valves between the treatment chamber 1102 and the combustor 900. Any number of the valves could also be controlled by the controller 402.

In one implementation, for instance, the controller 402 could control a valve (not shown) located in the fuel conduit 1104 between the treatment chamber 1102 and the combustor 900. For example, such a valve could be closed by the controller 402 during a fuel pretreatment phase when the fuel is being modified within the treatment chamber 1102. Upon completion of the pretreatment phase, such a valve can then be opened by the controller 402 during an injection phase. During the injection phase, the modified fuel can be injected into the combustion zone 912 of the combustor 900. In other implementations, the system 1210 can include a valve configured to control a flow rate at which the fuel conduit 1104 provides the fuel to the combustor 900. Further, the controller 402 could adjust the valve in order to modify the flow rate based on a power-output demand of a corresponding power-generation turbine that includes the system 1210.

FIG. 12B illustrates a system 1220, according to example implementations. The system 1220 can be analogous to the system 1210 illustrated in FIG. 12A. However, unlike the system 1210 illustrated in FIG. 12A, the system 1220 in FIG. 12B does not include a modulator or a treatment chamber. Additionally, the system 1220 illustrated in FIG. 12B includes two coaxial resonators 201 arranged such that each of the coaxial resonators 201 radiates electromagnetic waves into the fuel conduit 1104 so as to modify fuel flowing within the fuel conduit. Both of the coaxial resonators 201 are electromagnetically coupled to the signal generator 202. However, each of the coaxial resonators 201 is electromagnetically coupled to the signal generator through a respective switch 1222. As illustrated, the switches 1222 can be controlled by the controller 402. As such, based on whether a respective switch 1222 is open or closed, the respective coaxial resonator 201 can be selectively, electromagnetically coupled or selectively, electromagnetically decoupled from the signal generator 202. Thus, the signal generator 202 can provide a signal to excite zero of, one of, or both the coaxial resonators 201 such that the respective coaxial resonators 201 radiate electromagnetic waves. In some implementations, the controller 402 controls the switches 1222 to selectively electromagnetically couple the coaxial resonators 201 to the signal generator 202 based on a power-output demand of a power-generation turbine that includes the system 1220.

By controlling the signal generator 202, the controller 402 can modulate a signal output by the signal generator 202, can modify an output power of a signal output by the signal generator 202, can modify an output waveform of a signal output by the signal generator 202, can modify an output frequency of a signal output by the signal generator 202, etc. Further, by controlling the switches 1222, the controller 402 can select which of multiple locations within the fuel conduit 1104 receive electromagnetic waves 1002. In addition, the switches 1222 can be opened and/or closed by the controller 402 according to a predetermined pattern. The predetermined pattern can take various forms. For example, the switch 1222 connected to the rightmost coaxial resonator 201 and the switch 1222 connected to the leftmost coaxial resonator 201 can be alternating such that one closes as the other opens. In such an implementation, the switch 1222 connected to the rightmost coaxial resonator 201 can initially be closed, while the switch 1222 connected to the leftmost coaxial resonator 201 can initially be open, such that electromagnetic waves are only radiated to a region of the fuel conduit 1104 near the rightmost coaxial resonator 201. Then, a predetermined time later, the rightmost switch 1222 can open and the leftmost switch can close 1222, such that electromagnetic waves are only radiated to a region of the fuel conduit 1104 near the leftmost coaxially resonator 201. The predetermined time can be based on a fuel flow rate within the fuel conduit 1104. Such a fuel flow rate can be sensed by a sensor (for example, a sensor in the fuel conduit 1104 or in the fuel tank 502) and communicated to the controller 402. Alternatively, such a fuel flow rate can be based on a pump rate of the fuel pump 504 set by the controller 402 and/or measured by a sensor in the fuel pump 504 and transmitted to the controller 402.

In some implementations, there can be more than two coaxial resonators 201. For example, in one implementation, three, four, five, six, seven, eight, nine, ten, or any number of coaxial resonators 201 could line the fuel conduit 1104. Further, in some implementation, there could be a treatment chamber, either along the path of the fuel conduit or within the combustion zone 912. The treatment chamber could additionally or alternatively receive electromagnetic waves from one or more additional coaxial resonators 201. Such additional coaxial resonators 201 could also be electromagnetically coupled to the signal generator 202 through respective switches that can be opened and closed by the controller 402. Further, the fuel tank 502 could also receive electromagnetic waves from one or more additional coaxial resonators 201 (similar, for example, to the system 1140 illustrated in FIG. 11D). Similarly, such additional coaxial resonators 201 could also be electromagnetically coupled to the signal generator 202 through respective switches that can be opened and closed by the controller 402.

FIG. 12C illustrates a system 1230, according to example implementations. The system 1230 can be analogous to the system 1220 illustrated in FIG. 12B. However, unlike the system 1220 illustrated in FIG. 12B, the system 1230 in FIG. 12C does not include a second coaxial resonator 201 along the fuel conduit 1104. Additionally, the system 1230 illustrated in FIG. 12C includes a secondary signal generator 202B, a secondary fuel tank 502B, a secondary fuel pump 504B, a secondary coaxial resonator 201B, and a secondary fuel conduit 1104B. The secondary components are labeled with a “B” to distinguish them from the other signal generator 202, fuel tank 502, fuel pump 504, coaxial resonator 201, and fuel conduit 1104. In some implementations one or more of the secondary components can be similar and/or identical to the corresponding other components. For example, in some implementations, the fuel pump 504 and the secondary fuel pump 504B could be the same in design and operation, except the fuel pump 504 pumps fuel from the fuel tank 502 through the fuel conduit 1104, whereas the secondary fuel pump 504B pumps secondary fuel from the secondary fuel tank 502B through the secondary fuel conduit 1104B. Other correspondences between components are understood to be presently contemplated. However, in some implementations, one or more of the secondary components could be different than the corresponding other components. For example, the fuel conduit 1104 and the secondary fuel conduit 1104B could have different cross-sectional areas, allowing for disparate flow rates. Other differences between corresponding components are understood to be presently contemplated.

As illustrated, the controller 402 can be communicatively coupled to the secondary signal generator 202B and the secondary fuel pump 504B. Similar to the signal generator 202 and the fuel pump 504, the controller 402 can control the secondary fuel pump 504B and the secondary signal generator 202B. For example, the controller 402 generated by the secondary signal generator 202B. The controller 402 can control other outputs of the secondary signal generator 202B and/or the secondary fuel pump 504B, as described above with respect to the controller 402 controlling the signal generator 202 and the fuel pump 504. Further, unlike the system 1210 of FIG. 12A, the system 1230 of FIG. 12C does not include a modulator 1202. It is understood that in alternate implementations, a single modulator could be used to control the excitation of the coaxial resonator 201 and/or the secondary coaxial resonator 201B. Alternatively, multiple modulators (for example, one for each coaxial resonator 201/201B) could be used to independently control the excitation of the coaxial resonators 201/201B. The controller 402 could control one, multiple, or each of the modulators, in various implementations (for example, using one or more control signals).

A further difference between the secondary components and the other components may include the fuel tank 502 holding a different fuel type than the secondary fuel tank 502B. For example, the secondary fuel tank 502B may contain a secondary fuel that has different properties than the fuel contained in the fuel tank 502. The secondary fuel may have a different energy density, combustibility, chemical composition, etc. than the fuel in the fuel tank 502. As such, one or more design features of the secondary coaxial resonator 201B may be different than one or more design features of the coaxial resonator 201. For example, a secondary resonant wavelength of the secondary coaxial resonator 201B can be designed based on a resonance condition of the secondary fuel (for example, a wavelength at which certain chemical bonds of the secondary fuel would break) so that electromagnetic waves used to modify the secondary fuel can be efficiently radiated by the secondary coaxial resonator 201B at the resonance condition of the secondary fuel. This resonance condition of the secondary fuel may be different than a resonance condition of the fuel within the fuel tank 502. As such, the resonant wavelength of the coaxial resonator 201 can be designed based on a different resonance condition. Hence, the resonant wavelength of the coaxial resonator 201 and the secondary resonant wavelength of the secondary coaxial resonator 201B may be different.

Additionally or alternatively, design features of the coaxial resonator 201 and the secondary coaxial resonator 201B could be tuned differently based on differences between the fuel tank 502 and the secondary fuel tank 502B, between the fuel pump 504 and the secondary fuel pump 504B, and/or between the fuel conduit 1104 and the secondary fuel conduit 1104B. For example, if the secondary fuel conduit 1104B has an increased cross-sectional area when compared with the fuel conduit 1104, the secondary resonant wavelength of the secondary coaxial resonator 201B may be greater than the resonant wavelength of the coaxial resonator 201. Such a difference in resonant wavelengths for the coaxial resonators 201/201B may be based on differences in the resonance conditions of the fuel conduits 1104/1104B, themselves, for instance.

In other implementations, similar to previous figures, the system 1230 could include multiple coaxial resonators (as opposed to a single coaxial resonator) along one or both of the fuel conduits 1104/1104B. Additionally or alternatively, the system 1230 could include a treatment chamber (for example, similar to the treatment chamber 1102 shown and described with reference to FIG. 11A) along one or both of the fuel conduits 1104/1104B. Parameters of such a treatment chamber (for example, size and materials) could be designed to conform to different resonance conditions of different fuel types stored in the fuel tank 502 and the secondary fuel tank 502B, respectively. Still further, in some implementations (similar to shown and described in FIG. 11D), one or both of the coaxial resonator 201 and the secondary coaxial resonator 201B could radiate electromagnetic waves directly into a respective fuel tank, rather than into a respective fuel conduit 1104/1104B.

Also as illustrated, the controller 402 can be communicatively coupled to the liquid-fuel port 924. In some implementations, the liquid-fuel port 924 can include one or more valves that are controllable based on a signal from the controller 402. For example, a valve that is fluidly connected to the fuel conduit 1104 could be opened by the controller 402 to permit fuel from the fuel tank 502 to pass into the combustion zone 912 and could be closed to prevent fuel from the fuel tank 502 from passing into the combustion zone 912. Similarly, a valve that is fluidly connected to the secondary fuel conduit 1104B could be opened by the controller 402 to permit secondary fuel from the secondary fuel tank 502B to pass into the combustion zone 912 and could be closed to prevent fuel from the secondary fuel tank 502B from passing into the combustion zone 912. Both of the valves could be opened at the same time to allow a mixture of fuel from the fuel tank 502 and a secondary fuel from the secondary fuel tank 502B to enter the combustion zone 912.

The ratio of fuel from the fuel tank 502 to secondary fuel from the secondary fuel tank 502B could be based on the degree to which one and/or both of the valves are opened. For example, the controller 402 can select whether the fuel from the fuel tank 502, the secondary fuel from the secondary fuel tank 502B, or some mixture of the two should be injected into the combustion chamber. Such a selection can be based on a power-output demand of a power-generation turbine association with the system 1230, for instance. Then, if a power-output demand is above a threshold value, whichever fuel (of the fuel within the fuel tank 502 and the secondary fuel within the secondary fuel tank 502B) has higher energy density can be selected.

Alternatively, a mixture of the two fuels can be selected based on the power-output demand of the power-generation turbine. Based on the selected fuel or fuel mixture, the controller 402 can open/close appropriate valve(s). Further, based on the selected fuel or mixture, the controller 402 can cause the respective signal generator(s) 202/202B to excite the respective coaxial resonator(s) 201/201B such that the respective coaxial resonator(s) 201/201B excite the fuel(s) in the respective fuel conduit(s) 1104/1104B. In alternate implementations, rather than two valves (each connecting to a respective fuel conduit 1104/1104B), the liquid-fuel port 924 may include a three-way valve. The three-way valve could be controlled by the controller 402 to determine a ratio of the fuel from the fuel tank 502 to the secondary fuel from the secondary fuel tank 502B with the fuel mixture. Other arrangements are possible as well.

X. Example Methods

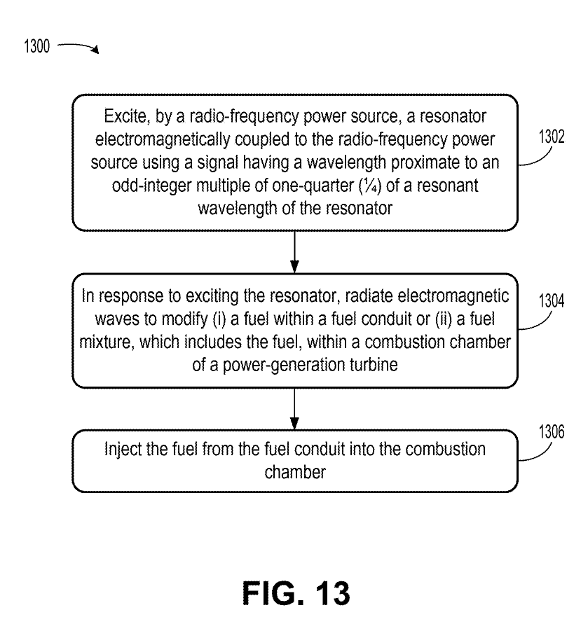

FIG. 13 illustrates a method 1300, according to example implementations. The method 1300 can be performed by a system. For example, the method 1300 can be performed by the system 1210 illustrated in FIG. 12A or other systems presently disclosed. Various features described above can be applied in the context of the method 1300. Such features can be applied in addition to or instead of the features of the method 1300 described below.

At block 1302, the method 1300 can include exciting, by a radio-frequency power source, a resonator electromagnetically coupled to the radio-frequency power source with a signal having a wavelength proximate to an odd-integer multiple of one-quarter (¼) of a resonant wavelength of the resonator. The resonator can include a first conductor. The resonator can also include a second conductor. Further, the resonator can include a dielectric between the first conductor and the second conductor.

At block 1304, the method 1300 can include, in response to exciting the resonator, radiating electromagnetic waves to modify (i) a fuel within a fuel conduit or (ii) a fuel mixture, which includes the fuel, within a combustion chamber of a power-generation turbine.

At block 1306, the method 1300 can include injecting the fuel from the fuel conduit into the combustion chamber.

The particular arrangements shown in the figures should not be viewed as limiting. It should be understood that other implementations can include more or less of each element shown in a given figure. Further, some of the illustrated elements can be combined or omitted. Yet further, an illustrative implementation can include elements that are not illustrated in the figures.

A step or block that represents a processing of information can correspond to circuitry that can be configured to perform the specific logical functions of a method or technique as presently disclosed. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk, hard drive, or other storage medium.

The computer-readable medium can also include non-transitory computer-readable media such as computer-readable media that store data for short periods of time like register memory, processor cache, and random access memory (RAM). The computer-readable media can also include non-transitory computer-readable media that store program code and/or data for longer periods of time. Thus, the computer-readable media can include secondary or persistent long term storage, like read only memory (ROM), optical or magnetic disks, compact-disc read only memory (CD-ROM), for example. The computer-readable media can also be any other volatile or non-volatile storage systems. A computer-readable medium can be considered a computer-readable storage medium, for example, or a tangible storage device.

While various examples and implementations have been disclosed, other examples and implementations will be apparent to those skilled in the art. The various disclosed examples and implementations are for purposes of illustration and are not intended to be limiting, with the true scope being indicated by the claims.

What is claimed is:

1. A power-generation turbine comprising:
a combustion chamber;
a radio-frequency power source;
a fuel conduit configured to provide a fuel to the combustion chamber; and
a resonator configured to electromagnetically couple to the radio-frequency power source and having a resonant wavelength, the resonator including:
a first conductor,
a second conductor, and
a dielectric between the first conductor and the second conductor, wherein the resonator is configured such that, when the resonator is excited by the radio-frequency power source with a signal having a wavelength proximate to an odd-integer multiple of one-quarter (¼) of the resonant wavelength, the resonator radiates electromagnetic waves usable to modify (i) the fuel within the fuel conduit or (ii) a fuel mixture, which includes the fuel, within the combustion chamber.

2. The power-generation turbine of claim 1, wherein the resonator is selected from the group consisting of a coaxial-cavity resonator, a dielectric resonator, a crystal resonator, a ceramic resonator, a surface-acoustic-wave resonator, a yttrium-iron-garnet resonator, a rectangular-waveguide cavity resonator, a parallel-plate resonator, and a gap-coupled microstrip resonator.

3. The power-generation turbine of claim 1, wherein the electromagnetic waves comprise microwaves having wavelengths from one millimeter to one meter.

4. The power-generation turbine of claim 1, wherein the electromagnetic waves comprise microwaves having frequencies from 300 MHz to 300 GHz.

5. The power-generation turbine of claim 1, wherein modifying the fuel within the fuel conduit or the fuel mixture within the combustion chamber includes a modification selected from the group consisting of ionizing at least one hydrogen atom in a hydrocarbon chain,
liberating at least one hydrogen atom from a hydrocarbon chain,
exciting a hydrocarbon chain at one or more natural resonant frequencies to break one or more carbon-hydrogen bonds,
altering an energy state of the fuel,
exciting electrons within a valence band of a hydrocarbon chain to a higher energy level,
reorienting water molecules, and
reorienting polar hydrocarbon chains.

6. The power-generation turbine of claim 1, further comprising a switchable direct-current power source configured to provide a bias signal between the first conductor and the second conductor.

7. The power-generation turbine of claim 1, wherein modifying the fuel within the fuel conduit or the fuel mixture within the combustion chamber includes increasing an energy state of the fuel or the fuel mixture, thereby lowering an energy barrier to combustion of the fuel or the fuel mixture.

8. The power-generation turbine of claim 1, wherein the resonator further includes an electrode configured to electromagnetically couple to the first conductor, the resonator being configured to provide a plasma corona proximate to the electrode when excited by the radio-frequency power source with the signal so as to ignite the fuel mixture within the combustion chamber.

9. The power-generation turbine of claim 1, further comprising a treatment chamber that is:
disposed at least partially inside the combustion chamber,
configured to house at a least a portion of the fuel mixture within the combustion chamber, and
arranged such that, when the resonator radiates electromagnetic waves when excited by the radio-frequency power source with the signal, the portion of the fuel mixture within the combustion chamber is modified within the treatment chamber.

10. The power-generation turbine of claim 1, further comprising a treatment chamber that is:
disposed at least partially outside the combustion chamber,
configured to house at a least a portion of the fuel conduit, and
arranged such that, when the resonator radiates electromagnetic waves when excited by the radio-frequency power source with the signal, the fuel within the fuel conduit is modified within the treatment chamber.

11. The power-generation turbine of claim 1, wherein modifying the fuel within the fuel conduit or the fuel mixture within the combustion chamber increases combustibility of the fuel or the fuel mixture.

12. The power-generation turbine of claim 11, wherein increasing combustibility of the fuel or the fuel mixture increases a power output by the power-generation turbine during combustion for a given fuel-to-air ratio of the fuel mixture.

13. The power-generation turbine of claim 11, wherein increasing combustibility of the fuel or the fuel mixture reduces an amount of fuel consumed during combustion, thereby permitting a burning of leaner fuel mixtures within the combustion chamber based on a given amount of power output by the power-generation turbine.

14. The power-generation turbine of claim 1, wherein the fuel is a primary fuel, the fuel conduit is a primary fuel conduit, the radio-frequency power source is a primary radio-frequency power source, the resonator is a primary resonator, the signal is a first signal, the wavelength is a primary wavelength, and the resonant wavelength is a primary resonant wavelength, the power-generation turbine further comprising:
a secondary fuel conduit configured to provide a secondary fuel to the combustion chamber, the secondary fuel being of a different type than the primary fuel;
a secondary radio-frequency power source;
a secondary resonator configured to electromagnetically couple to the secondary radio-frequency power source and having a secondary resonant wavelength, the secondary resonator including:
a secondary first conductor,
a secondary second conductor, and
a secondary dielectric between the secondary first conductor and the secondary second conductor, wherein the secondary resonator is configured such that, when the secondary resonator is excited by the secondary radio-frequency power source with a secondary signal having a secondary wavelength proximate to an odd-integer multiple of one-quarter (¼) of the secondary resonant wavelength, the secondary resonator radiates electromagnetic waves usable to modify (i) the secondary fuel within the secondary fuel conduit or (ii) a secondary fuel mixture, which includes the secondary fuel, within the combustion chamber; and
a controller configured to carry out operations, the operations including:
selecting either the primary fuel or the secondary fuel for injecting into the combustion chamber,
based on the selecting, causing either the primary fuel to be injected into the combustion chamber from the primary fuel conduit or the secondary fuel to be injected into the combustion chamber from the secondary fuel conduit, and
based on the selecting, causing either the primary radio-frequency power source to excite the primary resonator or the secondary radio-frequency power source to excite the secondary resonator.

15. The power-generation turbine of claim 14, wherein the operation of selecting either the primary fuel or the secondary fuel for injecting into the combustion chamber is based on a power-output demand of the power-generation turbine.

16. The power-generation turbine of claim 14, wherein the primary resonant wavelength of the primary resonator corresponds to a resonance of the primary fuel and the secondary resonant wavelength of the secondary resonator corresponds to a resonance of the secondary fuel.

17. The power-generation turbine of claim 1, further comprising:
a modulator configured to modulate the signal at a modulation frequency in order to intermittently excite the resonator; and
a controller configured to carry out operations including adjusting the modulation frequency based on a power-output demand of the power-generation turbine.

18. The power-generation turbine of claim 1, further comprising:
an additional resonator configured to electromagnetically couple to the radio-frequency power source and having the resonant wavelength, the additional resonator including:
an additional first conductor,
an additional second conductor, and
an additional dielectric between the additional first conductor and the additional second conductor, wherein the additional resonator is configured to radiate additional electromagnetic waves usable to modify the fuel within the fuel conduit or the fuel mixture within the combustion chamber, when the additional resonator is excited by the radio-frequency power source with the signal;
a switch configured to selectively electromagnetically couple the additional resonator to the radio-frequency power source; and
a controller configured to carry out operations including causing the switch to electromagnetically couple the additional resonator to the radio-frequency power source so as to provide the additional electromagnetic waves based on a power-output demand of the power-generation turbine.

19. A method comprising:
exciting, by a radio-frequency power source, a resonator electromagnetically coupled to the radio-frequency power source with a signal having a wavelength proximate to an odd-integer multiple of one-quarter (¼) of a resonant wavelength of the resonator, wherein the resonator includes:
a first conductor,
a second conductor, and
a dielectric between the first conductor and the second conductor;
in response to exciting the resonator, radiating electromagnetic waves to modify (i) a fuel within a fuel conduit or (ii) a fuel mixture, which includes the fuel, within a combustion chamber of a power-generation turbine; and
injecting the fuel from the fuel conduit into the combustion chamber.

20. A system comprising:
a treatment chamber;
a radio-frequency power source;
a fuel conduit configured to provide fuel from the treatment chamber to a combustion chamber of a power-generation turbine; and
a resonator configured to electromagnetically couple to the radio-frequency power source and having a resonant wavelength, the resonator including:
a first conductor,
a second conductor, and
a dielectric between the first conductor and the second conductor, wherein the resonator is configured such that, when the resonator is excited by the radio-frequency power source with a signal having a wavelength proximate to an odd-integer multiple of one-quarter (¼) of the resonant wavelength, the resonator radiates electromagnetic waves usable to modify the fuel within the treatment chamber.
